(19) United States
(12) Patent Application Publication
(10) Pub. No.: US 2007/0077572 A1
(43) Pub. Date: Apr. 5, 2007

(54) Compositions and methods for in vitro sorting of molecular and cellular libraries

(75) Inventors: Dan Tawfik, Jerusalem (IL); Kalia Bernath, Mazkeret-Batia (IL); Amir Aharoni, Tel-Aviv (IL); Sergio Peisajovich, Rehovot (IL); Andrew D. Griffiths, Straibourg (FR); Enrico Mastrobattista, Utrecht (NL); Shlomo Magdassi, Jerusalem (IL)

Correspondence Address: BROWDY AND NEIMARK, P.L.L.C.;624 NINTH STREET, NW, SUITE 300, WASHINGTON, DC, 20001-5303, US

(73) Assignees: YEDA RESEARCH AND DEVELOPMENT CO. LTD., Rehovot (IL); YISSUM RESEARCH DEVELOPMENT COMPANY THE HEBREW UNIVERSITY OF JERUSALEM, Jerusalem (IL); MEDICAL RESEARCH COUNCIL, London (GB)

(21) Appl. No.: 11/439,533

(22) Filed: May 24, 2006

Related U.S. Application Data
(63) Continuation-in-part of application No. PCT/IL04/01079, filed on Nov. 24, 2004.
(60) Provisional application No. 60/524,045, filed on Nov. 24, 2003.
(60) Provisional application No. 60/618,426, filed on Oct. 13, 2004.

(51) Int. Cl. C40B 30/06; C40B 40/04; C40B 40/08; C40B 40/10

(52) U.S. Cl. 435/6; 435/7.1

(57) ABSTRACT

The present invention provides an in vitro system for compartmentalization of molecular or cellular libraries and provides methods for selection and isolation of desired molecules or cells from the libraries. The library includes a plurality of distinct molecules or cells encapsulated within a water-in-oil-in-water emulsion. The emulsion includes a continuous external aqueous phase and a discontinuous dispersion of water-in-oil droplets. The internal aqueous phase of a plurality of such droplets comprises a specific molecule or cell that is within the plurality of distinct molecules or cells of the library.

### FIELD OF THE INVENTION

The present invention relates to libraries of molecules or cells that are dispersed in water-in-oil-in-water (w/o/w) emulsions and to methods of selecting and isolating desired cells or molecules which are encapsulated within the w/o/w emulsions.

### BACKGROUND OF THE INVENTION

One of the frontiers of molecular biology is the generation of molecular libraries, particularly gene libraries. Evolution requires the generation of genetic diversity followed by the selection of those nucleic acids, which result in beneficial characteristics. As nucleic acids and the activity of the encoded gene products of an organism are physically linked (the nucleic acids being confined within cells which translate the proteins that they encode) multiple rounds of mutation and selection can result in the progressive survival of organisms with increasing fitness. Systems for rapid evolution of nucleic acids or proteins in vitro must mimic this process at the molecular level in that the nucleic acid and the activity of the encoded gene product must be linked and the activity of the gene product must be selectable.

Common to these methods is the establishment of large libraries of nucleic acids. Molecules having the desired characteristics (activity) can be isolated through selection regimes that select for the desired activity of the encoded gene product, such as a desired biochemical or biological activity, for example binding activity.

Phage display technology has been highly successful as providing a vehicle that allows for the selection of a displayed protein by providing the essential link between nucleic acid and the activity of the encoded gene product (for review see Clackson and Wells, 1994). Filamentous phage particles act as genetic display packages with proteins on the outside and the genetic elements that encode them on the inside. The tight linkage between nucleic acid and the activity of the encoded gene product is a result of the assembly of the phage within infected bacteria. As individual bacteria are rarely multiply infected, in most cases all the phage produced from an individual bacterium will carry the same genetic element and display the same protein.

However, phage display relies upon the creation of nucleic acid libraries in vivo in bacteria Thus, the practical limitation on library size allowed by phage display technology is of the order of 10⁷ to 10¹¹, even talking advantage of λ phage vectors with excisable filamentous phage replicons. The technique has mainly been applied to selection of molecules with binding activity. A small number of proteins with catalytic activity have also been isolated using this technique, however, in no case was selection directly for the desired catalytic activity, but either for binding to a transition-state analogue (Widersten and Mannervik, 1995) or reaction with a suicide inhibitor (Soumillion et al., 1994; Janda et al., 1997).

Specific peptide ligands have been selected for binding to receptors by affinity selection using large libraries of peptides linked to the C terminus of the lac repressor Lac1 (Cull et al., 1992). When expressed in E. coli the repressor protein physically links the ligand to the encoding plasmid by binding to a lac operator sequence on the plasmid.

An entirely in vitro polysome display system has also been reported (Martheakis et al., 1994) in which nascent peptides are physically attached via the ribosome to the RNA which encodes them. However, the scope of the above systems is limited to the selection of proteins and furthermore does not allow direct selection for activities other than binding, for example catalytic or regulatory activity.

In vitro RNA selection and evolution (Ellington and Szostak, 1990), sometimes referred to as SELEX (systematic evolution of ligands by exponential enrichment) (Tuerk and Gold, 1990) allows for selection for both binding and chemical activity, but only for nucleic acids. When selection is for binding, a pool of nucleic acids is incubated with immobilised substrate. Non-binders are washed away, then the binders are released, amplified and the whole process is repeated in iterative steps to enrich for better binding sequences. This method can also be adapted to allow isolation of catalytic RNA and DNA (for reviews see Chapman and Szostak, 1994; Joyce, 1994; Gold et al., 1995; Moore, 1995).

However, selection for “catalytic” or binding activity using SELEX is only possible because the same molecule performs the dual role of carrying the genetic information and being the catalyst or binding molecule (aptamer). When selection is for “auto-catalysis” the same molecule must also perform the third role of-being a substrate. Since the genetic element must play the role of both the substrate and the catalyst, selection is only possible for single turnover events. Because the “catalyst” is in this process itself modified, it is by definition not a true catalyst. Additionally, proteins may not be selected using the SELEX procedure. The range of catalysts, substrates and reactions that can be selected is therefore severely limited.

Those of the above methods that allow for iterative rounds of mutation and selection are mimicking in vitro mechanisms usually ascribed to the process of evolution: iterative variation, progressive selection for a desired the activity and replication. However, none of the methods so far developed have provided molecules of comparable diversity and functional efficacy to those that are found naturally. Additionally, there are no artificial “evolution” systems which can evolve both nucleic acids and proteins to effect the full range of biochemical and biological activities (for example, binding, catalytic and regulatory activities) and that can combine several processes leading to a desired product or activity.

Water-in-oil emulsions used to compartmentalize and select large gene libraries for a pre-determined function are known in the art, as disclosed for example in U.S. Pat. No. 6,495,673; 6,489,103; 6,184,012; 5,766,861 and US Patent Application No. 20030124586, to Griffiths and Tawfik. The aqueous droplets of the water-in-oil emulsion function as cell-like compartments in each of which a single gene is transcribed and translated to give multiple copies of the protein (e.g., an enzyme) it encodes. Whilst compartmentalization ensures that the gene, the protein it encodes and the products of the activity of this protein remain linked, it does not directly afford a way of selecting for the desired activity.

Flow cytometry is a method widely used in biological and medical research, and may include use of a fluorescent marker that binds to specific cell sites and thereby enables the measurement of various characteristics of individual cells (e.g., size, shape and fluorescent intensity) suspended in a fluid stream. The fluorescence of cells is measured as they travel in suspension one by one past a sensing point. Flow cytometery can serve as a high throughput fluorescence microscope able to detect and read multiple signals of specific intensity range. Modern flow cytometers consist of a light source, collection optics, electronics and a computer to convert signals to data. In most cytometers the light source of choice is a laser that emits coherent light at a given wavelength. Scattered and emitted fluorescent light is collected by a series of optical lenses, beam splitters filters and photomultipliers that enable specific bands of light to be measured.

The use of flow cytometry or Fluorescence Activated Cell Sorting (FACS) can be divided into two broad categories, analysis and sorting. Flow cytometry has powerful analytic functions, enabling evaluation of cells or particles at an extremely rapid rate, up to 40,000 events per second, making this technology ideal for the reliable and accurate quantitative evaluation of cell populations and even for selection of specific cells. The sensitivity of these instruments for the presence of molecules present on cell surfaces at low levels is impressive; as few as 500 molecules per cell may be detected. Whilst flow cytometry is an extremely useful and powerful method to study cell properties in biological and medical systems, it has also been used for the analysis of other particles such as microbeads and liposomes.

A similar problem is posed by cellular analysis. The uniqueness of any one cell within an organism arises from the particular set of genes it expresses at a given time. Most tissues are composed of many different cell types, each with its particular gene complement. In some of them, such as the nervous or immune systems, the level of complexity is enormous, resulting in a spatial mosaic of gene composition, expression levels, and, consequently, biological activity. Even within cell populations made of a single cell type (monoclonal populations), individual cells exhibit substantial phenotypic variation. This is due to the fact that cell cultures are never perfectly synchronized, and therefore, cells of identical genetic composition may still be at a different growth stage or phase, or differentiation pattern, and also due to the stochastic transcription (Elowitz et al., 2002) or spontaneous, deterministic changes, postulated to be an inherent property of regulatory networks (Kamine & Erlander, 2003).

On the other hand, most of our knowledge of cell function, implicitly gene transcription and expression, is derived from the study of cell populations containing millions, or at best, thousands of individual cells, the original heterogeneity having been averaged in pursue of a measurable threshold. However, some cells are present in extremely small amounts at one particular time and, therefore, are not seen. Even though present in minute amounts, such cells can be of the outmost importance, such as in embryonic development, and in tumor growth and metastasis.

Currently, there are a number of methods suitable for analyzing gene expression in single cells. Probably the most widely used is in situ hybridization, where labeled probes applied to slices of tissue are observed under the microscope, providing information on gene expression levels (Freeman et al., 1999). A recent innovation in which multiplex probe design is combined with advanced computational fluorescence microscopy allows the simultaneous visualization of the transcription of several individual genes inside single cells, in real time (Levsky et al., 2002).

Derived from electrophysiological analysis, a method to aspirate the contents of single cells within a tissue with a micropipette has been devised (Richardson et al., 1999). Unfortunately, a highly skilled operator must perform the method and, due to the complexity of the manipulation, only a low numbers of cells can be processed.

A number of methods have been developed to isolate single cells from tissue sections. Ablation can be used to remove or destroy unwanted cell populations present in the sample, followed by mechanical removal of the target cell (Becker et al., 1996; Shibata et al., 1992). Alternatively, a precise manipulating tool, such as a patch-clamp micropipette, blade or needle is employed to physically separate the cell of interest from neighboring cells in a tissue section (Whetsell et al., 1992). A substantial advance in single cell isolation from tissues has been the development of laser-capture microdissection (LCM). In this method, the desired cell is either attached to an apposed cap, using a laser beam and subsequently lifted from the tissue section; or encircled using a cutting ultraviolet laser beam and then catapulted with a second laser into a collection device (Kamme & Erlander, 2003). The main advantages of LCM are that the technology is commercially available and the process is faster than other mechanical techniques. However, both in situ hybridization and single cell isolation from tissues are not readily suitable for high throughput analysis of large numbers of cells. Moreover, the above techniques enable the analysis of mRNA levels only, and there is a growing realization that the levels of mRNA and expressed protein do always not correlate.

A more appropriate method for large-scale studies is FACS, where individual cells can be sorted according to their fluorescence, which can be an indication of enzyme activity, presence of a specific nucleic acid, membrane potential, or other parameters, into 96-well plates for further single cell analysis (Neves et al., 2004). Ideally suited for liquid samples, such as suspensions of cultured cells or body fluids, solid tissues should be processed prior to analysis. Furthermore, single cell isolation in multi-well plates generally results in a large dilution of the cell contents, thus rendering the analysis of low-copy number molecules very difficult.

Indeed, various methods, including LCM or FACS, provide a solution to the problem of isolating single cells, but they do not solve the problem of analyzing low copy numbers of cellular material such as genes, mRNAS, or proteins. When imbedded in relatively large volumes, small copy numbers yield very low concentrations that, in turn, complicate the analysis or sometimes make it impossible. In such a case, amplification is desirable.

Moreover, cellular material is often diffusible through the cells, making such material difficult to obtain. Similarly, such material may be difficult to reach within the cell, thus requiring cellular lysis. In addition, it can be difficult to keep the cells alive for further study after using methods such as FACS.

There is thus an unmet need to provide an in vitro system that overcomes the limitations discussed above, namely, enabling selection of molecules, and particularly of genes and gene products, in a cell-free system suitable for high throughput screening. There is a similar unmet need to analyze large cell populations (e.g., millions of cells) for the different molecules contained in them (mRNA, protein, DNA) or other qualities on a single cell basis, and in a quantitative manner.

### SUMMARY OF THE INVENTION

The present invention provides an in vitro system for compartmentalization of large molecular or cellular libraries and provides methods for selection and isolation of desired molecules or cells from the libraries using sensitive and precise selection procedures. Specifically, the present invention provides an in vitro system based on a library of molecules or cells. The library includes a plurality of distinct molecules or cells encapsulated within a water-in-oil-in-water emulsion. The emulsion includes a continuous external aqueous phase and a discontinuous dispersion of water-in-oil droplets. The internal aqueous phase of a plurality of such droplets comprises a specific molecule or cell that is within the plurality of distinct molecules or cells of the library.

Such a system is suitable for flow cytometry and other high throughput screening methods. Each droplet can also include a reaction system and, optionally, one or more detectable markers. A water-in-oil-in-water double emulsion comprising the droplets can be prepared, for example, by being re-emulsified from a primary water-in-oil emulsion.

The term “droplet” is used herein in accordance with the meaning normally assigned thereto in the art and further described herein. In essence, a droplet is a compartment whose delimiting borders restrict the exchange of its components described herein with other droplets, thus allowing the sorting of droplets by their molecular content, such as genetic elements, according to the function exerted by said content.

As used herein, “re-emulsified” droplets refer to any emulsion that contains droplets of a first fluid medium dispersed within a continuous phase of a second fluid medium that are in turn dispersed in a continuous phase of the first fluid medium. Typically, re-emulsified droplets comprise primary emulsions essentially consisting of water-in-oil emulsions also termed herein “primary water-in-oil” droplets, the “water-in-oil” droplets are re-emulsified with an external continuous aqueous phase to obtain the re-emulsified droplets.

According to a first aspect the present invention provides an in vitro system for compartmentalization of large molecular libraries and provides methods for selection and isolation of desired molecules from the libraries using sensitive and precise selection procedures. According to one embodiment, the specific molecule is selected from the group consisting of: a genetic element, a protein, a carbohydrate and a small organic molecule that is water soluble.

“Small organic molecule” is used herein as such term is commonly used in the biological and pharmaceutical arts. Exemplary small organic molecules include, but are not limited to, enzyme products, enzyme substrates, antigens or antigenic epitopes, and synthetic organic molecules such as drugs. A small organic molecule can have a molecular weight of up to 2000 Daltons, preferably up to 1000 Daltons, even more preferably between 250 and 750 Daltons and, most preferably, less than 500 Daltons. The small organic molecule can be natural or synthetic.

According to another embodiment, the specific molecule can be a genetic element and the reaction system used for expressing the genetic element. In another embodiment of the invention, each droplet described above further includes at least one additional molecule capable of interacting with the specific molecule. Said interaction results in a detectable signal. As non-limitative examples, the specific molecule can be an enzyme and the additional molecule can be a substrate, or the specific molecule can be an antibody and the additional molecule can be an antigen, or the specific molecule can be a carbohydrate and the additional molecule can be a lectin.

According to certain embodiments, the droplets compartmentalize genetic elements and gene products such that they remain physically linked together. Nucleic acid expression remains possible within the droplets allowing for isolation of nucleic acid on the basis if the activity of the gene product which it encodes. Generally, the molecular content of each water-in-oil-in-water droplet is contained within the internal aqueous phase of the primary water-in-oil droplet.

The advantage of water-in-oil-water droplets of the present invention is that the outer aqueous phase makes these droplets amenable to sorting by any techniques which requires hydrophilic media, for example, FACS, without compromising the integrity of the internal aqueous phase within the water-in-oil droplet. Accordingly, molecules embedded in the aqueous phase of the water-in-oil droplets together with a fluorescent marker can be isolated and enriched from a large excess of molecules embedded in water-in-oil-in-water droplets that do not contain a fluorescent marker.

According to a preferred embodiment, the water-in-oil-in-water droplet further comprises a genetic element capable of modifying at least one molecule within the droplet such that the at least one modified molecule induces formation of a fluorescent signal. The molecule can be, for example, a fluorescent marker or a fluorogenic substrate. It is to be understood that modification may be direct, in that it is caused by the direct action of the gene product on the at least one molecule, or indirect, in which a series of reactions, one or more of which involve the gene product having the desired activity, leads to modification of the at least one molecule.

According to yet another embodiment, the droplet comprises at least one genetic element capable of modifying, directly or indirectly, one or more optical properties of the droplet.

The invention further provides an in vitro system for compartmentalization of single cells and provide methods for selection and isolation of a desired characteristic of such cell. Specifically, the present invention provides an in vitro system based on a water-in-oil-in-water emulsion, the emulsion including an external continuous phase and a discontinuous dispersion of a plurality of water-in-oil droplets. The emulsified water-in-oil droplets can be re-emulsified in a continuous aqueous phase. The system is suitable for flow cytometry and other high throughput screening methods. A plurality of emulsified or double emulsified droplets include at least one specific cell. The cell can be in a reaction system and, optionally, the droplet can include one or more detectable markers.

More particularly, the invention provides a library that includes a plurality of distinct cells encapsulated within a water-in-oil-in-water emulsion. The emulsion includes an external aqueous phase and a discontinuous dispersion of a plurality of water-in-oil droplets. The internal aqueous phase of each droplet contains a specific cell within the plurality of distinct cells. It will be understood by the skilled artisan that the aqueous phase of the emulsions used for cells will comprise at least a balanced salt solution capable of maintaining the cells in the droplets intact. They may further comprise nutrients As used herein, the term “distinct cells” means cells that each has a distinguishable feature from every other cell in the plurality. Preferably, the feature is having a distinct molecule. A “library of cells” refers to a collection of cells where the individual species comprising the library are distinct from other cells of the same library in at least one detectable character.

In an additional embodiment of the invention, single cells can be analyzed for example for enzymatic activity. In another embodiment, the content of each cell can be isolated for further study, for example to determine the level of a compound, such as a particular mRNA or a protein of a single cell, or to determine the sequence of a nucleic acid molecule.

In a further embodiment, single-cell compartmentalization can be used to detect cell response to various stimuli. The stimulus can come from a library of compounds, such as nucleic acids, proteins or other organic molecules. The libraries can be co-compartmentalized with the cells, so that each droplet contains a single cell and a single compound of the library.

In yet another embodiment, libraries of genetic elements, for example cDNA, can be expressed within the single cells and screened for various purposes. Such libraries can be expressed under various formats including cell-display, periplasmic expression, or cytoplasmic expression. The gene product may be secreted into the droplet. The cells can be grown or the genetic elements within them can be isolated or amplified directly.

Such libraries can be screened from man-made or natural genetic diversity. They can be screened for various activity, such as regulatory activity. They can be expressed for various activities on target cells that are co-compartmentalized with the library. Similarly, libraries of compounds can be generated or isolated and tested for various activities on target cells that are co-compartmentalized with the library.

The present invention of compartmentalizing cells, as described herein, has many advantages. For example, it is often desirable to identify and isolate a molecule, such as a gene, mRNA, a protein, or the product of an enzymatic reaction within the cell of interest. However, such molecules may be diffusible from the cell. Alternatively, such molecules may be difficult to obtain from within the cell and, therefore, will require cell lysis. In addition, such molecule may be present at very low concentration and, therefore, require amplification. Finally, it may be desirable to keep the cell viable after analysis for further study.

According to a second aspect, the present invention provides methods for selecting and isolating one or more molecules from a molecular library, the one or more molecule having a desired function. Specifically, the present invention provides a method for selecting, in vitro, one or more desired molecules from an in vitro molecular library comprising droplets, as described below, with at least one distinct molecule within each droplet, each selected distinct molecule induces or exhibits a desired activity and each droplet that contains such molecule can be selected and isolated from the entire population of droplets comprising the entire molecular library.

According to one embodiment of the present invention, there is provided a method for isolating or identifying one or more molecules having a desired function, comprising the steps of:
(a) compartmentalizing molecules within a water-in-oil-in-water emulsion, the emulsion comprising an external aqueous phase and a discontinuous dispersion of water-in-oil droplets; and
(b) screening the droplets for a molecule having the desired function.

The molecule having a desired function can induce a change in the optical properties of the droplet, the change permitting the droplet to be sorted. For example, the change in the optical properties can be a change in fluorescence.

In another embodiment, the molecule is a genetic element, a protein, a polypeptide or a peptide, a carbohydrate or a water soluble small organic molecule.

According to yet another embodiment the molecule is a genetic element encoding a gene product having a desired activity, such that the inner water phase within each water-in-oil droplet comprises at least one genetic element and, optionally, in vitro transcription-translation reaction system. Preferably, the genetic element encodes at least one gene product having a desired activity. In a further embodiment, the gene product remains linked to its genetic element.

According to yet another embodiment, following step (a) the method further comprises the step of expressing the genetic elements to produce their respective gene products within the droplets.

According to yet another embodiment, the activity of the gene product results in the alteration of the expression of a second gene within the droplet and the activity of the product of the second gene enables the isolation of the genetic element.

According to yet another embodiment, the genetic element comprises a ligand such that a desired gene product within the droplet binds to the ligand to enable isolation of the genetic element.

According to yet another embodiment, the screening step comprises detecting the optical change induced by the desired molecule. In a further embodiment, the screening step comprises flow cytometry, fluorescence microscopy, optical tweezers or micro-pipettes. In yet another embodiment, one or more of the molecules described above are each within cells. Additional compositions and methods of the invention directed to cells are described below.

In a further embodiment, the compartmentalizing step additionally includes the steps of:
(i) compartmentalizing molecules into primary water-in-oil droplets; and
(ii) re-emulsifying the primary water-in-oil droplets of (i) with an external aqueous phase to obtain re-emulsified water-in-oil-in-water droplets.

The method of the invention can be performed by further iteratively repeating at least one of the steps. The method can further include isolating a sub-population of droplets that include the genetic element that encodes the desired gene product. The genetic elements within the sub-population of droplets can be pooled and subjected to mutagenesis. The genetic elements can also be re-compartmentalized for further iterative rounds of screening.

The re-emulsified droplets according to the present invention compartmentalize genetic elements and gene products such that they remain physically linked together within the artificial droplets allowing for isolation of nucleic acid on the basis of the activity of the gene product, which it encodes. Surprisingly, the re-emulsified droplets are particularly stable emulsions that withstand the extreme conditions applied during sorting, such that the multiphase water-oil-water arrangement remains intact and the content of each phase remains undisturbed. Subsequently, genes embedded in the central aqueous phase of the re-emulsified droplets together with a fluorescent marker can be sorted, isolated and enriched from a large excess of genes imbedded in re-emulsified water-in-oil droplets that do not contain a fluorescent marker.

Preferably, the droplets used in the method of the present invention can be produced in very large numbers, and thereby to compartmentalize a library of genetic elements that encodes a repertoire of gene products.

The ability to obtain large in vitro gene libraries within re-emulsified water-in-oil-in-water droplets together with the capacity of flow cytometry instruments to sort up to 40,000 events per second endows the method of the invention with a wide potential in the area of high throughput screening and the regime of directed evolution of enzymes.

Another advantage of flow cytometry techniques, such as FACS, for sorting the droplets of the present invention is the ability of such techniques to sort particles by their size, in parallel to sorting the same particles by their fluorescence properties. A population of re-emulsified droplets consists of multiple droplets of various sizes wherein the very large droplets contain a large number of water droplets and therefore reduces the actual enrichment and the small oil droplets appear to contain no water droplets within them and their sorting seems pointless. Thus, sorting by FACS techniques a population of re-emulsified droplets containing genetic elements, enables to limit the sorting procedure to an enriched sub-population of optimized-size droplets while avoiding the very large and small droplets.

According to yet another embodiment of the present invention, there is provided a method for sorting one or more genetic elements encoding a gene product having a desired activity, comprising the steps of:
(a) compartmentalizing genetic elements into primary water-in-oil droplets;
(b) expressing the genetic elements to produce their respective gene products within the primary water-in-oil droplets;
(c) re-emulsifying the primary water-in-oil droplets of (b) with an external aqueous phase to obtain re-emulsified water-in-oil-in-water droplets; and
(d) sorting the genetic elements which produce the gene product(s) having the desired activity, said genetic elements inducing an optical modification in the droplets containing same, by detecting the optical change.

According to a preferred embodiment of the present invention, the droplets further comprise at least one molecule selected from the group consisting of: a fluorescent marker and a fluorogenic substrate.

According to yet another embodiment, the gene library comprises at least one genetic element capable of modifying at least one molecule within the internal water phase, such that the at least one modified molecule induces formation of a fluorescent signal.

According to yet another embodiment of the second aspect of the present invention, following sorting droplets containing the genetic elements that produce the gene product(s) having the desired activity, the droplets are isolated.

According to yet another embodiment, the isolated droplets are coalesced so that all the contents of the individual droplets are pooled.

According to yet another embodiment, the selected genetic elements can be cloned into an expression vector to allow further characterization, amplification and modification of the genetic elements and their products.

The selected genetic element(s) may also be subjected to subsequent, possibly more stringent rounds of sorting in iteratively repeated steps, reapplying the method of the invention either in its entirety or in selected steps only. By tailoring the conditions appropriately, genetic elements encoding gene products having a better optimized activity may be isolated after each round of selection.

Additionally, the droplets isolated after a first round of sorting may be broken, their genetic content subjected to mutagenesis before repeating the compartmentalization into re-emulsified water-in-oil droplets following sorting by iterative repetition of the steps of the method of the invention as set out above. After each round of mutagenesis, some genetic elements will have been modified in such a way that the activity of the gene products is enhanced.

In another aspect, the invention provides a product when selected according to the sorting method of the invention. As used in this context, a “product” may refer to a gene product, such as a polypeptide, a protein or a peptide, selectable according to the invention, the genetic element or genetic information comprised therein.

In yet another aspect, the invention provides a method for preparing a gene product, comprising the steps of:
(a) compartmentalizing genetic elements within droplets of a water-in-oil-in-water emulsion, the emulsion including an external aqueous phase and a discontinuous dispersion of water-in-oil droplets;
(b) expressing the genetic elements to produce the gene product encoded by the genetic elements;
(c) screening the droplets to identify at least one genetic element that produces the gene product; and
(d) isolating the genetic element identified in (c); and
(e) expressing the gene product.

Preferably, the technique for detection is FACS. In accordance with this aspect, step (a) preferably comprises preparing a repertoire of genetic elements, wherein each genetic element encodes a potentially differing gene product. Repertoires may be generated by conventional techniques, such as those employed for the generation of libraries intended for selection by methods such as phage display. Gene products having the desired activity may be selected from the repertoire, according to the present invention.

In yet another aspect, the invention provides a method for screening a compound or compounds capable of modulating the activity of a gene product, comprising the steps of:
(a) preparing a repertoire of genetic elements encoding gene products;
(b) compartmentalizing the genetic elements within droplets of a water-in-oil-in-water emulsion, the emulsion including an external aqueous phase and a discontinuous dispersion of water-in-oil droplets;
(c) expressing the genetic elements to produce their respective gene products within the droplets;
(d) sorting the genetic elements which produce the gene product(s) having the desired activity, wherein a molecule having the desired activity induces, directly or indirectly, a change in the optical properties of the droplet, the change permitting the droplet to be sorted; and
(e) contacting a gene product having the desired activity with the compound or compounds and monitoring the modulation of an activity of the gene product by the compound or compounds.

Advantageously, the method further comprises the step of:
(f) identifying the compound or compounds capable of modulating the activity of the gene product and synthesizing said compound or compounds.

Preferably, sorting is performed by FACS. This selection system can be configured to select for RNA, DNA or protein molecules with catalytic, regulatory or binding activity. These and further objects, features and advantages of the present invention will become apparent from the following detailed description and appended claims.

### BRIEF DESCRIPTION OF THE DRAWINGS

FIG. 1 shows the proposed scheme of selection by in vitro compartmentalization in re-emulsified water-in-oil droplets: (1) Single genes are compartmentalized in a water-in-oil emulsion, and translated in vitro in the presence of a fluorogenic substrate to obtain a primary water-in-oil emulsion. Compartments in which the gene encodes an active enzyme subsequently contain a fluorescent product. (2) A primary water-in-oil emulsion is re-emulsified to produce a water-in-oil-in-water emulsion, thus providing an external aqueous phase. (3) Compartments containing the fluorescent product are isolated by FACS, and the genes imbedded in them, that encode the enzyme of interest, are isolated and amplified.

FIG. 2 shows the stability and enrichment of a population of re-emulsified water-in-oil droplets sorted twice by FACS. A ‘positive’ re-emulsified water-in-oil emulsion containing FITC-BSA in its aqueous droplets was mixed 1:5 with a ‘blank’ re-emulsified water-in-oil emulsion containing buffer only. A. Dot-blot FSC-H (forward scatter) and SSC-H (side scatter) analysis of the double emulsion of the first sort (for clarity, shown are 20% of events). Events gated in R1 (˜90% of total events) were subjected to sorting and analysis. B. Histogram analysis of different populations of the emulsion droplets fluorescence (for R1-gated events). Shown are population analyses: Before sorting: the ‘blank’ re-emulsified water-in-oil emulsion (1), and a 1:5 mix of ‘positive’ and ‘blank’ w/o/w emulsions (2). After sorting: the first (3) and second sort (4). ‘Positive’ events were gated and sorted through M1, and the statistics are given in Table 1.

FIG. 3 shows a model selection of genes in a double emulsion system. A ‘positive’ w/o emulsion containing FolA genes and a fluorescent marker was mixed at a 1:100 ratio with a ‘negative’ w/o emulsion containing buffer and M.HaeIII genes. The mixed water-in-oil emulsion was converted into a re-emulsified water-in-oil emulsion that was then sorted by FACS. A. FSC-H (forward scatter) and SSC-H (side scatter) of the mixed re-emulsified water-in-oil emulsion (for clarity, only 5% of all events are shown). The sub-population gated through R1 was subjected to sorting and analysis. B. A histogram analysis of the pre-sorted re-emulsified water-in-oil emulsion. The M1 marker indicates the range of high-fluorescence chosen for sorting of ‘positive’ droplets. C. A histogram analysis of the sorted re-emulsified water-in-oil emulsion. The statistical analysis of the pre-sorted and sorted population is provided in Table 2. D. Analysis by gel electrophoresis of the PCR amplification of genes isolated from the different re-emulsified water-in-oil emulsions: a separate ‘negative’ emulsion containing the M.HaeIII genes only (yielding an amplification product of 1477 bp); a separate ‘positive’ emulsion containing the FolA genes only (yielding an amplification product of 1214 bp); the 1:100 mixture of ‘positive’ and ‘negative’ emulsions ‘before sorting’ and ‘after sorting’. The ratio between the FolA and M.HaeIII genes in the mixed emulsion is 1:100 before sorting (at this ratio, the amplification product of the FolA gene is not visible) and ˜1:3 after sorting (estimated by eye in comparison to DNA mixtures of known ratios) indicating an enrichment of 30 fold. M denotes marker DNA (100 bp DNA ladder; Fermentas).

FIG. 4 shows a quantitative analysis of the amount of lacZ vs lacZmut DNA by gel electrophoresis and subsequent staining of DNA with ethidium bromide. Lane 1: lacZ DNA; Lane 2-4, 1:10, 1:100 and 1:1000 mixtures of lacZ:lacZmut DNA before (lanes 2-4) and after (lanes 5-7) selection by flow cytometry sorting.

FIG. 5 shows flow cytometry analysis and sorting of a compartmentalized and in vitro expressed Ebg random mutagenesis library. Single members of the Ebg random mutagenesis library were transcribed and translated inside the aqueous compartments of a w/o emulsion in the presence of the fluorogenic substrate FDG. After 60 minutes incubation at 37° C., the w/o emulsion was re-emulsified to get a w/o/w emulsion that is amenable to high speed cell sorting. In each round of sorting, 100,000 events that fell within the indicated sorting gate were collected. DNA from selected double emulsions was extracted and amplified by PCR product was directly used in a next round of sorting. Histograms show the coumarin (Y-axis) and fluorescein (X-axis) fluorescence distribution of double emulsion droplets. Panel A: double emulsions without DNA. Panel B: double emulsions with Ebg random mutagenesis DNA before selection, after 1 selection round (panel C) and after 2 selection rounds (panel D). Panel E: double emulsions containing Ebg Class IV mutant DNA. FIG. 6 shows beta-galactosidase activities of selected clones of the Ebg random mutagenesis library. Graphs show rates of FDG conversion into fluorescein by the expressed Ebg variant (fluorescence units/s). Fluorescence was measured every 45 s for 90 minutes at 37° C. Slopes were determined by taking the first 40 measurements of each curve. As a comparison, beta-galactosidase activities of expressed wt lacZ (well A1, B1), wt Ebg (C1, D1), Ebg Class IV (E1, F1), Ebg Class I (G1, H1, A2, B2) and Ebg Class II (C2, D2, E2, F2) are also indicated.

FIG. 7 shows activity tests of the wild type beta-galactosidase of Thermus thermophilus HB27 in the primary w/o emulsion (emulsion I) at 80° C. using FDG as fluorogenic substrate. A preliminary 30-minute incubation of the water-in-oil emulsion at 30° C. allowed in vitro translation. Fluorescence emission (arbitrary units) was measured on 150 μl of emulsion I in a 96-well plate (excitation 485 nm/emission 514 nm).

FIG. 8 shows results of activity tests of the wild type beta-galactosidase of Arthrobacter psychrolactophilus B7 (Lac Z) in the primary w/o emulsion at 4° C. and 10° C. with 10 or 20 min pre-incubation at 30° C. to allow efficient in vitro transcription. Fluorescence emissions were measured on 100 μl of emulsion I in a 96-well cell culture plate (excitation 485 nm/emission 514 nm). Fluorescence (arbitrary units) corresponds to the ratio of LacZ fluorescence and control fluorescence (same experiment without gene).

FIG. 9 shows exchange tests in emulsion I (EI). The tests were carried out with 0.1 nM of the wild type beta-galactosidase gene of Thermus thermophilus HB27 (This) after a 30-minute incubation at 90° C., as well as 0.1 nM of Arthrobacter psychrolactophilus B7 (Ahis) beta-galactosidase gene after a 12-hours incubation at 4° C. A preliminary 30-minute incubation of the water-in-oil emulsion was performed at 30° C. for the thermophilic strain to allow in vitro translation, while only a 10-minute preliminary 30° C. incubation was performed for the psychrophilic strain. Blank samples correspond to an emulsion I (EI) without gene but submitted to the same conditions of incubation. 50 μl of two primary water-in-oil emulsions from an incomplete IVT mix were mixed, the first one containing 0.5 mM FDG but no gene (annotated “substrate EI”), and the second one containing the IVT mix without FDG (annotated “gene EI”). Fluorescence of both complete first emulsion and of the mix of the two incomplete emulsions were compared by measuring 100 μl in a 96-well cell culture plate by fluorimeter (excitation 485 nm/emission 514 nm).

FIG. 10 shows FACS analysis of double emulsion from His-tagged Thermus sp T2 (T2his) beta-galactosidase genes. Each panel shows the FACS results (fluorescence emission, arbitrary units) of a negative control corresponding to a blank without DNA (on the left) and a positive T2his wild type sample (on the right). Each experiment was started by a 30 min pre-incubation at 30° C. to allow in vitro translation. Panel A corresponds to a 15 min incubation at 90° C. and Panel B to an incubation of 15 min at 95° C. The reference gate of positive events was designed by excluding the region defined by the negative control, the percentage on the top right of the gate is the quantity of positive events inside the corresponding gate. Fluorescence (arbitrary units): FL2=7-hydroxycoumarin-3 carboxylic acid emission (450-465 nm bandpass filter); FL7=fluorescein emission (530-540 nm bandpass filter).

FIG. 11 shows FACS analysis of double emulsion from his-tagged Thermus thermophilus HB27 (This) and Thermus sp T2 (T2his) beta-galactosidase genes. The graph shows the percentage of positive events for both wild-type (wt) beta-galactosidase genes and libraries before selection. The negative control (blank) corresponding to an experiment realized without DNA but with all other reaction components. Labelling rules: “T2his 1/8”=strain T2, his tagged beta-galactosidase gene library with 8-time diluted base-mix.

FIG. 12 shows the enrichment of Thermus sp T2 his-tagged beta-galactosidase 1/16 library after two successive rounds of FACS selection of double emulsions. The procedure used 0.1 nM of DNA, 0.5 mM FDG and a 20-minute incubation at 90° C. (following a 30-minute preliminary incubation at 30° C.). The negative control (blank) was performed under the same conditions but without DNA. The wild-type (wt) population is given as reference. The reference gate of positive events was designed by excluding the region defined by the negative control, the percentage on the top right of the gate is the quantity of positive events inside the corresponding gate. Fluorescence (arbitrary units): FL2=7-hydroxycoumarin-3 carboxylic acid emission (450-465 nm bandpass filter); FL7=fluorescein emission (530-540 nm bandpass filter).

FIG. 13 shows FACS analysis of Arthrobacter psychrolactophilus B7 his-tagged beta-galactosidase in double emulsion. The procedure involved 0.1 nM of DNA, 0.5 mM FDG and 12-hour incubation at 4° C. (following 10-minute preliminary incubation at 30° C.). The negative control (blank) was performed in the same conditions but without DNA. wt: wild type Arthrobacter psychrolactophilus B7 beta-galactosidase gene; 1/8: lacZ gene library with higher level of mutations; 1/16: lacZ gene library with intermediate level of mutations; 1/22: lacZ gene library with lower level of mutations. The reference gate of positive events was designed by excluding the region defined by the negative control, the percentage on the top right of the gate is the quantity of positive events inside the corresponding gate. Fluorescence (arbitrary units): FL2=7-hydroxycoumarin-3 carboxylic acid emission (450-465 nm bandpass filter); FL7=fluorescein emission (530-540 nm bandpass filter).

FIG. 14 shows single-cell compartmentalization and selection by in vitro compartmentalization (IVC) in w/o/w emulsions. A. A schematic of (1) a gene library being transformed and cloned into E. coli, with (2) the encoded proteins allowed to translate in the cytoplasm, or on the surface of the bacteria cells. (3) Single cells are compartmentalized in the aqueous droplets of a w/o emulsion. (4) The fluorogenic substrate is added (through the oil phase), and w/o/w emulsion is formed by emulsification of the primary w/o emulsion, enveloping the aqueous droplets with an intermediate layer of oil and providing an external aqueous phase. (5) Compartments containing the fluorescent product are sorted by FACS, and the cells imbedded in them are isolated, together with the gene encoding the enzyme of interest.

B. Detection of TBLase activity. Hydrolysis of γTBL (R═H) or HcyT (R═NH₂) releases a free thiol that reacts with the thiol-detecting reagent CPM to give a fluorescent dye-product adduct. See Pavari et al.

FIG. 15 shows FACS detection and sorting of the TBLase activity of PON1-carrying E. coli cells in w/o/w emulsion droplets. Cells expressing in their cytoplasm a particular PON1 variant were emulsified, together with the γTBL substrate and the thiol-detecting dye. (A) Representative dot-blot FSC-H (forward scatter) and SSC-H (side scatter) analysis of the double emulsion. Events gated in R1 (˜30% of total events) were subjected to sorting and analysis. (B) For increased sorting rate and enrichment, cells were labeled by GFP expression. Shown is a histogram of the GFP emission for the R1 population of droplets. Events gated in R2 (˜30% of R1 gated events, or 9% of total events) correspond to droplets that contain single E. coli cells. (C) The R1+R2 gated events were analyzed for TBLase activity. Shown is a histogram of the fluorescence at 450 nm corresponding to the thiol-derivatized dye. Indicated are three samples of different PON1 variants: the inactive H115Q mutant (red), wt PON1 (green), and the 100-fold improved variant 1E9 (blue). (1)) Catalytic parameters and statistical analysis indicating, for each variant, the percentage of ‘positive’ events (out of R1+R2-gated events) in the M1-, and M2-gated events, and the calculated enrichment factor (percentage of positives for 1E9 divided by wt PON1).

FIG. 16 (A) is a FACS histogram analysis of the TBLase activity detected by the 450 nm fluorescence intensity observed in w/o/w emulsions prepared with E. coli cells expressing: wt PON1 (WT, orange), the un-selected PON1 library (R0, purple), and the library after one (R1, red), two (R2, green) and three (R3, blue) rounds of FACS enrichment; (B) is a bar graph showing the increase in the percentage of positive events (M1 gate), and TBLase activity, for the various rounds of enrichment. The TBLase activity was measured in lysates prepared from the pool of cells obtained after each round and were normalized to the activity exhibited by wt PON1 under the same conditions.

FIG. 17 shows FACS detection of the TBLase activity of surface-displayed PON1 variants compartmentalized in w/o/w double emulsions. E. coli cells displaying different PON1 variants were separately emulsified and analyzed. Shown is a histogram for fluorescence at 450 nm corresponding to the thiol-derivatized dye, for a sub-population gated by droplet size, as in region R1 of FIG. 15A. Indicated are: a highly mutated PON1 gene library exhibiting no TBLase activity (Mut, in red), wt PON1 (k_{cat}/Kₘ<100 M⁻¹s⁻¹; in green), and (in blue) a 93-fold improved variant 1HT. The percentage of ‘positive’ events in M1 (out of R1) was found to be: 0.01% for the mutated PON1 library, 0.26% for wt PON1, and 2.3% for the improved 1HT variant. The calculated enrichment factor is therefore: 26 fold for enrichment of wt PON1 from the mutated library, and 230 fold for the enrichment of the 1HT variant.

### DETAILED DESCRIPTION OF THE INVENTION

Definitions

The term “emulsion” as used herein is in accordance with the meaning normally assigned thereto in the art and further described herein. In essence, however, an emulsion may be produced from any suitable stable combination of immiscible liquids. Preferably the “primary emulsion” of the present invention has an aqueous phase that contains the molecular components, as the dispersed phase present in the form of finely divided droplets (the disperse, internal or discontinuous phase) and a hydrophobic, liquid immiscible in the aqueous phase (an “oil”) as the matrix in which these droplets are suspended (the continuous or external phase). Such emulsions are termed “water-in-oil” (w/o). This has the advantage that the entire aqueous phase containing the molecular components is compartmentalized in discrete droplets (the internal phase). The hydrophobic oil phase generally contains none of the biochemical components and hence is inert. According to the present invention, the primary water-in-oil emulsions are further re-emulsified in a continuous aqueous phase thus forming the water-in-oil-in-water emulsions. It should be understood that the non-aqueous phase is not limited to any particular type of oil. It is to be explicitly understood that the emulsions may further comprise natural or synthetic emulsifiers, co-emulsifiers, stabilizers and other additives as are well known in the art. As used herein, a “genetic element” is a molecule, a molecular construct or a cell comprising a nucleic acid. The genetic elements of the present invention may comprise any nucleic acid (for example, DNA, RNA or any analogue, natural or artificial, thereof). The nucleic acid component of the genetic element may moreover be linked, covalently or non-covalently, to one or more molecules or structures, including proteins, chemical entities and groups, solid-phase supports such as magnetic beads, and the like. In the methods of the invention, these structures or molecules can be designed to assist in the sorting and/or isolation of the genetic element encoding a gene product with the desired activity. It is further to be understood that the genetic elements of the present invention may be present within a cell, virus or phage.

The term “expression” as used herein, is used in its broadest meaning, to signify that a nucleic acid contained in the genetic element is converted into its gene product. Thus, where the nucleic acid is DNA, expression refers to the transcription of the DNA into RNA; where this RNA codes for protein, expression may also refer to the translation of the RNA into protein. Where the nucleic acid is RNA, expression may refer to the replication of this RNA into further RNA copies, the reverse transcription of the RNA into DNA and optionally the transcription of this DNA into further RNA molecule(s), as well as optionally the translation of any of the RNA species produced into protein. Preferably, therefore, expression is performed by one or more processes selected from the group consisting of transcription, reverse transcription, replication and translation.

Expression of the genetic element may thus be directed into either DNA, RNA or protein, or a nucleic acid or protein containing unnatural bases or amino acids (the gene product) within the droplet of the invention, so that the gene product is confined within the same droplet as the genetic element.

The genetic element and the gene product thereby encoded are linked by confining each genetic element and the respective gene product encoded by the genetic element within the same droplet. In this way the gene product in one droplet cannot cause a change in any other droplets.

A “library” refers to a collection of cells or molecules wherein a plurality of individual species comprising the library are distinct from other cells or molecules of the same library in at least one detectable characteristic. Examples of libraries of molecules include libraries of nucleic acids, peptides, polypeptides, proteins, fusion proteins, peptide hormones or hormone precursors, carbohydrates, polynucleotides, oligonucleotides, and small organic molecules. The molecules may be naturally-occurring or artificially synthesized. The term “cells” encompasses eukaryotic, prokaryotic cells or archaeal cells. Other types of libraries are also encompassed within the scope of the present invention including libraries of viruses or phages and display libraries that include microbead-, phage-, plasmid-, or ribosome-display libraries and libraries made by CIS display and mRNA-peptide fusion. It is to be understood that every member of the library does not have to be different from every other member. Often, there can be multiple identical copies of individual library members.

A “bioactive” or “biologically active” moiety is any compound, either man-made or natural, that has an observable effect on a cell, a cell component or an organism. The observable effect is the “biological activity” of the compound.

The term “variant” as used herein refers to a protein that possesses at least one modification compared to the original protein. Preferably, the variant is generated by modifying the nucleotide sequence encoding the original protein and then expressing the modified protein using methods known in the art. A modification may include at least one of the following: deletion of one or more nucleotides from the sequence of one polynucleotide compared to the sequence of a related polynucleotide, the addition of one or more nucleotides or the substitution of one nucleotide for another. Accordingly, the resulting modified protein may include at least one of the following modifications: one or more of the amino acid residues of the original protein are replaced by different amino acid residues, or are deleted, or one or more amino acid residues are added to the original protein. Other modification may be also introduced, for example, a peptide bond modification, cyclization of the structure of the original protein. A variant may have an altered binding ability to a cellulase substrate than the original protein. A variant may encompass all stereoisomers or enantiomers of the molecules of interest, either as mixtures or as individual species.

The terms “polypeptide”, “peptide” and “protein” are used interchangeably to refer to polymers of amino acids of any length. These terms also apply to amino acid polymers in which one or more amino acid residues is an artificial chemical analogue of a corresponding naturally occurring amino acid, as well as to naturally occurring amino acid polymers. An amino acid polymer in which one or more amino acid residues is an “unnatural” amino acid, not corresponding to any naturally occurring amino acid, is also encompassed by the use of the terms “protein”, “peptide” and “polypeptide” herein.

General Description

All high throughput screening methodologies rely on means of compartmentalizing assay reactions in the smallest possible volume, and means of rapidly screening these compartments by virtue of an easily detected signal. The ability of modem fluorescence activated cell sorter (FACS) instruments to analyze and sort up to 40,000 events per second has given this technology a wide potential in the area of high throughput screening and directed evolution of enzymes [Ibrahim et al., 2003]. FACS technology has been used to screen libraries of proteins displayed on bacterial, yeast and mammalian cells [Wittrup 2001; Daugherty et al. 1998; Daugherty et al., 2000]. Whilst these screening systems have yielded highly useful tailor-made proteins [Boder et al., 2000], they have certain limitations:

They rely on living cells to compartmentalize the gene-library and display the selected proteins.

Selection is primarily through binding interactions [Wittrup 2001], although enzymatic activity has been selected for in a particular case where the fluorescent product could associate with the cell surface [Olsen et al. 2000].

Although FACS has also been applied in conjunction with completely in vitro systems such as in vitro compartmentalization by sorting microbeads, these selections rely on the attachment of the enzymatic product to the gene via a microbead, and require the use of substrates modified, for example, with a linker and caged-biotin [Griffiths et al., 2003].

Despite the above limitations, fluorescence is one of the most sensitive and versatile ways of detecting biological activities and is extremely useful in the context of high-throughput screens (HTS). Both binding interactions of small ligands and proteins labeled with a fluorescent tag and enzymatic activities using fluorogenic substrates, namely substrates that release fluorescent products, can be monitored. Fluorescence energy transfer (FRET) has further widened the scope of fluorescence in HTS by enabling the detection of binding interactions also by using fluorescent proteins (e.g., GFP) that are expressed with the binding pair [Harpur et al. 2001; Mahajan et al. 1998] as well as enzymatic activities [Olsen et al., 2000; List et al., 1998].

In vitro compartmentalization (IVC) uses the aqueous droplets of water-in-oil emulsions as cell-like compartments. In each of these aqueous droplets (of ˜2 μm diameter), a single gene is transcribed and translated to give multiple copies of the protein it encodes. This ensures that the gene, the protein it encodes and the products of the activity of this protein all remain within the same compartment, thus providing a linkage between the gene and its molecular phenotype (e.g., enzymatic activity). By applying an appropriate selection pressure, genes encoding proteins with the desired activity (binding or enzymatic) can be selected from large pools of genes [Tawfik and Griffiths, 1998]. Given the high capacity of IVC (>10¹⁰ discrete compartments are available in 1 mL of emulsion), the direct sorting by FACS of artificial cell-like compartments in which single genes are transcribed and translated, provides the basis for versatile and powerful HTS systems. Using fluorogenic substrates, compartments that carry a gene encoding an enzyme with the desired activity would become fluorescent and could then be isolated by FACS. In principle, display-libraries could also be compartmentalized in water-in-oil emulsions together with fluorogenic substrates to enable their direct selection for enzymatic activities. However, the water-in-oil emulsions that are previously known for IVC have a continuous oil phase that is not compatible with FACS. The present invention provides a compartmentalization systems based on double emulsions, namely water-in-oil-in-water (w/o/w), that comprise an external continuous aqueous phase without the alteration of the aqueous droplets imbedded in the primary water-in-oil emulsion. The additional external aqueous phase of the w/o/w (double) emulsion makes the emulsion amenable to sorting by flow cytometry without compromising the integrity of the inner aqueous droplets within the oil phase.

The present invention provides methods for sorting re-emulsified water-in-oil stable droplets by FACS while the individual droplets remain intact. Subsequently, genes imbedded in the aqueous droplets of the primary water-in-oil droplets together with a fluorescent marker can be isolated and enriched from a large excess of genes imbedded in re-emulsified water-in-oil droplets that do not contain a fluorescent marker.

The droplets of the present invention in conjunction with the methods of the invention provide an advantageous sorting and isolating platform with the following characteristics:

The w/o/w emulsion droplets are stable and withstand the pressure and shear force of the FACS.

No mixing of content between droplets of the primary water-in-oil emulsion takes place throughout the sorting under the harsh experimental FACS conditions.

Sorting of w/o/w emulsions allows highly-fluorescent droplets to be isolated and enriched by many fold, whilst the droplet size and shape distribution remain intact.

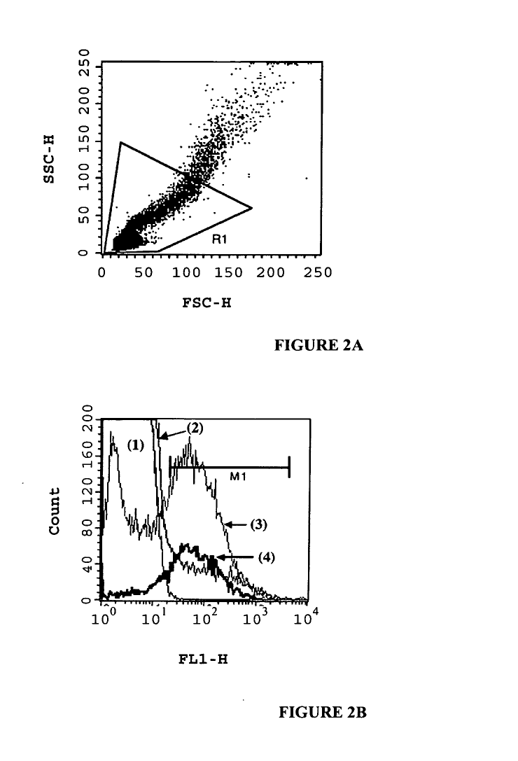

W/o/w droplets isolated by FACS may be re-sorted to show yet additional enrichment whilst the physical characteristics of the droplets remain unchanged (e.g., FIG. 2B).

The methods of the present invention enable enzymatic activities to be detected and selected with a wide range of available soluble fluorogenic substrates that require no immobilization or attachment. Selection according to the present invention may be completely in vitro—namely, the enzyme molecules can be expressed from gene libraries generated by PCR, using a cell-free extract imbedded in the aqueous droplets of the primary water-in-oil emulsion; such processes involve no cloning or transformation. The methods of the present invention further enable to compartmentalize in w/o emulsions various display libraries (libraries of proteins that are physically linked to their coding gene; e.g., cell-, bacterial-, microbead-, phage-, plasmid-, or ribosome-display, or mRNA-peptide fusion libraries) [Daugherty et al., 1998; Wittrup, 2001; Griffiths and Tawfik, 2003; Smith et al., 1997; Little et al., 1995; Cull et al., 1992; Amstutz et al., 2001; Roberts et al., 1997] together with soluble fluorogenic substrates. Display-libraries cannot be selected directly for enzymatic activity [Griffiths and Tawfik, 2000] except in those cases where the fluorescent product associates with the cell surface [Olsen et al., 2000]. Emulsification in w/o/w emulsions may enable the subsequent isolation of genes encoding the desired enzyme, while circumventing the need to have the product physically linked to the displayed protein. All screening and selection procedures make use of compartmentalization, be it in tubes, wells of microtitre plates or other 2D arrays, or nanodroplets [Borchardt et al., 1997]. The ability to create miniature aqueous compartments of a few microns diameter, and then sort these compartments by FACS, therefore widens the scope and capacity of HTS and provide yet another powerful tool for the in vitro evolution of enzymes.

Preferred Modes for Carrying Out the Invention

According to a first aspect the present invention provides a gene library comprising a plurality of re-emulsified water-in-oil droplets, each droplet comprises an external water phase surrounding a central water-in-oil droplet, the internal water phase within each droplet comprises a genetic element, in vitro transcription-translation reaction system.

The droplets of the present invention require appropriate physical properties to allow the working of the invention.

First, to ensure that the genetic elements and gene products may not diffuse between primary water-in-oil droplets or between re-emulsified water-in-oil droplets, the-contents of each droplet must be isolated from the contents of the surrounding droplets, so that there is no or little exchange of the generic elements and gene products between the droplets over the timescale of the experiment.

Second, the method of the present invention requires that there are only a limited number of genetic elements per droplet This ensures that the gene product of an individual genetic element will be isolated from other genetic elements. Thus, coupling between genetic element and gene product will be highly specific. The enrichment factor is greatest with on average one or fewer genetic elements per droplet, the linkage between nucleic acid and the activity of the encoded gene product being as tight as is possible, since the gene product of an individual genetic element will be isolated from the products of all other genetic elements. However, even if the theoretically optimal situation of, on average, a single genetic element or less per droplet is not used, a ratio of 5, 10, 50, 100 or 1000 or more genetic elements per droplet may prove beneficial in sorting a large library. Subsequent rounds of sorting, including renewed encapsulation with differing genetic element distribution, will permit more stringent sorting of the genetic elements. Preferably, there is a single genetic element, or fewer, per droplet.

Third, the formation and the composition of the droplets must not interrupt with the function of the expression machinery of the genetic elements and the activity of the gene products.

Consequently, any microencapsulation system used must fulfill these three requirements. The appropriate system(s) may vary depending on the precise nature of the requirements in each application of the invention, as will be apparent to the skilled person.

A wide variety of microencapsulation procedures are available (see Benita, 1996) and may be used to create microcapsules used in accordance with the present invention. Indeed, more than 200 microencapsulation methods have been identified in the literature (Finch, 1993). These include membrane enveloped aqueous vesicles such as lipid vesicles (liposomes; New, 1990) and non-ionic surfactant vesicles (van Hal et al., 1996). These are closed-membranous capsules of single or multiple bilayers of non-covalently assembled molecules, with each bilayer separated from its neighbor by an aqueous compartment. In the case of liposomes the membrane is composed of lipid molecules; these are usually phospholipids but sterols such as cholesterol may also be incorporated into the membranes (New, 1990). A variety of enzyme-catalyzed biochemical reactions, including RNA and DNA polymerization, can be performed within liposomes (Chakrabarti et al., 1994; Oberholzer et al., 1995a; Oberholzer et al., 1995b; Walde et al., 1994; Wick & Luisi, 1996).

With a membrane-enveloped vesicle system much of the aqueous phase is outside the vesicles and is therefore non-compartmentalized. This continuous, aqueous phase should be removed or the biological systems in it inhibited or destroyed (for example, by digestion of nucleic acids with DNase or RNase) in order that the reactions are limited to the droplets (Luisi et al., 1987).

Enzyme-atalyzed biochemical reactions have also been demonstrated in droplets generated by a variety of other methods. Many enzymes are active in reverse micellar solutions (Bru & Walde, 1991; Bru & Walde, 1993; Creagh et al., 1993; Haber et al., 1993; Kumar et al., 1989; Luisi & B., 1987; Mao & Walde, 1991; Mao et al., 1992; Perez et al., 1992; Walde et al., 1994; Walde et al., 1993; Walde et al., 1988) such as the AOT-isooctane-water system (Menger & Yamada, 1979).

Droplets can also be generated by interfacial polymerization and interfacial complexation (Whateley, 1996). Droplets of this sort can have rigid, nonpermeable membranes, or semipermeable membranes. Semipermeable droplets bordered by cellulose nitrate membranes, polyamide membranes and lipid-polyamide membranes can all support biochemical reactions, including multienzyme systems (Chang, 1987; Chang, 1992; Lim, 1984). Alginate/polylysine droplets (Lim & Sun, 1980), which can be formed under very mild conditions, have also proven to be very biocompatible, providing, for example, an effective method of encapsulating living cells and tissues (Chang, 1992; Sun et al., 1992). Non-membranous microencapsulation systems based on phase partitioning of an aqueous environment in a colloidal system, such as an emulsion, may also be used.

Preferably, the droplets of the present invention are formed from emulsions. The primary water-in-oil droplets are formed from heterogeneous systems of two immiscible liquid phases with one of the phases dispersed in the other as droplets of microscopic or colloidal size (Becher, 1957; Sherman, 1968; Lissant, 1974; Lissant, 1984).

Emulsions may be produced from any suitable combination of immiscible liquids. Preferably the primary emulsion of the present invention has water that contains the biochemical components, as the phase present in the form of finely divided droplets (the disperse, internal or discontinuous phase) and a hydrophobic, immiscible liquid (an ‘oil’) as the matrix in which these droplets are suspended (the nondisperse, continuous or external phase). Such emulsions are termed ‘water-in-oil’ (w/o). This has the advantage that the entire aqueous phase containing the biochemical components is compartmentalized in discreet droplets (the internal phase). The hydrophobic oil phase, generally contains none of the biochemical components and hence is inert.

The primary emulsion may be stabilized by addition of one or more surface-active agents (surfactants). These surfactants are termed emulsifying agents and act at the water/oil interface to prevent (or at least delay) separation of the phases. Many oils and many emulsifiers can be used for the generation of water-in-oil emulsions; a recent compilation listed over 16,000 surfactants, many of which are used as emulsifying agents (Ash and Ash, 1993). Particularly suitable oils include light white mineral oil and non-ionic surfactants (Schick, 1966) such as sorbitan monooleate (Span™80; ICI) and polyoxyethylenesorbitan monooleate (Tween™ 80; ICI).

The use of anionic surfactants may also be beneficial. Suitable surfactants include sodium cholate and sodium taurocholate. Particularly preferred is sodium deoxycholate, preferably at a concentration of 0.5% w/v, or below. Inclusion of such surfactants can in some cases increase the expression of the genetic elements and/or the activity of the gene products. Addition of some anionic surfactants to a non-emulsified reaction system completely abolishes translation. During emulsification, however, the surfactant is transferred from the aqueous phase into the interface and activity is restored. Addition of an anionic surfactant to the mixtures to be emulsified ensures that reactions proceed only after compartmentalization.

Creation of an emulsion generally requires the application of mechanical energy to force the phases together. There are a variety of ways of doing this, which utilize a variety of mechanical devices, including stirrers (such as magnetic stir-bars, propeller and turbine stirrers, paddle devices and whisks), homogenizes (including rotor-stator homogenizes, high-pressure valve homogenizes and jet homogenizes), colloid mills, ultrasound and ‘membrane emulsification’ devices (Becher, 1957; Dickinson, 1994).

Water-in-oil droplet emulsions of the present invention, are generally stable with little if any exchange of genetic elements or gene products between the droplets. Additionally, biochemical reactions proceed in emulsion droplets. Moreover, complicated biochemical processes, notably gene transcription and translation are also active in emulsion droplets. The technology exists to create emulsions with volumes all the way up to industrial scales of thousands of liters (Becher, 1957; Sherman, 1968; Lissant, 1974; Lissant, 1984).

The preferred droplet size will vary depending upon the precise requirements of any individual selection process that is to be performed according to the present invention. In all cases, there will be an optimal balance between gene library size, the required enrichment and the required concentration of components in the individual droplets to achieve efficient expression and reactivity of the gene products.

The processes of expression must occur within each individual droplet provided by the present invention. Both in vitro transcription and coupled transcription-translation become less efficient at sub-nanomolar DNA concentrations. Because of the requirement for only a limited number of DNA molecules to be present in each droplet, this therefore sets a practical upper limit on the possible droplet size. The mean volume of the primary droplets may be less that 5.2·10⁻¹⁶m³, (corresponding to a spherical droplet of diameter less than 10 μm, less than 6.5·10⁻¹⁷m³, (5 μm), about 4.2·10⁻¹⁸m³ (2 μm) or about 9·10⁻¹⁸m³ (2.6 μm).

The effective genetic element, namely, DNA or RNA, concentration in the droplets may be artificially increased by various methods that will be well-known to those versed in the art. These include, for example, the addition of volume excluding chemicals such as polyethylene glycols (PEG) and a variety of gene amplification techniques, including transcription using RNA polymerases including those from bacteria such as E. coli (Roberts, 1969; Blattner and Dahlberg, 1972; Roberts et al., 1975; Rosenberg et al., 1975), eukaryotes e.g. (Weil et al., 1979; Manley et al., 1983) and bacteriophage such as T7, T3 and SP6 (Melton et al., 1984); the polymerase chain reaction (PCR) (Saiki et al., 1988); Qβ replicase amplification (Miele et al., 1983; Cahill et al., 1991; Chetverin and Spirin, 1995; Katanaev et al., 1995); the ligase chain reaction (LCR) (Landegren et al., 1988; Barany, 1991); and self-sustained sequence replication system (Fahy et al., 1991) and strand displacement amplification (Walker et al., 1992). Even gene amplification techniques requiring thermal cycling such as PCR and LCR could be used if the emulsions and the in vitro transcription or coupled transcription-translation systems are thermostable (for example, the coupled transcription-translation systems could be made from a thermostable organism such as Thermus aquaticus).

Increasing the effective local nucleic acid concentration enables larger droplets to be used effectively. This allows a practical upper limit to the droplet volume of about 5.2·10⁻¹⁶m³ (corresponding to a sphere of diameter 10 μm).

The droplet size must be sufficiently large to accommodate all of the required components of the biochemical reactions that are needed to occur within the droplet. For example, in vitro, both transcription reactions and coupled transcription-translation reactions require a total nucleoside triphosphate concentration of about 2 mM.

For example, in order to transcribe a gene to a single short RNA molecule of 500 bases in length, this would require a minimum of 500 molecules of nucleoside triphosphate per droplet (8.33·10⁻²² moles). In order to constitute a 2 mM solution, this number of molecules must be contained within a droplet of volume 4.17·10⁻¹⁹ liters (4.17·10⁻²m³ which if spherical would have a diameter of 93 nm).

Furthermore, particularly in the case of reactions involving translation, it is to be noted that the ribosomes necessary for the translation to occur are themselves approximately 20 nm in diameter. Hence, the preferred lower limit for primary droplets is a diameter of approximately 0.1 μm (100 nm). Therefore, the primary droplet volume is of the order of between 5.2·10⁻²²m³ and 5.2 10⁻¹⁶m³ corresponding to a sphere of diameter between 0.1 μm and 10 μm, preferably of between about 5.2·10⁻¹⁹m³ and 6.5-10⁻⁷m³ (1 μM and 5 μm). Sphere diameters of about 2.6 μm are advantageous.

It is no coincidence that the preferred dimensions of the primary compartments (droplets of 2.6 μm mean diameter) closely resemble those of bacteria, for example, Escherichia are 1.1-1.5·2.0-6.0 μm rods and Azotobacter are 1.5-2.0 μM diameter ovoid cells. In its simplest form, Darwinian evolution is based on a ‘one genotype one phenotype’ mechanism. The concentration of a single compartmentalized gene, or genome, drops from 0.4 nM in a compartment of 2 μm diameter, to 25 pM in a compartment of 5 μm diameter. The prokaryotic transcription/translation machinery has evolved to operate in compartments of about 1-2 μm diameter, where single genes are at approximately nanomolar concentrations. A single gene, in a compartment of 2.6 μm diameter is at a concentration of 0.2 nM. This gene concentration is high enough for efficient translation. Compartmentalization in such a volume also ensures that even if only a single molecule of the gene product is formed it is present at about 0.2 nM, which is important if the gene product is to have a modifying activity of the genetic element itself. The volume of the primary droplet should thus be selected bearing in mind not only the requirements for transcription and translation of the genetic element, but also the modifying activity required of the gene product in the method of the invention.

The size of emulsion primary and re-emulsified droplets may be varied simply by tailoring the emulsion conditions used to form the emulsion according to requirements of the selection system. The larger the droplet size, the larger is the volume that will be required to encapsulate a given genetic element library, since the ultimately limiting factor will be the size of the droplet and thus the number of droplets possible per unit volume.

The size of the droplets is selected not only having regard to the requirements of the transcription/translation system, but also those of the selection system employed for the genetic element. Thus, the components of the selection system, such as a chemical modification system, may require reaction volumes and/or reagent concentrations which are not optimal for transcription/translation. As set forth herein, such requirements may be accommodated by a secondary re-encapsulation step; moreover, they may be accommodated by selecting the droplet size in order to maximize transcription/translation and selection as a whole. Empirical determination of optimal droplet volume and reagent concentration, for example as set forth herein, is preferred.

A “genetic element” in accordance with the present invention is as described above. Preferably, a genetic element is a molecule or construct selected from the group consisting of a DNA molecule, an RNA molecule, a partially or wholly artificial nucleic acid molecule consisting of exclusively synthetic or a mixture of naturally-occurring and synthetic bases, any one of the foregoing linked to a polypeptide, and any one of the foregoing linked to any other molecular group or construct. Advantageously, the other molecular group or construct may be selected from the group consisting of nucleic acids, polymeric substances, particularly beads, for example polystyrene beads, magnetic substances such as magnetic beads, labels, such as fluorophores or isotopic labels, chemical reagents, binding agents such as macrocycles and the like.

The nucleic acid portion of the genetic element may comprise suitable regulatory sequences, such as those required for efficient expression of the gene product, for example promoters, enhancers, translational initiation sequences, polyadenylation sequences, splice sites and the like.

Preferably, the genetic element comprises a nucleic acid or construct encoding a polypeptide or other molecular group, which is a ligand or a substrate that directly or indirectly binds to or reacts with the gene product in order to tag the genetic element. This allows the sorting of the genetic element on the basis of the activity of the gene product.

A ligand or substrate may be connected to the nucleic acid by a variety of means that will be apparent to those skilled in the art (see, for example, Hermanson, 1996). Any tag will suffice that allows for the subsequent selection of the genetic element by FACS techniques. Sorting by FACS can be accompanied by an additional sorting step using any method which allows the preferential separation, amplification or survival of the tagged genetic element. Examples include selection by binding (including techniques based on magnetic separation, for example using Dynabeads™), and by resistance to degradation (for example by nucleases, including restriction endonucleases).

One way in which the nucleic acid molecule may be linked to a ligand or substrate is through biotinylation. This can be done by PCR amplification with a 5′-biotinylation primer such that the biotin and nucleic acid are covalently linked.

The ligand or substrate to be selected can be attached to the modified nucleic acid by a variety of means that will be apparent to those of skill in the art. A biotinylated nucleic acid may be coupled to a polystyrene microbead (0.03 to 0.25 μm in diameter) that is coated with avidin or streptavidin, that will therefore bind the nucleic acid with very high affinity. This bead can be derivatized with substrate or ligand by any suitable method such as by adding biotinylated substrate or by covalent coupling.

Alternatively, a biotinylated nucleic acid may be coupled to avidin or streptavidin complexed to a large protein molecule such as thyroglobulin (669 Kd) or ferritin (440 Kd). This complex can be derivatized with substrate or ligand, for example by covalent coupling to the ε-amino group of lysines or through a non-covalent interaction such as biotin-avidin. The substrate may be present in a form unlinked to the genetic element but containing an inactive “tag” that requires a further step to activate it such as photoactivation (e.g. of a “caged” biotin analogue; Sundberg et al., 1995; Pirrung and Huang, 1996). The catalyst to be selected then converts the substrate to product. The “tag” could then be activated and the “tagged” substrate and/or product bound by a tag-binding molecule (e.g. avidin or streptavidin) complexed with the nucleic acid. The ratio of substrate to product attached to the nucleic acid via the “tag” will therefore reflect the ratio of the substrate and product in solution.

An alternative is to couple the nucleic acid to a product-specific antibody (or other product-specific molecule). In this scenario, the substrate (or one of the substrates) is present in each droplet unlinked to the genetic element, but has a molecular “tag” (for example biotin, DIG or DNP). When the catalyst to be selected converts the substrate to product, the product retains the “tag” and is then captured in the droplet by the product-specific antibody. In this way the genetic element only becomes associated with the “tag” when it encodes or produces an enzyme capable of converting substrate to product When all reactions are stopped and the droplets are combined, the genetic elements encoding active enzymes can be enriched using an antibody or other molecule which binds, or reacts specifically with the “tag”. Although both substrates and product have the molecular tag, only the genetic elements encoding active gene product will co-purify.

The terms “isolating”, “sorting”, “enriching” and “selecting”, as well as variations thereof, are used herein. Isolation, according to the present invention, refers to the process of separating an entity from a heterogeneous population, for example a mixture, such that it is free of at least one substance with which it was associated before the isolation process. In a preferred embodiment, isolation refers to separation of a sub-population of w/o/w droplets from a population of these droplets, by utilizing at least one sorting cycle which involves FACS techniques. In as far as this relates to isolation of the desired entities, the terms “isolating” and “enriching” are equivalent. Preferably, the isolated sub-population is a pure and essentially homogeneous entity. Sorting of an entity refers to the process of preferentially isolating desired entities over undesired entities. In as far as this relates to isolation of the desired entities, the terms “isolating” and “sorting” are equivalent. The method of the present invention permits the sorting of desired genetic elements from pools (libraries or repertoires) of genetic elements which contain the desired genetic element. Selecting is used to refer to the process (including the sorting process) of isolating an entity according to a particular property thereof.

In a highly preferred application, the method of the present invention is useful for sorting libraries of genetic elements. The invention accordingly provides a method according to preceding aspects of the invention, wherein the genetic elements are isolated from a library of genetic elements encoding a repertoire of gene products. Herein, the terms “library”, “repertoire” and “pool” are used according to their ordinary signification in the art, such that a library of genetic elements encodes a repertoire of gene products. In general, libraries are constructed from pools of genetic elements and have properties which facilitate sorting.

Initial selection of a genetic element from a genetic element library using the present invention will in most cases require the screening of a large number of variant genetic elements. Libraries of genetic elements can be created in a variety of different ways, including the following.

Pools of naturally occurring genetic elements can be cloned from genomic DNA or cDNA (Sambrook et al., 1989); for example, phage antibody libraries, made by PCR amplification repertoires of antibody genes from immunized or non-immunized donors have proved very effective sources of functional antibody fragments (Winter et al., 1994; Hoogenboom, 1997). Libraries of genes can also be made by encoding all (see for example Smith, 1985; Parmley and Smith, 1988) or part of genes (see for example Lowman et al., 1991) or pools of genes (see for example Nissim et al., 1994) by a randomized or doped synthetic oligonucleotide. Libraries can also be made by introducing mutations into a genetic element or pool of genetic elements ‘randomly’ by a variety of techniques in vivo, including; using ‘mutator strains’, of bacteria such as E. coli mutD5 (Liao et al., 1986; Yamagishi et al., 1990; Low et al., 1996); using the antibody hypermutation system of B-lymphocytes (Yelamos et al., 1995). Random mutations can also be introduced both in vivo and in vitro by chemical mutagens, and ionizing or UV irradiation (see Friedberg et al., 1995), or incorporation of mutagenic base analogues (Freese, 1959; Zaccolo et al., 1996). ‘Random’ mutations can also be introduced into genes in vitro during polymerization for example by using error-prone polymerases (Leung et al., 1989).

Further diversification can be introduced by using homologous recombination either in vivo (see Kowalczykowski et al., 1994 or in vitro (Stemmer, 1994a; Stemmer, 1994b)).

According to a further aspect of the present invention, therefore, there is provided a method of in vitro evolution comprising the steps of:
(a) selecting one or more genetic elements from a genetic element library according to the present invention;
(b) mutating the selected genetic element(s) in order to generate a further library of genetic elements encoding a repertoire to gene products; and
(c) iteratively repeating steps (a) and (b) in order to obtain a gene product with enhanced activity.

Mutations may be introduced into the genetic elements(s) as set forth above.

The genetic elements according to the invention advantageously encode enzymes, preferably of pharmacological or industrial interest, activators or inhibitors, especially of biological systems, such as cellular signal transduction mechanisms, antibodies and fragments thereof, other binding agents suitable for diagnostic and therapeutic applications. In a preferred aspect, therefore, the invention permits the identification and isolation of clinically or industrially useful products. In a preferred aspect of the invention, there is provided a product when isolated by the method of the invention.

The selection of suitable encapsulation conditions is desirable. Depending on the complexity and size of the library/to be screened, it may be beneficial to set up the encapsulation procedure such that one or less than one genetic element is encapsulated per droplet. This will provide the greatest power of resolution. Where the library is larger and/or more complex, however, this may be impracticable; it may be preferable to encapsulate several genetic elements together and rely on repeated application of the method of the invention to achieve sorting of the desired activity. A combination of encapsulation procedures may be used to obtain the desired enrichment.

Theoretical studies indicate that the larger the number of genetic element variants created the more likely it is that a molecule will be created with the properties desired (see Perelson and Oster, 1979 for a description of how this applies to repertoires of antibodies). Recently it has also been confirmed practically that larger phage-antibody repertoires do indeed give rise to more antibodies with better binding affinities than smaller repertoires (Griffiths et al., 1994). To ensure that rare variants are generated and thus are capable of being selected, a large library size is desirable. Thus, the use of optimally small droplets is beneficial.

The largest repertoire created to date using methods that require an in vivo step (phage-display and LacI systems) has been a 1.6·10¹¹ clone phage-peptide library which required the fermentation of 15 liters of bacteria (Fisch et al., 1996). SELEX experiments are often carried out on very large numbers of variants (up to 10¹⁵). Using the present invention, at a preferred droplet diameter of 2.6 μm, a repertoire size of at least 10¹⁰ can be selected using 1 ml aqueous phase in a 20 ml emulsion. In addition to the genetic elements described above, the droplets according to the invention will comprise further components required for the sorting process to take place. Other components of the system will for example comprise those necessary for transcription and/or translation of the genetic element. These are selected for the requirements of a specific system from the following; a suitable buffer, an in vitro transcription/replication system and/or an in vitro translation system containing all the necessary ingredients, enzymes and cofactors, RNA polymerase, nucleotides, nucleic acids (natural or synthetic), transfer RNAs, ribosomes and amino acids, and the substrates of the reaction of interest in order to allow selection of the modified gene product.

A suitable buffer will be one in which all of the desired components of the biological system are active and will therefore depend upon the requirements of each specific reaction system. Buffers suitable for biological and/or chemical reactions are known in the art and recipes provided in various laboratory texts, such as Sambrook et al., 1989.

The in vitro translation system will usually comprise a cell extract, typically from bacteria (Zubay, 1973; Zubay, 1980; Lesley et al., 1991; Lesley, 1995), rabbit reticulocytes (Pelham and Jackson, 1976), or wheat germ (Anderson et al., 1983). Many suitable systems are commercially available (for example from Promega) including some which will allow coupled transcription/translation (all the bacterial systems and the reticulocyte and wheat germ TNT™ extract systems from Promega). The mixture of amino acids used may include synthetic amino acids if desired, to increase the possible number or variety of proteins produced in the library. This can be accomplished by charging tRNAs with artificial amino acids and using these tRNAs for the in vitro translation of the proteins to be selected (Ellman et al., 1991; Benner, 1994; Mendel et al., 1995).

After each round of selection the enrichment of the pool of genetic elements for those encoding the molecules of interest can be assayed by non-compartmentalized in vitro transcription/replication or coupled transcription-translation reactions. The selected pool is cloned into a suitable plasmid vector and RNA or recombinant protein is produced from the individual clones for further purification and assay.

The invention moreover relates to a method for producing a gene product, once a genetic element encoding the gene product has been sorted by the method of the invention. Clearly, the genetic element itself may be directly expressed by conventional means to produce the gene product. However, alternative techniques may be employed, as will be apparent to those skilled in the art. For example, the genetic information incorporated in the gene product may be incorporated into a suitable expression vector, and expressed therefrom.

The invention also describes the use of conventional screening techniques to identify compounds which are capable of interacting with the gene products identified by the first aspect of the invention. In preferred embodiments, gene product encoding nucleic acid is incorporated into a vector, and introduced into suitable host cells to produce transformed cell lines that express the gene product The resulting cell lines can then be produced for reproducible qualitative and/or quantitative analysis of the effect(s) of potential drugs affecting gene product function. Thus gene product expressing cells may be employed for the identification of compounds, particularly small molecular weight compounds, which modulate the function of gene product. Thus host cells expressing gene product are useful for drug screening and it is a further object of the present invention to provide a method for identifying compounds which modulate the activity of the gene product, said method comprising exposing cells containing heterologous DNA encoding gene product, wherein said cells produce functional gene product, to at least one compound or mixture of compounds or signal whose ability to modulate the activity of said gene product is sought to be determined, and thereafter monitoring said cells for changes caused by said modulation. Such an assay enables the identification of modulators, such as agonists, antagonists and allosteric modulators, of the gene product. As used herein, a compound or signal that modulates the activity of gene product refers to a compound that alters the activity of gene product in such a way that the activity of gene product is different in the presence of the compound or signal (as compared to the absence of said compound or signal).

Cell-based screening assays can be designed by constructing cell lines in which the expression of a reporter protein, i.e. an easily assayable protein, such as β-galactosidase, chloramphenicol acetyltransferase (CAT) or luciferase, is dependent on gene product. Such an assay enables the detection of compounds that directly modulate gene product function, such as compounds that antagonize gene product, or compounds that inhibit or potentiate other cellular functions required for the activity of gene product.

The present invention also provides a method to exogenously affect gene product dependent processes occurring in cells. Recombinant gene product producing host cells, e.g. mammalian cells, can be contacted with a test compound, and the modulating effect(s) thereof can then be evaluated by comparing the gene product-mediated response in the presence and absence of test compound, or relating the gene product-mediated response of test cells, or control cells (i.e., cells that do not express gene product), to the presence of the compound.

In a further aspect, the invention relates to a method for optimizing a production process which involves at least one step which is facilitated by a polypeptide. For example, the step may be a catalytic step, which is facilitated by an enzyme. Thus, the invention provides a method for preparing a compound or compounds comprising the steps of:
(a) providing a synthesis protocol wherein at least one step is facilitated by a polypeptide;
(b) preparing genetic elements encoding variants of the polypeptide which facilitates this step;
(c) compartmentalizing the genetic elements into droplets according to the present invention;
(d) expressing the genetic elements to produce their respective gene products within the droplets;
(e) sorting the genetic elements which produce polypeptide gene product(s) having the desired activity; and
(f) preparing the compound or compounds using the polypeptide gene product identified in (e) to facilitate the relevant step of the synthesis.

By means of the invention, enzymes involved in the preparation of a compound may be optimized by selection for optimal activity. The procedure involves the preparation of variants of the polypeptide to be screened, which equate to a library of polypeptides as refereed to herein. The variants may be prepared in the same manner as the libraries discussed elsewhere herein.

The methods of the invention can be configured to select for RNA, DNA or protein gene product molecules with catalytic, regulatory or binding activity.

(A) Affinity Selection

In the case of selection for a gene product with affinity for a specific ligand, the genetic element may be linked to the gene product in the droplet via the ligand. Only gene products with affinity for the ligand will therefore bind to the genetic element itself and therefore only genetic elements that produce active product will be retained in the selection step. In this embodiment, the genetic element will thus comprise a nucleic acid encoding the gene product linked to a ligand for the gene product.

In this embodiment, all the gene products to be selected contain a putative binding domain, which is to be selected for, and a common feature i.e. a tag. The genetic element in each droplet is physically linked to the ligand. If the gene product produced from the genetic element has affinity for the ligand, it will bind to it and become physically linked to the same genetic element that encoded it, resulting in the genetic element being ‘tagged’. At the end of the reaction, all of the droplets are combined, and all genetic elements and gene products pooled together in one environment. Genetic elements encoding gene products exhibiting the desired binding can be selected by affinity purification using a molecule that specifically binds to, or reacts specifically with, the “tag”.

In an alternative embodiment, genetic elements may be sorted on the basis that the gene product, which binds to the ligand, merely hides the ligand from, for example, further binding partners. In this eventuality, the genetic element, rather than being retained during an affinity purification step, may be selectively eluted whilst other genetic elements are bound.

In an alternative embodiment, the invention provides a method according to the second aspect of the invention, wherein in step (b) the gene products bind to genetic elements encoding them. The gene products together with the attached genetic elements are then sorted as a result of binding of a ligand to gene products having the desired activity. For example, all gene products can contain an invariant region which binds covalently or non-covalently to the genetic element, and a second region which is diversified so as to generate the desired binding activity.

Sorting by affinity is dependent on the presence of two members of a binding pair in-such conditions that binding may occur. Any binding pair may be used for this purpose. As used herein, the term binding pair refers to any pair of molecules capable of binding to one another. Examples of binding pairs that may be used in the present invention include an antigen and an antibody or fragment thereof capable of binding the antigen, the biotin-avidin/streptavidin pair (Savage et al., 1994), a calcium-dependent binding polypeptide and ligand thereof (e.g. calmodulin and a calmodulin-binding peptide; Stofko et al., 1992; Montigiani et al., 1996), pairs of polypeptides which assemble to form a leucine zipper (Tripet et al., 1996), histidines (typically hexahistidine peptides) and chelated Cu²⁺, Zn²⁺ and Ni²⁺, (e.g. Ni-NTA; Hochuli et al., 1987), RNA-binding and DNA-binding proteins (Klug, 1995) including those containing zinc-finger motifs (Klug and Schwabe, 1995) and DNA methyltransferases (Anderson, 1993), and their nucleic acid binding sites.

(B) Catalysis

When selection is for catalysis, the genetic element in each droplet may comprise the substrate of the reaction. If the genetic element encodes a gene product capable of acting as a catalyst, the gene product will catalyze the conversion of the substrate into the product. Therefore, at the end of the reaction the genetic element is physically linked to the product of the catalyzed reaction. When the droplets are combined and the reactants pooled, genetic elements encoding catalytic molecules can be enriched by selecting for any property specific to the product.

For example, enrichment can be by affinity purification using a molecule (e.g. an antibody) that binds specifically to the product Equally, the gene product may have the effect of modifying a nucleic acid component of the genetic element, for example by methylation (or demethylation) or mutation of the nucleic acid, rendering it resistant to or susceptible to attack by nucleases, such as restriction endonucleases.

Alternatively, selection may be performed indirectly by coupling a first reaction to subsequent reactions that takes place in the same droplet. There are two general ways in which this may be performed. First, the product of the first reaction could be reacted with, or bound by, a molecule which does not react with the substrate of the first reaction. A second, coupled reaction will only proceed in the presence of the product of the first reaction. An active genetic element can then be purified by selection for the properties of the product of the second reaction.

Alternatively, the product of the reaction being selected may be the substrate or cofactor for a second enzyme-catalyzed reaction. The enzyme to catalyze the second reaction can either be translated in situ in the droplets or incorporated in the reaction system prior to microencapsulation. Only when the first reaction proceeds will the coupled enzyme generate a selectable product.

This concept of coupling can be elaborated to incorporate multiple enzymes, each using as a substrate the product of the previous reaction. This allows for selection of enzymes that will not react with an immobilized substrate. It can also be designed to give increased sensitivity by signal amplification if a product of one reaction is a catalyst or a cofactor for a second reaction or series of reactions leading to a selectable product (for example, see Johannsson and Bates, 1988; Johannsson, 1991). Furthermore an enzyme cascade system can be based on the production of an activator for an enzyme or the destruction of an enzyme inhibitor (see Mize et al., 1989). Coupling also has the advantage that a common selection system can be used for a whole group of enzymes which generate the same product and allows for the selection of complicated chemical transformations that cannot be performed in a single step.

Such a method of coupling thus enables the evolution of novel “metabolic pathways” in vitro in a stepwise fashion, selecting and improving first one step and then the next. The selection strategy is based on the final product of the pathway, so that all earlier steps can be evolved independently or sequentially without setting up a new selection system for each step of the reaction.

Expressed in an alternative manner, there is provided a method of isolating one or more genetic elements encoding a gene product having a desired catalytic activity, comprising the steps of:
(1) expressing genetic elements to give their respective gene products;
(2) allowing the gene products to catalyze conversion of a substrate to a product, which may or may not be directly selectable, in accordance with the desired activity;
(3) optionally coupling the first reaction to one or more subsequent reactions, each reaction being modulated by the product of the previous reactions, and leading to the creation of a final, selectable product;
(4) linking the selectable product of catalysis to the genetic elements by either:
   a. coupling a substrate to the genetic elements in such a way that the product remains associated with the genetic elements, or
   b. reacting or binding the selectable product to the genetic elements by way of a suitable molecular “tag” attached to the substrate which remains on the product, or
   c. coupling the selectable product (but not the substrate) to the genetic elements by means of a product-specific reaction or interaction with the product; and
(5) selecting the product of catalysis, together with the genetic element to which it is bound, either by means of a specific reaction or interaction with the product, or by affinity purification using a suitable molecular “tag” attached to the product of catalysis, wherein steps (1) to (4) each genetic element and respective gene product is contained within a droplet.
   (C) Regulation

A similar system can be used to select for regulatory properties of enzymes.

In the case of selection for a regulator molecule which acts as an activator or inhibitor of a biochemical process, the components of the biochemical process can either be translated in situ in each droplet or can be incorporated in the reaction system prior to microencapsulation. If the genetic element being selected is to encode an activator, selection can be performed for the product of the regulated reaction, as described above in connection with catalysis. If an inhibitor is desired, selection can be for a chemical property specific to the substrate of the regulated reaction.

There is therefore provided a method of sorting one or more genetic elements coding for a gene product exhibiting a desired regulatory activity, comprising the steps of:
(1) expressing genetic elements to give their respective gene products;
(2) allowing the gene products to activate or inhibit a biochemical reaction, or sequence of coupled reactions, in accordance with the desired activity, in such a way as to allow the generation or survival of a selectable molecule;
(3) linking the selectable molecule to the genetic elements either by
   a. having the selectable molecule, or the substrate from which it derives, attached to the genetic elements, or
   b. reacting or binding the selectable product to the genetic elements, by way of a suitable molecular “tag” attached to the substrate which remains on the product, or
   c. coupling the product of catalysis (but not the substrate) to the genetic elements, by means of a product-specific reaction or interaction with the product;
(4) selecting the selectable product, together with the genetic element to which it is bound, either by means of a specific reaction or interaction with the selectable product, or by affinity purification using a suitable molecular “tag” attached to the product of catalysis, wherein steps (1) to (4) each genetic element and respective gene product is contained within a droplet.
   (D) Droplet Sorting

The invention provides methods for sorting intact droplets using various sorting techniques. Droplets may be sorted as such when the change induced by the desired gene product either occurs or manifests itself at the surface of the droplet or is detectable from outside the droplet. The change may be caused by the direct action of the gene product, or indirect, in which a series of reactions, one or more of which involve the gene product having the desired activity leads to the change. For example, the droplet may be so configured that the gene product is displayed at its surface and thus accessible to reagents. Where the droplet is a membranous droplet, the gene product may be targeted or may cause the targeting of a molecule to the membrane of the droplet. This can be achieved, for example, by employing a membrane localization sequence, such as those derived from membrane proteins, which will favor the incorporation of a fused or linked molecule into the droplet membrane. Alternatively, where the droplet is formed by phase partitioning such as with primary water-in-oil emulsions or re-emulsified water-in-oil-in-water droplets, a molecule having parts which are more soluble in the extra-capsular phase will arrange themselves such that they are present at the boundary of the droplet.

In a preferred aspect of the invention, droplet sorting is applied to sorting systems, which rely on a change in the optical properties of the droplet, for example absorption or emission characteristics thereof, for example alteration in the optical properties of the droplet resulting from a reaction leading to changes in absorbance, luminescence, phosphorescence or fluorescence associated with the droplet. All such properties are included in the term “optical”. In such a case, droplets can be sorted by luminescence, fluorescence or phosphorescence activated sorting. In a highly preferred embodiment, fluorescence activated sorting is employed to sort droplets in which the production of a gene product having a desired activity is accompanied by the production of a fluorescent molecule in the cell. For example, the gene product itself may be fluorescent, for example a fluorescent protein such as GFP. Alternatively, the gene product may induce or modify the fluorescence of another molecule, such as by binding to it or reacting with it.

When selection is for catalysis, the substrate and product of the catalyzed reaction may have different optical properties. In a preferred embodiment, the substrate this difference in optical properties is a difference in fluorescence. In a highly preferred embodiment the substrate is non-fluorescent and the product is fluorescent at a particular wavelength.

Alternatively, selection may be performed indirectly by coupling a first reaction to subsequent reactions that takes place in the same droplet. The product of the reaction being selected may be the substrate or cofactor for a second enzyme-catalyzed reaction. The enzyme to catalyze the second reaction can either be translated in situ in the droplets or incorporated in the reaction system prior to microencapsulation. Only when the first reaction proceeds will the coupled enzyme generate a selectable product.

This concept of coupling can be elaborated to incorporate multiple enzymes, each using as a substrate the product of the previous reaction. This allows for selection of enzymes that will not react with an immobilized substrate. It can also be designed to give increased sensitivity by signal amplification if a product of one reaction is a catalyst or a cofactor for a second reaction or series of reactions leading to a selectable product (for example, see Johannsson and Bates, 1988; Johannsson, 1991). Furthermore an enzyme cascade system can be based on the production of an activator for an enzyme or the destruction of an enzyme inhibitor (see Mize et al., 1989). Coupling also has the advantage that a common selection system can be used for a whole group of enzymes which generate the same product and allows for the selection of complicated chemical transformations that cannot be performed in a single step.

Such a method of coupling thus enables the evolution of novel “metabolic pathways” in vitro in a stepwise fashion, selecting and improving first one step and then the next. The selection strategy is based on the final product of the pathway, so that all earlier steps can be evolved independently or sequentially without setting up a new selection system for each step of the reaction.

(E) Droplet Identification

Droplets may be identified by virtue of a change induced by the desired gene product which either occurs or manifests itself at the surface of the droplet or is detectable from the outside as described in section iii (Droplet Sorting). This change, when identified, is used to trigger the modification of the gene within the compartment.

In a preferred aspect of the invention, droplet identification relies on a change in the optical properties of the droplet resulting from a reaction leading to luminescence, phosphorescence or fluorescence within the droplet. Modification of the gene within the droplets would be triggered by identification of luminescence, phosphorescence or fluorescence. For example, identification of luminescence, phosphorescence or fluorescence can trigger bombardment of the compartment with photons (or other particles or waves) which leads to modification of the genetic element. A similar procedure has been described previously for the rapid sorting of cells (Keij et al., 1994). Modification of the genetic element may result, for example, from coupling a molecular “tag”, caged by a photolabile protecting group to the genetic elements: bombardment with photons of an appropriate wavelength leads to the removal of the cage. Afterwards, all droplets are combined and the genetic elements pooled together in one environment. Genetic elements encoding gene products exhibiting the desired activity can be selected by affinity purification using a molecule that specifically binds to, or reacts specifically with, the “tag”.

(F) Multi-Step Procedure

It will be also appreciated that according to the present invention, it is not necessary for all the processes of transcription/replication and/or translation, and selection to proceed in one single step, with all reactions taking place in one droplet. The selection procedure may comprise two or more steps. First, transcription/replication and/or translation of each genetic element of a genetic element library may take place in a first droplet. Each gene product is then linked to the genetic element which encoded it (which resides in the same droplet). The droplets are then coalesced, and the genetic elements attached to their respective gene products optionally purified. Alternatively, genetic elements can be attached to their respective gene products using methods which do not rely on encapsulation. For example phage display (Smith, G. P., 1985), polysome display (Mattheakkis et al., 1994), RNA-peptide fusion (Roberts and Szostak, 1997) or lac repressor peptide fusion (Cull, et al., 1992).

In the second step of the procedure, each purified genetic element attached to its gene product is put into a second droplet containing components of the reaction to be selected. This reaction is then initiated. After completion of the reactions, the droplets are again coalesced and the modified genetic elements are selected. In the case of complicated multistep reactions in which many individual components and reaction steps are involved, one or more intervening steps may be performed between the initial step of creation and linking of gene product to genetic element, and the final step of generating the selectable change in the genetic element.

(G) Selection by Activation of Reporter Gene Expression In Situ

The system can be configured such that the desired binding, catalytic or regulatory activity encoded by a genetic element leads, directly or indirectly to the activation of expression of a “reporter gene” that is present in all droplets. Only gene products with the desired activity activate expression of the reporter gene. The activity resulting from reporter gene expression allows the selection of the genetic element (or of the compartment containing it) by any of the methods described herein.

For example, activation of the reporter gene may be the result of a binding activity of the gene product in a manner analogous to the “two hybrid system” (Fields and Song, 1989). Activation might also result from the product of a reaction catalyzed by a desirable gene product. For example, the reaction product could be a transcriptional inducer of the reporter gene. For example, arabinose could be used to induce transcription from the araBAD promoter. The activity of the desirable gene product could also result in the modification of a transcription factor, resulting in expression of the reporter gene. For example, if the desired gene product is a kinase or phosphatase the phosphorylation or dephosphorylation of a transcription factor may lead to activation of reporter gene expression.

(H) Amplification

According to a further aspect of the present invention the method comprises the further step of amplifying the genetic elements. Selective amplification may be used as a means to enrich for genetic elements encoding the desired gene product.

In all the above configurations, genetic material comprised in the genetic elements may be amplified and the process repeated in iterative steps. Amplification may be by the polymerase chain reaction (Saiki et al., 1988) or by using one of a variety of other gene amplification techniques including; Qβ replicase amplification (Cahill, Foster and Mahan, 1991; Chetverin and Spirin, 1995; Katanaev, Kurnasov and Spirin, 1995); the ligase chain reaction (LCR) (Landegren et al., 1988; Barany, 1991); the self-sustained sequence replication system (Fahy, Kwoh and Gingeras, 1991) and strand displacement amplification (Walker et al., 1992).

(I) Compartmentalization

According to a further aspect of the present invention, there is provided a method for compartmentalizing a genetic element and expressing the genetic element to form its gene product within the compartment, comprising the steps of:
(a) forming an aqueous solution comprising the genetic element and the components necessary to express it to form its gene product;
(b) microencapsulating the solution so as to form a discrete primary droplet comprising the genetic element; and
(c) exposing the droplet to conditions suitable for the expression of the genetic element to form its gene product to proceed.

According to a preferred embodiment step (b) further comprises dispersion of the primary droplet within an aqueous phase and obtaining a water-in-oil-in-water droplet. Alternatively, the method further comprises the step of:
(d) re-encapsulating the primary droplet of (c) with a continuous aqueous phase to obtain a water-in-oil-in-water droplet.

Suitable microencapsulation techniques are described in detail in the foregoing general description.

Preferably, a library of genetic elements encoding a repertoire of gene products is encapsulated by the method set forth above, and the genetic elements expressed to produce their respective gene products, in accordance with the invention. In a highly preferred embodiment, microencapsulation is achieved by forming a water-in-oil-in-water emulsion of the aqueous solution comprising the genetic elements.

The invention, accordingly, also provides a droplet obtainable by the method set forth above.

The invention further provides an in vitro system for compartmentalization of single cells and to provide methods for selection and isolation of a desired characteristic of such cell. Specifically, the present invention provides an in vitro system based on emulsified water-in-oil droplets that, optionally, are re-emulsified in a continuous aqueous phase, suitable for flow cytometry and other high throughput screening methods. Each emulsified or internal re-emulsified droplet comprises at least one distinct cell. The cell can be in a reaction system and, optionally, the droplet can include one or more detectable markers.

Since greater than 10¹⁰ droplets of about 2 μm in diameter (or greater than 10⁹ droplets of about 5 μm diameter) can be created in 1 ml of emulsion, a high throughput analysis of millions of individual cells can be performed in parallel. A variety of methods are known by which emulsions with different droplet sizes (1-50 μm diameters) can be made. These methods should enable the compartmentalization of different cell types, from small bacteria cells to large eukaryotic cells. Furthermore, as the cell and the emulsion droplet sizes are in the same order of magnitude, cell lysis within the aqueous droplets does not dramatically change the concentration of the cell components such as mRNA, DNA or protein, thus enabling their detection and analysis.

Single-Cell Compartmentalization in Water in Oil Emulsions

Water-in-oil emulsions can be created using a large variety of water-phase and oil-phase components and surfactants, as well as varying their relative ratios. The exact composition and the method of preparation (e.g. speed of homogenization or mixing) can be altered according to the desired droplet mean size, droplet density, mechanical, thermal, and chemical stability of the emulsion, as well as size and characteristics of the cells to be compartmentalized and the particular analysis to be performed.

Eukaryotic or prokaryotic cells can be isolated and analyzed. Therefore the compositions of the water phase, in which the cells are suspended, and the oil phase will depend largely on the particular cell type. Emulsions can be made that are stable for many hours or days, and at a wide temperature range.

Single-Cell Analyses

(a) Analysis of Enzymatic Activities within Single Cells

Many enzymatic activities can be analyzed within or on the surface of cells, using, for example fluorogenic substrates, either directly, or via coupling to additional reactions that generate fluorescent products. In those cases where the substrate can penetrate through the cell membrane, or of enzymes that are present on the cell's surface, the levels of enzymatic activity can be determined without disruption of the cells.

Compartmentalization would prevent the fluorescent product from diffusing away from the cell that generates it, thus enabling this type of single-cell analysis. For example, single E. coli cells can be compartmentalized in water-in-oil emulsions, and the presence of a given enzymatic activity can be detected within these cells.

(b) Isolation of Cell Contents within the Compartment

Cell lysis within the individual aqueous compartments can ensure that the contents of each cell are not mixed with the contents of other cells. In this manner, the levels of particular mRNA or protein molecules, as well as the sequence of nucleic acid molecules, such as the mRNA or DNA of single cells, can be determined. The method applied for cell lysis within compartments depends on the cells being studied and the subsequent analysis to be performed. A variety of chemical or physical methods of disruption could be applied on the emulsion-compartmentalized cells. Physical methods, such as sonication, can be applied on the intact emulsion. Alternatively, reagents that mediate chemical lysis could be added while maintaining the compartmentalization of cells. This could be achieved by mixing two types of emulsions, a cell-containing emulsion, with an emulsion containing aqueous droplets with the lysis reagents. Alternatively, nanodroplets or swollen micelles could be applied to deliver small, water-soluble lysis reagents into the aqueous droplets of the water-in-oil emulsion (Bernath et al., in press).

For the isolation of the desired cell components, the emulsion droplets may also carry microbeads coated either with oligonucleotides complementary to the nucleic acids one wishes to isolate (i.e., specific complementary sequence, if a particular nucleic acids needs to be isolated, or polyT if all mRNAs are to be isolated), or with antibodies specific against the protein, or proteins, of interest, or a combination of both. The number of cells and beads can be adjusted relative to the number of droplets so that the likelihood of having more than one cell per droplet is very low, and that all compartments, will contain, on average, one bead. In this case, most beads would carry no mRNAs or proteins, but those that do, would indeed represent a single cell.

The lysis reagents or buffers can contain a ‘cocktail’ of various inhibitors of RNases and proteinases to prevent the degradation of the analytes while the cells are broken and their contents processed. At the end of the lysis/capture, the emulsion can be broken and the microbeads isolated and rinsed to remove all cellular components apart from those DNA, RNA, or protein molecules that were specifically captured by the microbeads. Further processing of the microbeads depends on the particular analysis being performed.

The simplest analysis for the mRNA levels bound to the beads can be performed by addition of fluorescent oligonucleotides that are specific for the mRNA of interest. The amount of mRNA bound to the beads will be directly correlated to the level of fluorescence on the beads and can be sorted by FACS. Reverse transcription (RT) of mRNA can also be performed. This step can be performed in emulsion droplets to maintain the linkage between one cell and one microbead. The microbeads can then be isolated, rinsed and a PCR reaction performed in a new emulsion. The latter may use a set of oligonucleotides primers that are specific for the set of mRNAs that is being analyzed, with each oligonucleotide primer containing a different fluorescent probe. The PCR reaction can be preformed under conditions that ensure the linearity of amplification (no limiting number of primers, etc.) so that the relative number of fluorescent probes on the bead reflects the number of each mRNA type attached to it. Beads can be then analyzed by flow cytometry to enable the determination of the levels of mRNAs.

For the detection and quantification of cellular proteins, co-emulsification of cells with microbeads coated with one set of antibodies against these proteins can be performed. Following cell lysis, the target proteins from each individual cell can bind to the microbead. The beads can then be isolated, rinsed to remove all other cellular components, and a second set of antibodies can be added that recognize epitopes of the same targets that are different then those recognized by the first set of antibodies. The bead can then be rinsed and the level of the secondary antibodies determined, either by fluorescent labeling of these antibodies, and by flow cytometric analysis of the beads.

Alternatively, the second set of antibodies can be labeled with a parallel set of enzymes, each of which produces a discrete fluorescent product. The level of each of these products can be determined in emulsion compartments, in the droplets of which the microbeads are compartmentalized, and the fluorescent products are formed and maintained.

(c) Detection of Cell Response to Stimuli

Single-cell compartmentalization can be used also to identify effectors of cellular response within large libraries. The libraries can be of a variety of molecules: synthetic compounds derived from combinatorial chemistry, as well as, DNA, RNA and protein libraries. The exact set up depends on the particular cell types and the stimuli or responses analyzed. The cells and library can be co-compartmentalized so that individual droplets each contain a single member of the library together with one cell. For example, a second emulsion in addition to the cell emulsion can be prepared in which each droplet contains, or most droplets contain, a single gene from a library of genes, and all the components needed for in vitro replication, or transcription, or coupled transcription/translation (Griffiths & Tawfik, 2000).

The second emulsion can be incubated at the required temperature and for the necessary time for the necessary reactions to occur. Subsequently, droplets from the cell-containing and the library-containing emulsions can be merged, and the resultant combined emulsion can be incubated for the library components to exert their activity on the co-compartmentalized cell.

The cell response to this stimulus depends on the particular cell/stimulus pair. For example, a library component can activate a process the end signal of which is the transcription of a reporter gene (e.g. GFP) in the co-compartmentalized cell, and the resultant fluorescent signal can be detected by flow cytometry. The fluorescent droplet carrying the active library components can be sorted by FACS. Following sorting, the gene encoding the library component that evoked the desired cellular response can be recovered by PCR.

Alternatively, the library component can have an effect on cellular metabolism, or status (e.g., induce apoptosis), and the subsequent changes in the cell can be measured with a variety of fluorescent or other optical probes that monitor cell parameters such redox potential, pH, calcium levels. A variety of fluorescent assays are commercially available to assay viability of mammalian, yeast and bacterial cells and to assay for apoptosis.

In addition, the library component can be a synthetic compound derived from a synthetic combinatorial library. In such case, the library component can be recovered together with the compartmentalized cell and subsequently identified.

Single cells can be exposed to a drug of interest and then measured. This can address the problem of heterogeneity within cell populations, which may be a major obstacle in the development of antibiotic and anti cancer drugs. In both cases following treatments, cells that developed resistance to the drug may cause a relapse of inflammation and malignant tumor regrowth. The mechanism by which cells develop the immunity to these drugs and the initial heterogeneity in the target cells can be detected upon exposure of all cells to the same drug. In case of anti cancer drugs the toxicity of the drug can be measured by exposing a cancer and healthy cells in the same droplet to the same drug. Labeling the two cells with different fluorescent markers can enable the testing of drug toxicity on single cell levels under the same conditions.

Moreover, in many cases anti bacterial and anti cancer drugs originate from natural products. These drugs contain a common scaffold that in most cases has no biological activity. However, upon glycosylation of this scaffold by a variety of glycosyltransferases, the “mature” compound is generated with highly efficient anti bacterial and anti cancer activity (Walsh et al., 2003). These sugar moieties are crucial for the biological activity and modification of the compound with different sugars can have a dramatic effect on the activity. The system described above containing the drug scaffold, library of glycosyltransferases, different activated sugars and the target cells either bacterial or cancer cells can be used to generate novel drugs and the novel glycosyltransferases to produce these drugs.

Compartmentalized Single-Cell Sorting

Common to many of the applications described above is the need to sort individual droplets (together with the cells contained within them), by virtue of a specific signal observed within these droplets. Water-in-oil emulsions have a continuous oil phase and therefore are not compatible with standard FACS machines. To overcome this limitation, as discussed above, water-in-oil emulsions can be re-emulsified before the FACS step, by addition of a second aqueous phase containing a hydrophilic surfactant. Prior to sorting, the double emulsions can be diluted in excess of the buffer that forms the outer aqueous phase.

For example, single E. coli cells can be compartmentalized in the aqueous droplets of a water-in-oil emulsion. The primary emulsion can be re-emulsified to give a double w/o/w emulsion that is sorted by FACS. This procedure enables the identification of enzymatic activities within these cells that generate a soluble fluorescent substrate, and the subsequent isolation of cells in which a particular enzyme is expressed, from a large number of cells in which an inactive, or less active, enzyme is expressed. Thus, double emulsions enable the analysis and sorting of cells by virtue of certain enzymatic activities that are present within these cells.

In one embodiment of the invention, single cells can be analyzed for example for enzymatic activity. In another embodiment, the content of each cell can be isolated for further study, for example to determine the level of a compound, such as a particular mRNA or a protein of a single cell, or to determine the sequence of a nucleic acid molecule.

Various aspects and embodiments of the present invention are illustrated in the following examples. It will be appreciated that modification of detail may be made without departing from the scope of the invention.

All documents mentioned in the text are incorporated by reference.

The following examples are to be construed in a non-limitative fashion as they are provided for illustrative purposes.

### EXAMPLES

### Example 1

### Preparation and Sorting of Water in Oil in Water Emulsions by FACS

Preparation of W/O/W Double Emulsions

The primary water phase (80 μl of 4.8% Tween-80 in phosphate buffered saline (PBS; 50 mM sodium phosphate, 100 mM NaCl, pH 7.5)) was added to 0.8 ml of ice-cold oil mix (4.5% Span-80 in light mineral oil). The two phases were homogenized on ice in a 2 ml round-bottom cryotube (Corning) for 5 min at 9500 RPM (using IKA (Germany) T-25 homogenizer) to give the w/o emulsion. To this w/o emulsion, 0.8 ml of the second water phase was added (2% Tween-20 in PBS) and the mixture was homogenized for 2 min at 8000 RPM to give the double w/o/w emulsion.

Sorting of W/O/W Emulsions by FACS

W/o/w emulsions were diluted in excess of PBS and run in a Vantage SE flow cytometer (Becton-Dickinson) using PBS as sheath fluid, at ˜8000 events per second, with 70 μm nozzle, exciting with a 488 nm argon ion laser (coherent Innova 70) and measuring emissions passing a 530±20 nm bandpass filter. Single, un-aggregated droplets were gated using forward and side scatter criteria For analysis of the sorted droplets, several thousands droplets were analyzed in a FACScan cytometer (Becton-Dickinson) using the Becton Dickinson Information Systems CellQuest Pro Software.

Model Enrichment of Genes in W/O/W Emulsions Sorted by FACS

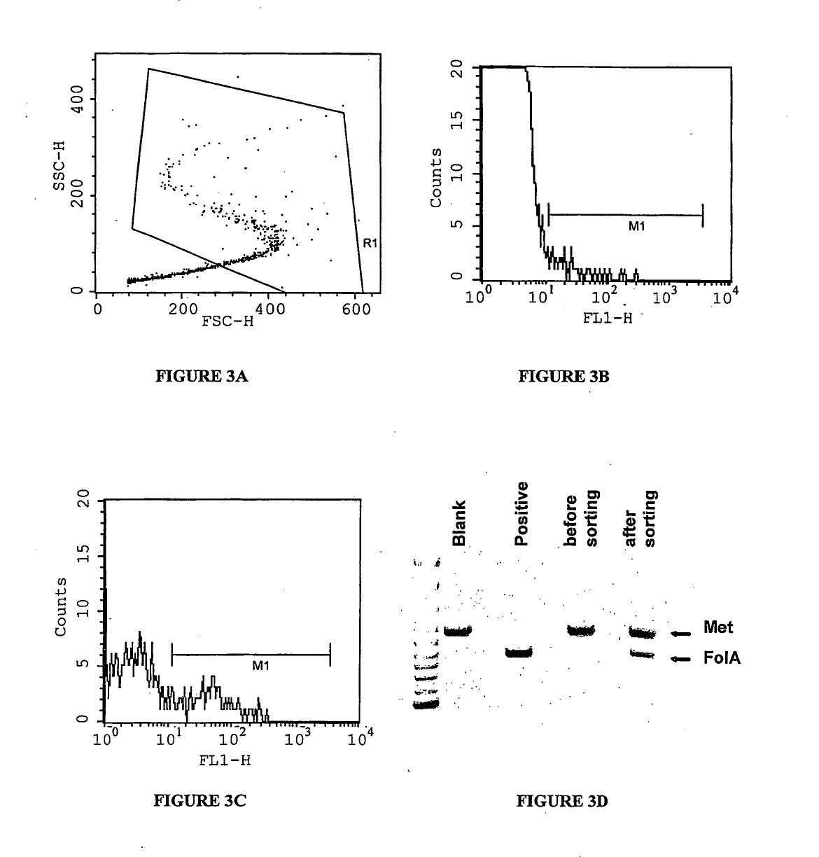

Cloning of the M.HaeIII and FolA genes (encoding, respectively, the DNA-methyltransferase HaeIII, and E. coli dihydrofolate reductase (DHFR)) was described elsewhere [Tawfik and Griffiths, 1998]. These genes were sub-cloned into pIVEX2.2b vector. The M.HaeIII and FolA genes were amplified from their respective pIVEX2.2b vectors using the forward primer LMB2-1-Biotin labeled with biotin at its 5′ end, and the back primer pIVB-1 as described. The ‘positive’ w/o emulsion was prepared with a water phase comprised of 0.3 nM FolA genes in PBS plus FITC-BSA (0.44FITC/BSA mole/mole; at 2 mg/ml concentration). The water phase of the ‘negative’ w/o emulsion contained 0.3 nM of the M.HaeIII gene diluted in 2 mg/ml of BSA in PBS. The positive and negative w/o emulsions were then mixed 1:100 and this mix was converted into a w/o/w emulsion as described above. The w/o/w emulsions were sorted in the Vantage SE and 40,000-80,000 ‘positive’ droplets (using the R1+M1 gate; see FIGS. 2 and 3 for examples) were collected.

PCR Amplifications

The sorted w/o/w emulsion droplets were coalesced by adding an equal volume (˜30 μl) of B&Wx2 buffer (2M NaCl, 10 mM Tris pH7.5, 10 mM EDTA) followed by 100 μl of B&W buffer (1M NaCl, 5 mM Tris pH7.5, 5 mM EDTA). Streptavidin-coated magnetic beads (Dynal M280, 5 μl) were added and incubated for 3 hours at room temperature while sonicating in a bath sonicator (every 30 min for 20 sec each time). The beads were then rinsed 3 times with 200 μl of B&Wx2 and twice with 200 μl of PCR buffer (16 mM (NH₄)₂SO₄, 67 mM Tris-HCl pH 8.8, 0.1% Tween-20). The rinsed beads were resuspended in 10 μl PCR buffer. For the controls, pure (unmixed) ‘positive’ and ‘negative’ w/o/w emulsions, and the w/o/w emulsions prepared from the 1:100 mix (before sorting), were all diluted 1000-fold to give approximately the same number of droplets as isolated by the sorter. The diluted w/o/w emulsions were coalesced and the genes captured as described above.

PCRs were set up at 50 μl total volume, with PCR buffer supplemented with template DNA, MgCl₂ (1.5 mM), primers (500 μM), dNTPs (200 μM) and polymerase (2U, BioTaq (BioLine)). Bead suspensions (5 μl from each sample) were used as templates for PCR amplifications with primers LMB2-9 (GTAAAACGACGGCCAGT; SEQ ID NO:1) and pIVB10 (TTTTTTGCTGAAAGGAG; SEQ ID NO:2). Reactions were cycled 20 times (95° C., 0.5 min; 60° C., 0.5 min; 72° C., 2 min) with a final step at 68° C. for 7 min. This PCR reaction was diluted 100 times in water, and 1 μl was used for a nested PCR, using primers that anneal to the T7 promoter and the T7 terminator, (5′-TAATACGACTCACTATAGG, (SEQ ID NO:3) 5′-CCCGTTTAGAGGCCCCAAGGGG (SEQ ID NO:4); respectively). The nested reactions were cycled 25 times (95° C., 0.5 min; 60° C., 0.5 min; 72° C., 1.5 min) with a final step at 68° C. for 7 min. The reactions were loaded on a 1.2% TAE agarose gel using ethidium bromide for DNA visualization.

W/O/W Emulsion Droplets can be Sorted by FACS

Passage through sorters involves high pressures and shear forces: a sample sorted by FACS is injected into a direct fluid stream (sheath fluid) at high speed and pressure and then passes through a narrow vibrating nozzle to create a stream of separate droplets. After illumination by a laser beam, a fluorescent droplet is electrically charged and deflected by an electric field to be collected [Ibrahim et al., 2003]. The w/o/w droplets must stay intact during FACS sorting so that their contents (and the enzyme-encoding gene, in particular) remains compartmentalized. Therefore, the preparation and stability of w/o/w emulsion droplets, and their amenability to sorting were examined.

A w/o/w emulsion was prepared from a w/o emulsion containing FITC-BSA as a fluorescent marker, and was then mixed (at 1:5 ratio) with a w/o/w emulsion prepared from a w/o emulsion containing no fluorescent marker. Light microscopy indicated an average of 5 w/o droplets per w/o/w droplet (results not shown). The w/o/w emulsions were sorted by FACS by defining a region of 90% of the population by criteria of shape and size as dictated by the forward and side scattering parameters (R1 gate; FIG. 2A) and a marker for the ‘positive’ peak of fluorescence (M1 gate; FIG. 2B). The sorter was allowed to collect about 100,000 droplets that met the criteria defined by both the R1 and the M1 gates. The droplets isolated by the first sort were analyzed, re-sorted and analyzed again. The results of this experiment are summarized in FIG. 2 and Table 1.

TABLE 1
Sorting of w/o/w emulsion droplets by FACS

| | % Positives | Enrichment^{c} | % Positives | Enrichment^{c} |
|---|---|---|---|---|
| Sample | (for total events)^{b} | (total events) | (R1-gated events)^{b} | (R1-gated events) |
| ‘negative’ | 0.06 | | 0.06 | |
| emulsion^{a} | | | | |
| ‘Positive’ | 24.87 | | 25.31 | |
| emulsion^{a} | | | | |
| Pre-sorted | 3.2 | — | 3.33 | — |
| 1:5 mix | | | | |
| Sorted once | 51.4 | 16 | 51.8 | 15.5 |
| Sorted twice | 79.7 | 24.9 | 80.0 | 24 |

^{a}‘Positive’ w/o/w emulsions originated from w/o emulsions containing a fluorescent marker (FITC-BSA) in the aqueous droplets, and ‘negative’ w/o/w emulsions from a w/o emulsion with no fluorescent marker.
^{b}The statistics ‘for total events’ relate to the overall droplet population with no gating by forward and side-scattering, whilst the statistics ‘for R1-gated events’ are restricted to a sub-population that meets the forward and side-scattering criteria as defined by the R1 gate (FIG. 2A).
^{c}The enrichment (or “fold increase”) is the percentage of ‘positive’ events (events gated through M1; FIG. 2B) after sorting, divided by the percentage ‘positive’ events before sorting.

TABLE 2
Models selections of w/o/w emulsions by FACS

| | % Positives | Enrichment^{b} | % Positives | Enrichment^{b} |
|---|---|---|---|---|
| Sample | (total events)^{a} | (total events) | (R1-gated events)^{a} | (R1-gated events) |
| ‘Negative’ | 0.01 | | 0.01 | |
| ‘Positive’ | 6.97 | | 15.8 | |
| 1:100 mix | 0.21 | | 0.59 | |
| before sorting | | | | |
| 1:100 mix | 7.05 | 33.6 | 22.7 | 38.5 |
| after sorting | | | | |

^{a}The statistics ‘for total events’ relate to the overall droplet population with no gating by forward and side-scattering, whilst the statistics ‘for R1-gated events’ are restricted to a sub-population that meets the forward and side-scattering criteria as defined by the R1 gate (FIG. 3A).
^{b}The enrichment (or “fold increase”) is the percentage of ‘positive’ events after sorting (FIG. 3C; events gated through M1) divided by the percentage ‘positive’ events before sorting (FIG. 3B; events gated through M1).

Prior to sorting, the percentage of positive events in the 1:5 mix was 3.33 (out of the R1-gated events). The first sort resulted in 51.8% of the droplets appearing at the high-fluorescence (‘positive’) gate M1 (a 15.5-fold enrichment). The second round of sorting gave an additional 50% enrichment to a total of 80% positives. These results show that the FACS sorts the correct droplets and can reach a high level of enrichment of w/o/w emulsion droplets containing a fluorescent marker. The droplets remained intact after sorting given that there was no change in forward and side-scatter (the same R1 gate was applied in all sorts and analyses) nor in the fluorescence intensity (FL1-H parameter; FIG. 2B). The droplets were stable during sorting and while stored in the sheath fluid, and could be taken through another round of sorting.

FIG. 2B also demonstrates that the low fluorescence population significantly decreases in the first sort and becomes negligible after the second sort, whereas the mean fluorescence of the ‘positive’ population remains unchanged. This suggests that there is no significant “leakage” of fluorescent marker during and in-between the sorts.

Model Enrichment of Genes in W/O/W Emulsions Sorted by FACS

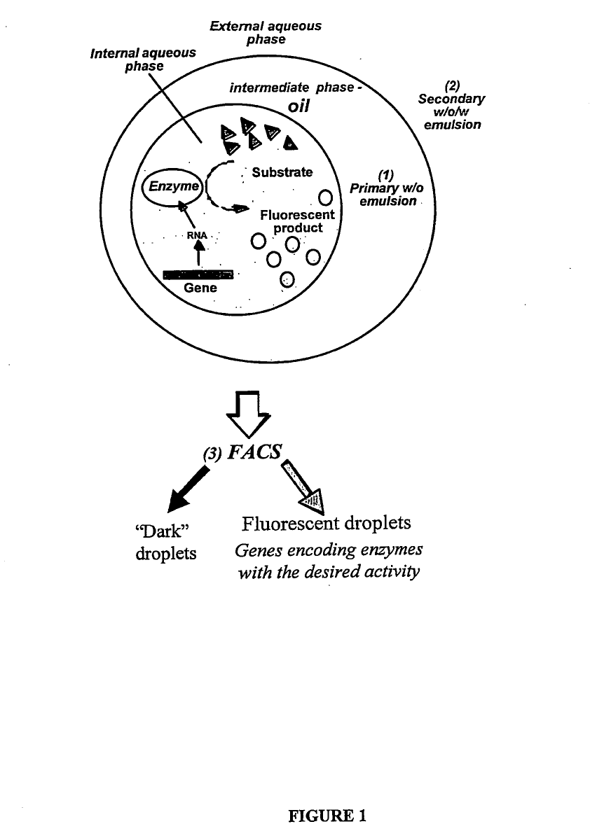

W/o/w emulsions have the potential to be applied for the selection or screening of a particular molecular phenotype as suggested above (FIG. 1). To do so, the content of the droplets containing the ‘positive’ genes that encode active enzyme molecules (and thereby contain the fluorescent product) must not mix with droplets carrying ‘negative’ genes that encode inactive proteins and contain no fluorescent product. Otherwise, the genotype-phenotype linkage that is vital for all evolutionary processes (and for HTS processes related to functional genomics, for example) would be lost.

To demonstrate the capability of this new IVC system to maintain this linkage, a model selection was performed that aims at enriching genes imbedded in aqueous droplets together with a fluorescently-labelled protein (FITC-BSA) from a large excess of other genes imbedded in aqueous droplets with no marker. Enrichment was tested through mixing of two w/o emulsions (each containing a different gene) and re-emulsification to a give a w/o/w emulsion that is amenable to FACS.

Two separate w/o emulsions were prepared: the ‘positive’ emulsion containing FolA genes and FITC-BSA; the ‘negative’ w/o emulsion containing genes of a different length (M.HaeIII genes) and no fluorescent marker. Both genes were amplified from the same cloning vector and were tagged with biotin at their 5′ end. Next, the two w/o emulsions were mixed at a ratio of 1:100 (‘positives’ to ‘negatives’, respectively) and re-emulsified to give a w/o/w emulsion. The w/o/w emulsion was sorted by FACS under forward- and side-scattering parameters that defined a sub-population of 42% of the total events (FIG. 3A; R1 gate).

Sorting the sub-population of medium-size droplets (40-50% of the total population) while avoiding the very large and small droplets yielded the highest enrichment. The very large oil droplets contain a large number of water droplets and therefore compromise the enrichment. The small oil droplets appear to contain no water droplets within them and their sorting seems pointless (see below). Droplets sorted through the M1 high fluorescence gate (FIG. 3B) were collected. These emulsion droplets were then coalesced, and the genes contained within them captured onto streptavidin-coated magnetic beads. The beads were rinsed and the captured genes were amplified by PCR using primers that anneal to the identical sequence regions flanking both the FolA and M.HaeIII genes. The genes isolated from the sorted droplets and amplified by PCR appear at 1:3 FolA:M.HaeIII ratio, indicating an enrichment of ˜30 fold from a starting ratio of 1:100 (FIG. 3D). Analysis of the sorted droplets (prior to breaking) by FACS indicated that the percentage of positives increased by 38.5 fold relative to the pre-sorted w/o/w emulsion (R1-gated events; Table 2). These results indicate that little or no mixing occurs, of either DNA or FITC-BSA, between w/o droplets upon formation and processing of the w/o/w emulsion, and that the genotype-phenotype linkage could be kept in this system.

The observed level of enrichment is consistent with no exchange of genes or fluorescent markers between droplets, as well as with the droplet-size distribution (5 w/o droplets per w/o/w droplet, on average). Thus, if the primary w/o droplets are evenly distributed in the secondary w/o/w emulsion, one should expect that mixing a ‘positive’ and a ‘blank’ w/o emulsion at 1:100 ratio would yield w/o/w droplets containing, on average, one positive aqueous droplet together with 4 blank droplets. Assuming that the ‘positive’ droplets have been enriched by sorting to 100%, we should therefore expect a maximal ratio of 1:4 FolA to M.HaeIII genes namely, a 25 fold enrichment relative to the 1:100 pre-sorted mix. The observed gene enrichment is indeed in the anticipated range (˜30 fold; FIG. 3D) and this enrichment of genes is mirrored in the enrichment for highly-fluorescent droplets (M1-gated w/o/w droplets) observed after sorting by FACS (38.5-fold; Table 2). However, the percentage of highly-fluorescent droplets after sorting is only 22.7 percent (Table 2). And indeed, the histogram shows a clear peak of a non-fluorescent population (FIG. 3C). This non-fluorescent population is assumed to consist mostly of oil droplets with no aqueous droplets within them. This is supported by the fact that the percentage of positives in a w/o/w emulsion prepared from a w/o emulsion containing a fluorescent marker only (FIG. 3C; ‘positive’ emulsion) is not 100% but 15.8%. Thus, a large fraction of the w/o/w droplets are comprised of oil only and exhibit no fluorescence. As these droplets carry no genes, their presence reduces the FACS enrichment, but does not compromise the gene enrichment.

### Example 2

### Enrichment of LacZ Genes from a Pool of Mutant LacZ Genes Based on Beta-Galactosidase Activity Inside the Aqueous Droplets of a Water-In-Oil-In-Water (W/O/W) Emulsion

This example shows how single genes encoding enzymes with a desired activity can be selected from a pool of genes using double emulsion selection.

It is demonstrated that lacZ genes encoding for active beta-galactosidase enzyme can be selected from a pool of mutant lacZ genes by expressing single genes in the aqueous compartments of a water-in-oil emulsion in the presence of the fluorogenic substrate, fluorescein digalactoside (FDG). When the gene present in the aqueous compartment encodes for an active beta-galactosidase enzyme, FDG inside the compartment will be converted into the fluorescent product fluorescein (excitation 488 nm, emission 514 nm). Conversion of the w/o emulsion into a w/o/w emulsion allows sorting of fluorescent droplets using a flow cytometer. After a single round of selection, LacZ genes can be enriched from a mixture of genes by 138 fold.

DNA Preparation

pIVEX2.2EM is a truncated version of pIVEX2.2b Nde (Roche Biochemicals GmbH, Mannheim, Germany) that does not contain the lacZ alpha-peptide coding region and was obtained by cutting pIVEX2.2b Nde with restriction enzymes AatII and SphI. Cut vector was blunted with T4 DNA polymerase (New England Biolabs Inc., Beverly, Mass., USA) and re-circularized with T4 DNA ligase (NEB).

The lacZ gene encoding for beta-galactosidase was amplified from genomic DNA isolated from strain BL21 of Escherichia coil using primers GALBA and GALFO

(SEQ ID NO:5)

(GALBA: 5′CAGACTGCACCATGGCCATGATTACGGATTCACTGGCCGT
CGTTTTAC-3′;

(SEQ ID NO:6))

GALFO: 5′-ACGATGTCAGGATCCTTATTATTTTTGACACCAGACCAAC
TGGTAATGGTA-3′

The PCR product was digested with restriction endonucleases NcoI and BamHI (NEB). Digested DNA was gel purified and ligated into vector pIVEX2.2EM that was digested with the same enzymes. Ligation product was transformed into XL-10 gold cells (Stratagene). Minicultures were grown from 5 single colonies in 3 ml LB medium supplemented with 100 μg/ml ampicillin at 37° C. o/n. From these overnight cultures, plasmid DNA (pDNA) was isolated and sequenced for the presence of the right insert. Linear DNA constructs were generated by PCR using pDNA from a sequenced clone (containing the correct lacZ sequence) as template and primers LMB2-10E (5′-GATGGCGCCCAACAGTCC-3′) (SEQ ID NO:7) and PIVB-4 (5′-TTTGGCCGCCGCCCAGT-3′) (SEQ ID NO:8).

Full-length mutant lacZ (lacZmut), which has an internal frameshift and hence does not encode an active beta-galactosidase, was obtained by cutting pIVEX2.2EM-LacZ with restriction enzyme SacI (NEB). Digested DNA was blunted by incubation for 15 min at 12° C. with T4 DNA polymerase (2 U) and dNTPs (500 μM final concentration). The reaction was quenched by adding EDTA to a final concentration of 10 mM and heating to 75° C. for 20 minutes. Blunted DNA was purified and self-ligated with T4 DNA ligase (1 Weiss unit) in the presence of 5% PEG 4,000 by incubating for 2 hrs at 22° C. pDNA was directly transformed into XL-10 Gold cells. Minicultures were grown from 5 single colonies in 3 ml LB medium supplemented with 100 μg/ml ampicillin at 37° C. o/n and plasmid DNA was isolated. pDNA was digested with SacI and one of the clones lacking the internal SacI site was used to generate linear DNA constructs as described above.

In Vitro Transcription and Translation Inside W/O Emulsions

LacZ and lacZmut linear DNA constructs were mixed at a molar ratio of 1:5, 1:100 and 1:1000, respectively at a total DNA concentration of 1 nM in nuclease-free water.

In vitro translation mixture (EcoProT7, Novagen/EMD Biosciences Ltd, Madison, Wis., USA) was prepared according to the manufacturer's protocol. In short, 35 μl of EcoProT7 extract was mixed with 2 μl of a 5 mM solution of L-methionine in nuclease-free water, 1 μl of 25 mM FDG (Molecular Probes) in DMSO, 3.75 μl of 1 mM 7-hydroxycoumarin-3-carboxylic acid in nuclease-free water (Sigma Aldrich), 3.25 μl of nuclease-free water and 5 μl of the DNA mixes prepared as described above. The in vitro translation mixture was kept on ice at all times to prevent premature initiation of transcription and translation.

A solution of 1% (w/v) span 60 and 1% (w/v) cholesterol in decane (all from Sigma Aldrich) was prepared by dissolving 80 mg of Span 60 and 80 mg of cholesterol into 7.84 ml of decane. The decane was heated to 45° C. to allow complete solubilization of the surfactant and cholesterol. The surfactant/decane solution was divided over batches of 200 μl and placed in a block-heater at 37° C.

A hand-extruding device (Mini extruder, Avanti Polar Lipids Inc, Alabaster, Ala., USA) was assembled according to the manufacturer's instructions (http://www.avantilipids.com/ExtruderAssembly.html). For extrusion, a single 19 mm Track-Etch polycarbonate filter with average pore size of 14 μm (Whatman Nuclepore, Whatman, Maidstone, UK) was fitted inside the mini extruder. Two gas-tight 1 ml Hamilton syringes (Gastight #1001, Hamilton Co, Reno, Nev., USA) were used for extrusion. The extruder was pre-rinsed with 3×1 ml of decane by loading one of the Hamilton syringes with 1 ml of decane, placing the syringe at one end of the mini extruder and extruding it through the filters into the empty Hamilton syringe on the other side of the extruder.

For emulsification of the IVT mix into decane/surfactant solution, 50 μl of the IVT mix was loaded into one of the Hamilton syringes and 200 μl of the pre-heated decane/surfactant mix was loaded into the other Hamilton syringe. The syringes were fitted into the openings on both sides of the filter holder of the extruder. The IVT mix was forced through the filter holder into the alternate syringe containing the decane/surfactant mix and directly forced back into the original syringe to complete one round of extrusion. In total, 7.5 rounds of extrusion were completed. The filled syringe was removed from the extruder and emptied into a 1.7 ml Axygen tube (#MCT-175-C, Axygen Scientific, Inc., Union City, Calif., USA). The formed w-o emulsion was placed at 30° C. for 2 hours to allow for in vitro transcription and translation to complete.

In the meantime, the extruder was disassembled, cleaned extensively with soap and reversed-osmosis water, and re-assembled. For the second emulsification step, a single 19 mm Track-Etch polycarbonate filter with an average pore size of 8 μm was fitted. The extruder was pre-rinsed with 3×1 ml phosphate-buffered salt solution (PBS). 750 μl of PBS containing 0.5% (w/v) Tween 80 (Sigma Aldrich) was loaded into a 1 μml gas-tight Hamilton syringe and fitted into the extruder. 250 μl of the w-o emulsion was loaded into the alternate 1 ml Hamilton syringe and fitted into the extruder. The w-o emulsion was forced through the filter into the alternate syringe containing the PBS/0.5% Tween 80 and immediately forced back into the original syringe to complete one cycle of extrusion. In total, 4.5 cycles of extrusion were performed. The filled syringe was removed from the extruder and emptied into a 1.7 ml Axygen tube. The formed w-o-w double emulsions were placed on ice.

Screening Aid Selection of W/O/W Emulsions by Flow Cytometry

W/o/w emulsions were diluted 25 times in sterile-filtered PBS and run in a MoFlo flow cytometer (Dako-Cytomation) using PBS as sheath fluid. The MoFlo was fitted with a 100 μm nozzle, an argon ion laser emitting at 488 nm and an argon ion laser tuned at 350 nm. Two bandpass filters of 450±30 nm and 530±15 nm were used to detect the 7-hydroxycoumarin-3-carboxylic acid fluorescence and the fluorescein fluorescence, respectively. The machine was triggered on coumarin fluorescence, thereby ignoring all w/o/w emulsions lacking internal water droplets. Sorting gates were placed in such a way that less than 0.05% of the population of droplets from a negative control (IVT mix without DNA) coincides within the sort gates. For each sort, 100,000 events were collected.

DNA Recovery from W/O/W Emulsions

DNA from the sorted w/o/w compartments was precipitated by adding 0.1 volume (relative to the sorted volume) of 3M sodium acetate pH 5.2 and 0.7 volume of isopropanol in the presence of 20 μg glycogen as carrier (Roche Biochemicals GmbH, Mannheim, Germany). DNA was pelleted by centrifugation at 20,000×g for 15 min at 4° C. Precipitated DNA was washed twice with 100 μl 70% ethanol and the DNA pellet was dried using a speedvac (Eppendorf). DNA was resuspended into 10 μl nuclease-free water.

PCR Amplification of Recovered DNA

PCR reactions were set up at 50 μl total volume, using Expand Long Template PCR mix with buffer 1 according to the manufacturer's protocol (Roche). Primers LMB2-11E (5′-GCCCGATCTTCCCCATCGG-3′) (SEQ ID NO:9) and PIVB-8 (5′-CACACCCGTCCTGTGGA-3′) (SEQ ID NO:10) were used at a concentration of 300 μM each. Reactions were incubated for 2 min at 94° C. and subsequently subjected to 10 cycles at 94° C., 15 s; 55° C., 30 s; 68° C., 2 min, another 22 cycles with an increment in elongation time of 10 s/cycle and a final incubation step for 7 min at 68° C. PCR products were purified using a Wizard PCR prep kit from Promega.

SacI Digestion of PCR Products

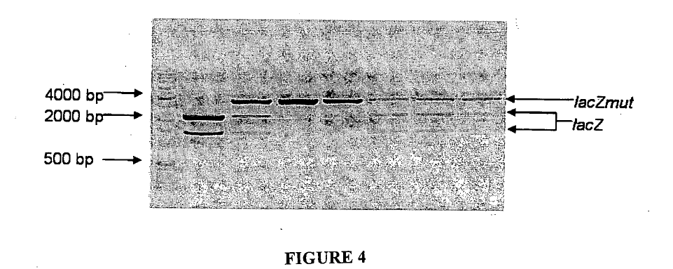

To be able to distinguish between lacZ DNA and lacZmut DNA, purified PCR products were digested with 20 U of SacI enzyme. SacI cuts the lacZ gene but not lacZmut. SacI enzyme was heat-inactivated (15 min at 65° C.) and 5 μl of digested DNA was loaded onto a 1% agarose gel in TAE. DNA was electrophoresed at 5V/cm. DNA was visualized by staining with ethidium bromide (FIG. 4) and quantified using ImageQuant TL gel analysis software (Amersham Biosciences) (Table 3).

TABLE 3
Quantitative analysis of lacZ vs IacZmut DNA from sorted double emulsions

| | Initial molar ratio's of | | | | | | | |
|---|---|---|---|---|---|---|---|---|
| | lacZ:lacZmut | | | | | | | |
| | 1:0 | | 1:5 | | 1:100 | | 1:1000 | |
| | Before | After | Before | After | Before | After | Before | After |
| | sort | sort | sort | sort | sort | sort | sort | sort |
| Relative quantity of | 0.1 | nd | 75.5 | 50.5 | 99.2 | 55.3 | 100 | 86.2 |
| uncut DNA (%) | | | | | | | | |
| Relative quantity of | 99.9 | nd | 24.5 | 49.5 | 0.8 | 44.7 | 0 | 13.8 |
| cut DNA (%) | | | | | | | | |

| | | | | |
|---|---|---|---|---|
| Enrichment factor | — | 2.0 | 55.9 | 138 |

It is demonstrated that genes encoding for an active β-galactosidase can be enriched from a pool of mutant genes encoding an inactive β-galactosidase by using double emulsions selection. With an initial gene concentration of 0.1%, genes encoding β-galactosidase could be enriched 138-fold in a single round of selection. At higher initial gene concentrations, the enrichment factor is lower.

### Example 3

### Mutants with Improved Beta-Galactosidase Activity can be Selected from a Random Mutagenesis Library of Evolved Beta-Galactosidase (Ebg) Using Double Emulsion Selection

Evolved β-galactosidase (Ebg) from Escherichia coli has been used since 1974 as an in vivo model system to dynamically study the evolutionary processes which have led to catalytic efficiency and substrate specificity in enzymes (Hall B. G, Malik H. S. Mol Biol Evol. 15(8):1055-61, 1998; Hall B. G. FEMS Microbiol Lett. 174(1):1-8, 1999; Hall B. G. Genetica. 118(2-3):143-56, 2003).

Wild-type Ebg from E. coli is an α₄β₄ heterooctamer, in which ebgA encodes the beta subunit and ebgC encodes the β subunit Ebg is a virtually inactive β-galactosidase. However, it is known from in vivo studies that in E. coli strains which carry a deletion of the lacZ gene, and which cannot utilize lactose or other β-galactoside sugars as carbon or energy sources because they do not synthesize the LacZ beta-galactosidase, ebgAC has the potential to evolve sufficient activity to replace the lacZ gene for growth on the β-galactoside sugars lactose and lactulose. Each of two specific base mutations at widely separate sites increases Ebg catalytic activity sufficient to permit growth on these substrates, and the combination of the two mutations further increases catalytic effectiveness and expands the substrate range of the enzyme in a non-additive fashion. Experimental studies suggested that these two substitutions are the only mutations capable of increasing activity toward lactose sufficiently to permit growth.

The following shows that similar mutants can be obtained in vitro by creating a random mutagenesis library of the ebg gene and subjecting them to selection on β-galactosidase activity using double emulsion selection.

Errorprone Mutagenesis of Ebg4C Using Base Analogues

A gene segment encoding for the A domain and the C domain of evolved β-galactosidase enzyme was amplified from genomic DNA of E. coli strain BL21 using primers EbgACFw (5′-CAGACTGCACCGCGGGATGAATCGCTGGGAAAACATTCAGC-3′) (SEQ ID NO:11) and EbgACBw (5′-GCGAGGAGCTCTTATTTGTTATGGAAATAACCATCTTCG-3′) (SEQ ID NO:12). The PCR product was cloned into vector pIVEX2.2EM (see example 2) using restriction endonucleases SacII and SacI (NEB). DNA was transfected into XL10-gold cells and single colonies were screened for the presence of the EbgAC gene construct with the right nucleotide sequence. pDNA from a single clone with the right EbgAC gene sequence was used as template to generate a random mutagenesis library using nucleoside analogues essentially as described by Zaccolo et al. (J Mol Biol 255(4): 589-603, 1996). A mixture of the 5′-triphosphates of 6-(2-deoxy-β-D-ribofiranosyl)-3,4-dihydro-8H-pyrimido-[4,5-C][1,2]oxazin-7-one (dPTP) and of 8-oxo-2′-deoxyguanosine (8-oxodG) was prepared in PCR grade water at 2 mM and 10 mM concentrations, respectively. This base analogue mix was diluted 167× and 333× in expand long template PCR buffer 1 (Roche), containing MgCl₂ (2 mM), dNTPs (500 μM), expand long template PCR polymerase enzyme mix (Roche), primer LMB2-9E (5′-GCATTTATCAGGGTTATTGTC-3′ (SEQ ID NO:13); 500 nM) and triple biotinylated primer PIVB-1 (5′-3Bi-GCGTTGATGCAATTTCT-3′ (SEQ ID NO:14); 500 nM) in a total reaction volume of 50 μl. Five nanograms of pIVEX2.2EM-EbgAC DNA was added and samples were subjected to 1 cycle of 2 minutes at 94° C., followed by 3 cycles at 94° C., 1 min; at 50° C., 1 min; at 68° C., 4 min), followed by a final extension of 7 min at 68° C. Ten micrograms of molecular biology-grade glycogen was added to the DNA prior to purification using a Qiaquick PCR purification kit. After purification DNA was recovered in 50 μl PCR-grade water. Ten micrograms of Streptavidin-coated magnetic beads (Dynabeads M-280 streptavidin, Dynal Biotech, Oslo, Norway) were rinsed in 2× binding buffer provided with the beads, resuspended into 50 μl 2× binding buffer and added to the purified DNA. Beads and DNA were incubated for 2.5 hrs at room temperature in a rotating device. Beads were collected with a magnet and rinsed twice with wash buffer that was provided with the beads and twice with PCR-grade water. Finally, beads were resuspended into 25 μl water. 5 μl of bead-bound DNA was used as template in a second PCR reaction (25 cycles of 15 s at 94° C., 30 s at 55° C. and 2 min at 68° C.). PCR product was purified using a Qiaquick PCR purification kit and recovered in 50 μl of PCR-grade water.

Iterative Rounds of In Vitro Selection Using Double Emulsions

The generated random mutagenesis library of ebgAC was subjected to 2 successive rounds of selection. Each selection round consisted of 3 separate steps. (1) the coupled in vitro transcription/translation of single members of the random mutagenesis library inside the segregated water droplets of a w/o emulsion, (2) the conversion of the w/o emulsion into a double w/o/w emulsion and selection of droplets based on the compartmentalized enzyme activity using fluorescence-activated cell sorting and (3) recovery and amplification of genes from the selected double emulsion droplets. The entire procedure is described in detail above (Example 2). Sets of nested primers were used for subsequent selection rounds (Table 4).

TABLE 4

list of primers used to amplify recovered DNA from
successive rounds of selection

| | | |
|---|---|---|
| Selection round | Forward primer | Backward primer |

| | | |
|---|---|---|
| 0 | LMB2-9E | PIVB-1 |
| | 5′-GCATTTATCAGGGTTATTGTC-3′ | 5′-GCGTTGATGCAATTTCT-3′ |
| | (SEQ ID NO:13) | (SEQ ID NO:14) |
| 1 | LMB2-10E | PIVB-4 |
| | 5′-GATGGCGCCCAACAGTCC-3′ | 5′-TTTGGCCGCCGCCCAGT-3′ |
| | (SEQ ID NO:7) | (SEQ ID NO:8) |
| 2 | LMB2-11 | PIVB-11 |
| | 5′-ATGCGTCCGGCGTAGAGG-3′ | 5′-AGCAGCCAACTCAGCTTCC-3′ |
| | (SEQ ID NO:15) | (SEQ ID NO:16) |

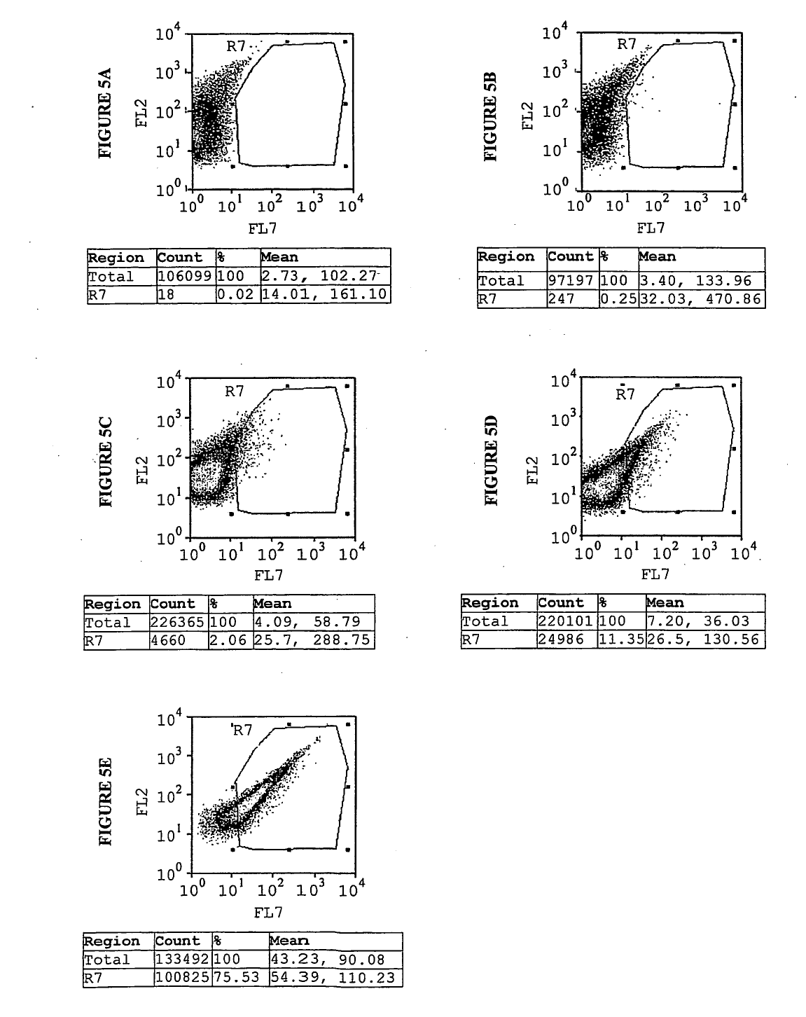

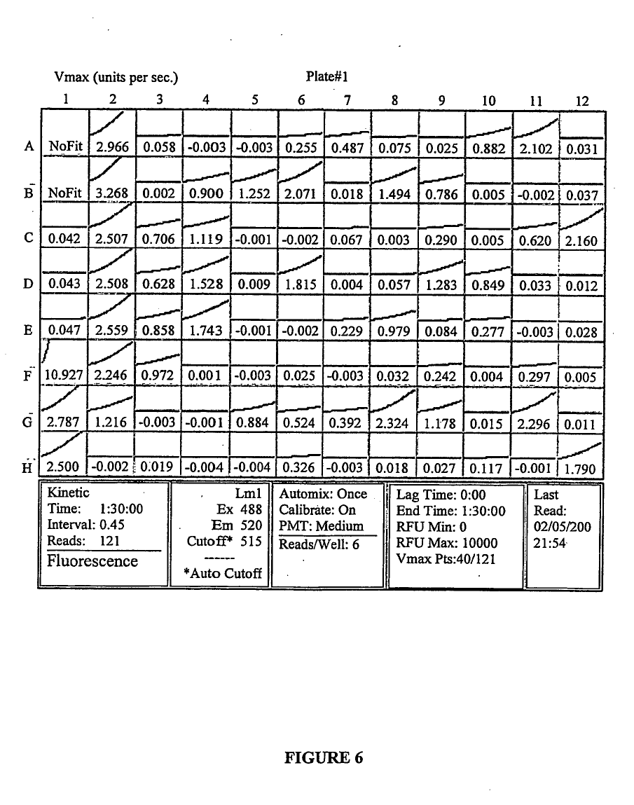

FIG. 5 shows that the number of positive compartments (i.e. compartments that due to β-galactosidase activity show increased fluorescein fluorescence compared to background) within the initial Ebg library is low: only 0.2% of individual compartments of the analyzed population were scored positive (1 in 500). After each selection round, the number of positive compartments within the Ebg library increased 10-fold.
Characterization of the β-Galactosidase Activity of Single Members of the Ebg Library

After the 2^{nd} selection round, DNA was recovered from the double emulsions by standard isopropanol precipitation and PCR amplified using primers LMB2-11 and PIVB-11. Amplified DNA was digested with restriction endonucleases SacI and SacII and cloned into pIVEX2.2EM that was digested with the same enzymes. The ligation product was transformed into ElectroBlue electrocompetent cells (Strategene) by electroporation (at 17 kV/cm, 600Ω, 25 μF) and plated onto LB agar plates with ampicillin. Ebg gene constructs were amplified from single colonies by colony PCR using primers LMB2-10E and PIVB-4. One microliter of PCR product was added to 14 μl of IVT mix (Novagen's EcoProT7 extract, supplemented with 200 μM L-methionine) and incubated for 90 min at 30° C. Forty microliters substrate solution (250 μM FDG, 10 mM MgCl₂, 50 mM NaCl, 1 mM DTT and 100 μg/ml BSA in 10 mM Tris-HCl, pH 7.9) was added and the conversion of FDG into fluorescein was monitored every 45 s for 90 min at 37° C. (FIG. 6).

The screened colonies all have a broad variety of β-galactosidase activity. 39 out of 80 colonies have β-galactosidase activities that are comparable to or lower than wild type Ebg. 10 out of 80 colonies from the Ebg random mutagenesis library show β-galactosidase activity that is comparable to the Class I and Class II mutants described by Hall et al. (FEMS Microbiol Lett 174(1): 1-8, 1999; Genetica 118(2-3): 143-56, 2003). In conclusion, the double emulsion selection system described here can be used for the selection of ebg variants with improved β-galactosidase activity from a large gene library.

### Example 4

### Selection of Thermophilic and Psychrophilic Beta-Galactosidase Coding Genes Based on Beta-Galactosidase Activity Inside the Aqueous Droplets of a Water-In-Oil-In-Water (W/O/W) Emulsion

The microbial world with its huge biodiversity could provide an extraordinary source of new catalysts or ligands which work efficiently in extreme conditions (near boiling temperature, at temperature close to freezing, at high or low pH, etc). Such molecules represent a very interesting reservoir usable for a wide range of applications. This example shows how single genes encoding thermophilic and psychrophilic enzymes with a desired activity can be selected from a pool of genes using double emulsion selection.

It is demonstrated that catalysis can be performed and analyzed within the internal aqueous compartments of water-in-oil emulsions at extreme temperatures. It is also demonstrated that the enzymatic activities can be detected in vitro within the internal aqueous compartments of water-in-oil-in-water double emulsions.

Beta-galactosidase encoding genes of cold-adapted Arthrobacter psychrolactophilus B7 beta-galactosidase (Trimbur et al., Appl. Environ. Microbiol. 60(12), 4544-4552, 1994) and of heat-stable Thermus thermophilus HB27 and Thermus sp T2 beta-galactosidases (Dion et al., Glycoconj. J. 16, 27-37, 1999; Benevides et al., Appl. Environ. Microbiol. 69(4), 1967-1972, 2003) were cloned and expressed in vitro within the internal aqueous compartments of water-in-oil emulsion. Catalysis was performed in this primary emulsion. Conversion of the w/o emulsion into a w/o/w emulsion allows sorting of fluorescent droplets using a fluorescence activated cell sorter (FACS). Such double emulsions formed a reliable high capacity compartmentalization system allowing selection of catalysts efficient at a wide range of temperatures, from at least 4° C. to 99° C.

DNA Preparation

Commercially available lyophilysed cultures of Arthrobacter psychrolactophilus B7 (DSMZ 15612), Thermus thermophilus HB27 (DSMZ 7039) and Thermus sp strain T2 (ATCC 27737) were rehydrated into TY medium (16%·w/v tryptone, 10%·w/v yeast extract, 5%·w/v sodium chloride in distilled water) containing 15% glycerol. Aliquots of the resuspended cultures were incubated 3 minutes in a micro-wave (800 W). The genes encoding for beta-galactosidase (namely bgaA for Thermus sp strain T2, ttβgly for Thermus thermophilus HB27 and LacZ for Arthrobacter psychrolactophilus B7) were amplified directly from these microwaved samples using the Expand Long Template PCR system (Roche) using the manufacturer's recommendations concerning GC-rich templates. The amplifications were performed using a 33-cycle PCR amplification with a common annealing temperature of 55° C. Primers were used at a final concentration of 0.3 μM. Each beta-galactosidase was also fused with a sequence coding for a 6-histidine tag (see Table 5). PCR amplified beta-galactosidase genes were purified using a QIAquick PCR purification kit (QIAGEN) and isopropanol-precipitated. The purified inserts were prepared for cloning by sequential digestion with the suitable restriction enzymes corresponding to the restriction sites supplied by the previous amplification primers (Table 5).

Digested beta-galactosidase genes were then run on a 1% agarose gel (1X TAE) by electrophoresis (130 mV), extracted and purified using a QIAquick gel extraction kit (QIAGEN). The in vitro expression vector pIVEX2.2EM (see Example 2) was digested with the appropriate enzymes, dephosphorylated using high concentration phosphatase (Roche) and purified using a QIAquick PCR purification kit (QIAGEN). 25 fmol of vector and 75 fmol of the previously prepared inserts were used in a ligation reaction with T4 DNA ligase (NEB). The Thermus sp T2 strain required a 2-step cloning with a separated amplification of the N-terminal part (1023 first base-pairs) and the C-terminal part (915 following base-pairs). Ligation products were transformed into XL-10 Ultra-competent gold cells (Stratagene). Plasmid DNA was extracted from some of the resulting clones using a QIAprep Miniprep kit (QIAGEN) after over-night growth of a single resulting colony in 2 ml TY medium containing 1001 g/ml ampicillin at 37° C.

Extracted plasmid DNAs were then analyzed by restriction digestion and checked on a 1% agarose gel (TAE 1X). In addition, the direction of T2 N-terminal insert was checked after digestion by SacII and BamHI. Furthermore, the T2 NcoI internal restriction site was removed by Quickchange II Site Directed Mutagenesis (Stratagene) using specifically designed oligonucleotides remove NcoIfw and remove NcoIbw (see Table 5). Selected clones were finally sequenced (Applied Biosystems 3730 DNA Analyser—MRC geneservice) using the primers T7 forward (5′-TAA TAC GAC TCA CTA TAG GG-3′) (SEQ ID NO:17) and T7 terminator (5′-GCT AGT TAT TGC TCA GCG G-3′) (SEQ ID NO:18), as well as additional internal primers ArtInsFW and ArtInsBW for Arthrobacter psychrolactophilus B7 strain (see Table 5). Sequences were analyzed using MacVector 7.1 (Accelrys) and Sequencher 4.1 (Gene Codes Corporation) software.

TABLE 5

Sequences and description of the primers used to amplify or
sequence beta-galactosidase genes

| | | | |
|---|---|---|---|
| Name | Supplier | Sequence (5′→3′) | Description |

| | | | |
|---|---|---|---|
| NfwA | QIAGEN | TACTATACTCACCTGCACTACATGGC | forward primer for strain A |
| | | ATCTTCCTCCTACATCACCGATCAAGG | beta-galactosidase gene,, |
| | (SEQ ID NO:19) | including AarI restriction site | |
| NfwAhis | QIAGEN | TACTATACTCACCTGCACTACATGGC | forward primer for stain A |
| | | ACATCACCATCACCATCACTCTTCCTC | beta-galactosidase gene with |
| | | CTACATCACCGATCAAGG | N-terminal his-tag,, including |
| | | (SEQ ID NO:20) | AarI restriction site |
| ArthB7bwCt | QIAGEN | ATAGTTTTAGCGGCCGCCTAAGCGGC | backward primer for strain A |
| | | ACGGATGC | beta-galactosidase gene, |
| | | (SEQ ID NO:21) | including NotI restriction site |
| NfwT | QIAGEN | TACTATACTGAAGACATCATGGCAAC | for primer for strain T |
| | | CGAGAACGCCGAAAAATTCCTT | beta-galactosidase gene, |
| | | (SEQ ID NO:22) | including BbvII restriction site |
| NfwThis | QIAGEN | TACTATACTGAAGACATCATGGCACA | forward primer for strain T |
| | | TCACCATCACCATCACACCGAGAACG | beta-galactosidase gene with |
| | | CCGAAAAATTCCTT | N-terminal his-tag, including |
| | | (SEQ ID NO:23) | BbvII restriciton site |
| ThermHB27BW | QIAGEN | ATAGTTTAGCGGCCGCATTCTTATTTA | backward primer for strain T |
| | | GGTCTGGGCCCGCGCGAT | beta-galactosidase gene, |
| | | (SEQ ID NO:24) | including NotI restriction site |
| ThT2fwNterm | QIAGEN | CATGCCATGGCTATGTTGGGCGTTTG | forward primer for the N- |
| | | TTACTACCCGGA | terminal part of strain T2 beta- |
| | | (SEQ ID NO:25) | galactosidase gene, including |
| | | | NcoI restriction site |
| ThT2fwHISNt | QIAGEN | CATGCCATGGCTCATCACCATCACCA | forward primer for the N- |
| | | TCACATGTTGGGCGTTTGTTACTACCC | terminal part of strain T2 beta- |
| | | GGA | galactosidase gene with N- |
| | | (SEQ ID NO:26) | terminal his-tag, including NcoI |
| | | | restriction site |
| ThT2bwNterm | QIAGEN | CATGCCATGGGCTATGGCCTCCCAGT | backward primer for the N- |
| | | CCAA | terminal part of strain T2 beta- |
| | | (SEQ ID NO:27) | galactosidase gene, including |
| | | | NcoI restriction site |
| ThT2fwCter | QIAGEN | CATGCCATGGGGCAGAGGTGGTTTCC | forward primer for the C- |
| | | TACTT | terminal part of strain T2 beta- |
| | | (SEQ ID NO:28) | galactosidase gene, including |
| | | | NcoI restriction site |
| ThT2bwCterm | QIAGEN | CGCGGATCCTCATGTCTCCTCCCACA | backward primer for the C- |
| | | CGGCAAGGT | terminal part of strain T2 beta- |
| | | (SEQ ID NO:29) | galactosidase gene,, including |
| | | | BamHI restriction site |
| RemoveNOCIfw | Sigma | GGAGGCCATAGCCCACGGGGCAGAG | forward primer to remove |
| | | GTGG | internal NcoI restriction site |
| | | (SEQ ID NO:30) | from stain T2 |
| RemoveNCOIbw | Sigma | CCACCTCTGCCCCGTGGGCTATGGCC | backward primer to remove |
| | | TCC | internal NcoI restriction site |
| | | (SEQ ID NO:31) | from strain T2 |
| ArtInsFW | QIAGEN | CTGGGACTTGAGGTTATCTG | forward internal primer for |
| | | (SEQ ID NO:32) | strain A sequencing |
| ArtInsBW | QIAGEN | GCCACTATTGATCCACGGAT | backward internal primer for |
| | | (SEQ ID NO:33) | strain A sequencing |

Linear DNA templates for in vitro transcription were generated from the previous constructs using a 25 cycles PCR amplification with an annealing temperature of 51° C. using primers LMB2-9E (5′-GCATTTATCAGGGTTATTGTC-3′) (SEQ ID NO:13) and PIVB-1 (5′-GCGTTGATGCAATTTCT-3′) (SEQ ID NO:14). The amplifications were performed in a final volume of 50 μl using the Expand Long Template DNA polymerase following the manufacturer's instructions (Roche).

Activity of In Vitro Expressed Beta-Galactosidases in Emulsions at Extreme Temperatures

Fluorescein di-beta-D-galactopyranoside (FDG) was used as a fluorogenic substrate for beta-galactosidase. In vitro expression was as described in example 2 using 0.1 nM PCR-amplified beta-galactosidase genes and 0.5 mM substrate. The procedure for making the w/o emulsion is described in detail above (Example 2). For thermophilic strains Thermus thermophilus HB27 and Thermus sp strain T2, a 30-minute incubation at 30° C. allowed the translation-transcription and was followed by a 1 to 60-minute incubation at higher temperatures from 70° C. to 99° C. For the psychrophilic strain Arthrobacter psychrolactophilus B7, an optional 10- to 30-minute incubation at 30° C. preceded a 4-hour to 2-day incubation at 16° C., 10° C. or 4° C. The conversion of the primary emulsion into a double water-in-oil-in-water emulsion was as follows: after incubation, both the thermophilic and psychrophilic w/o emulsions were put directly on ice for 10 minutes, and mixed gently for 3 minutes at room temperature to be resuspend. The entire first emulsion was then added to 750 μl of PBS (50 mM sodium phosphate pH 7.5, 100 mM NaCl) 0.5% (w/v) Tween 80 (NBS biologicals), vortexed for 5 seconds and emulsified by extruding 7 times through 8 μm filters (25 mm nucleopore Track-Etch membrane, Whatman). Double emulsions were kept on ice and 25 fold diluted in ice-cold PBS prior to FACS sorting. The rest of the procedure is as described in Example 2.

Activity of Extremophilic Beta-Galactosidases in Primary (W/O) Emulsions

Thermophilic Activity

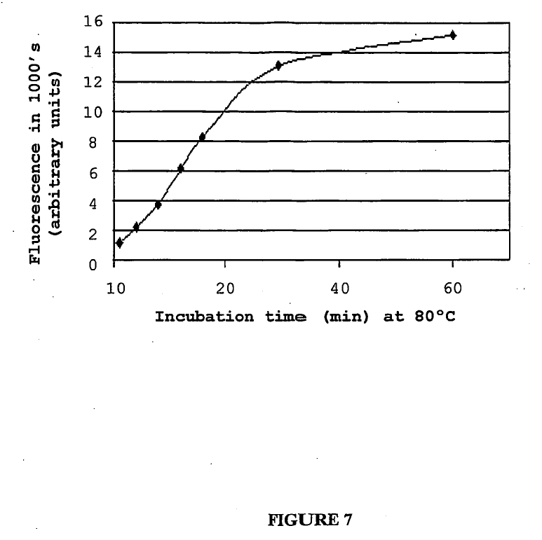

FIG. 7 represents a kinetic analysis of the activity of the thermophilic beta-galactosidase of Thermus thermophilus HB27 in the primary w/o emulsion (emulsion I) at 80° C. (close to the optimal temperature for activity of this thermophilic beta-galactosidase). The w/o emulsion was pre-incubated at 30° C. for 30 min. FDG hydrolysis starts immediately after the start of the 80° C. incubation and quickly reaches a plateau (within 30 minutes). Further tests were performed at various temperatures and showed that activity was detectable in w/o emulsion at temperatures from 70° C. to up to 99° C.

Psychrophilic Activity

After, a pre-incubation at 30° C. for 30 min to allow transcription-translation, the activity of the beta-galactosidase of Arthrobacter psychrolactophilus B7 strain was measured after an incubation of the primary emulsion for 1 to 12 hours at 4° C., 10° C. or 16° C. (Data not shown). Incubation times higher than 12 hours allows a signal to background ratio of more than 4 at all tested temperatures.

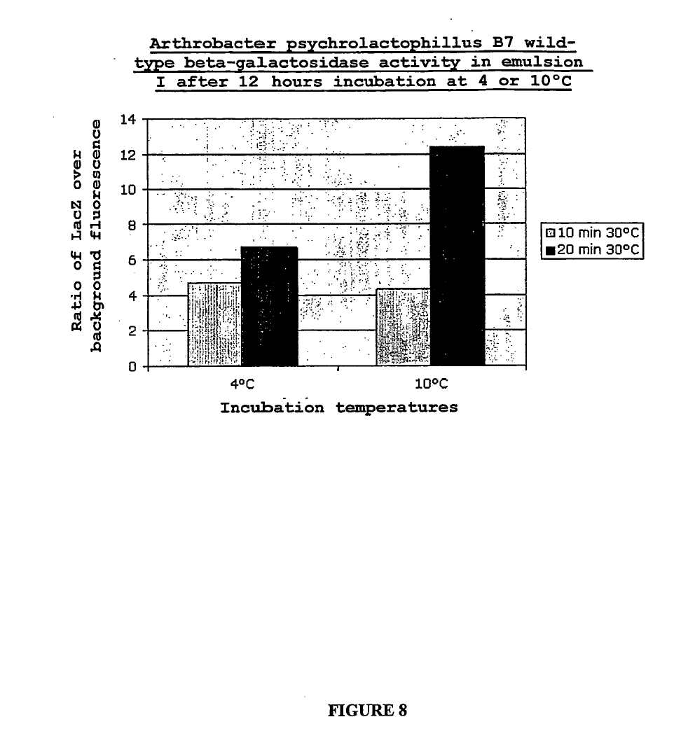

Further tests proved that only a 10-minute preliminary 30° C. incubation (FIG. 8) allowed a sufficient transcription-translation to lead to the same improvements (the pre-incubation is not even necessary for the 16° C. experiment, data not shown) while keeping fluorescence low during the 30° C. incubation (<2.3% higher than the background emission of a negative control): observed fluorescence thus results directly from beta-galactosidase activity at cold temperatures (4° C., 10° C. or 16° C.).

Tests of Exchanges between Droplets in Primary Emulsions

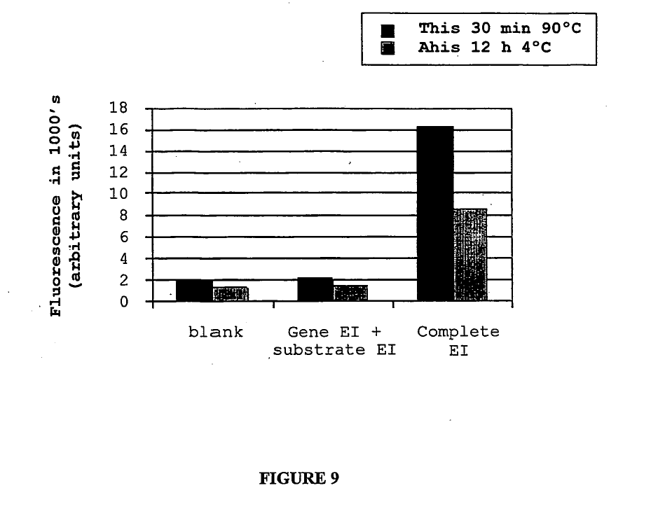

Tests of exchanges between droplets between primary water droplets were carried out by mixing 50 μl of two water-in-oil emulsions from an incomplete IVT mix, the first one containing 0.5 mM FDG but no gene, and the second one containing the IVT mix without FDG. Fluorescence of both complete first emulsion and mix of the two incomplete emulsions were measured in a 96-well plate (Corning) using a spectraMAX GEMINIS fluorimeter (Molecular Devices) with 485 nm excitation and 514 nm detection (corresponding to fluorescein excitation and emission wavelengths respectively). As shown in FIG. 9, this did not lead to any significant beta-galactosidase activity (as compared with the blank sample). This implied the absence of exchange of substrate, gene or enzyme between compartments: primary emulsions remained stable for 30 minutes at 90° C. as well as for 12 hours at 4° C.

Measuring Beta-Galactosidase Activity in W/O/W Double-Emulsions.

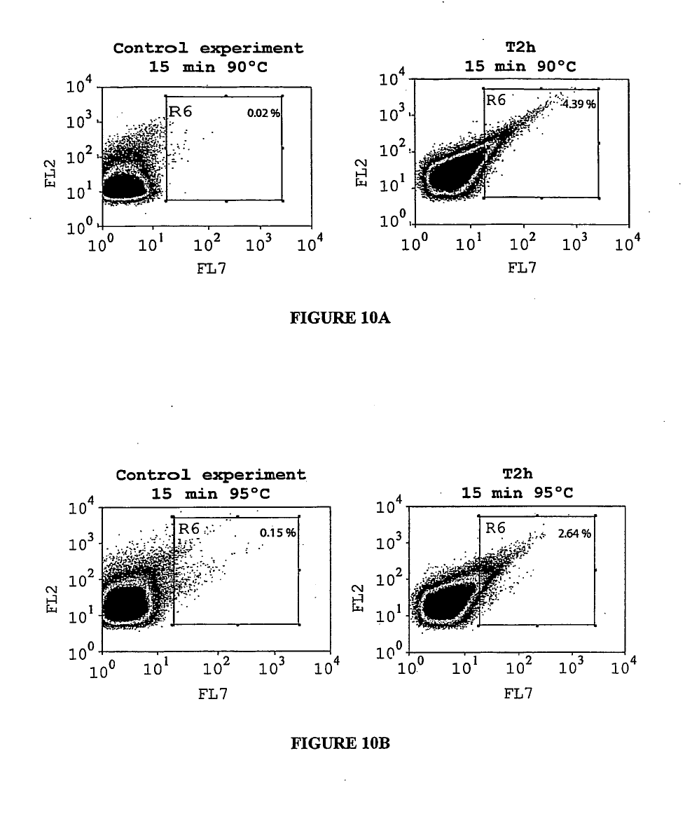

FIG. 10 shows the FACS analysis of double-emulsified samples from Thermus sp strain T2 genes after pre-incubation for 30 min at 30° C. to allow transcription-translation (without starting the conversion of FDG to fluorescein) followed by incubation for 15 min at 90 and 95° C. 7-hydroxycoumarin-3-carboxylic acid was also entrapped within the primary emulsion. Only both 7-hydroxycoumarin-3-carboxylic acid and fluorescein emission define a “positive event”, corresponding to water-in-oil-in-water droplets in which FDG has been hydrolyzed. These results confirm that it is possible to distinguish a positive sample (0.5 nM gene) from negative control (blank without DNA) in presence of 0.5 mM FDG (FIG. 10). FACS analysis of double emulsified samples from Thermus thermophilus HB27 or Thermus sp strain T2 genes at various temperatures ranging from 70° C. to 99° C. also showed clear discrimination between positive samples and background (due to non-enzymatic hydrolysis of FDG).

These results demonstrate that in vitro compartmentalisation and selection of double-emulsion emulsions using a fluorescence activated cell sorter (FACS) can be used to select enzymes efficient at temperature as high as 99° C. and as low as 4° C.

### Example 5

### Mutants with Improved Beta-Galactosidase Activity at Extreme Temperatures can be Selected from a Random Mutagenesis Library Using Double Emulsion Selection

Lactose intolerance, that is the inability to metabolized lactose, affects 70% of the world population. The lactose-intolerant human population is deficient in beta-galactosidase. Symptoms can be overcome by consumption of lactose-free milk and dairy products. Industrial interest in removing lactose from dairy products is moreover reinforced by both higher solubility and higher sweetness of galactose and glucose. Extremophile cold-adapted and heat-stable beta-galactosidases are especially interesting, respectively for the removal of lactose from refrigerated milk during shipping and storage, and for withstanding the high temperatures used during milk processing to prevent microorganism contamination.

Here we show that mutants can be selected in vitro from a random mutagenesis library of genes from thermophilic or psychrophilic organisms by subjecting them to selection for beta-galactosidase activity using double emulsion selection. Random-mutated gene libraries of cold-adapted Arthrobacter psychrolactophilus B7 beta-galactosidase and of heat-stable Thermus thermophilus HB27 and Thermus sp T2 beta-galactosidases were expressed in vitro within the internal aqueous compartments of water-in-oil-in-water double emulsion. It allowed both stable in vitro linkage between genotype and phenotype and direct high throughput sorting using a fluorescence activated cell sorter (FACS). This technology was successfully applied to the selection of active beta-galactosidases at extreme temperatures. For example, as shown below, a substantial population enrichment of more than 10²-fold can be achieved after two selection rounds at 90° C.

Error Prone Mutagenesis of Beta-galactosidases Coding Genes Using Base Analogues

Random mutagenesis was performed by using triphosphate derivatives of nucleoside analogues as described by Zaccolo et al. (J Mol Biol 255(4): 589-603, 1996). The base-analogues mix consists in 1/5 (v/v) of 10 mM DPTP (5′-triphosphates of 6-(2-deoxy-β-D-ribofuranosyl)-3,4-dihydro-8H-pyrimido-[4,5-C][1,2]oxazin-7-one, TriLink BioTech) and 4/5 of 10 mM 8-oxo dGTP (5′-triphosphates of 8-oxo-2′-deoxyguanosine, TriLink BioTech) in PCR-grade water. 135 fmol of genes encoding for the different extremophilic beta-galactosidase enzymes were amplified from the previous described constructs (Example 4) using primer LMB2-9E (5′-GCATTTATCAGGGTTATTGTC-3′; (SEQ ID NO:13) 500 nM) and triple biotinylated primer 3bio-pIVB1 (5′-GCGTTGATGCAATTTCT-3′; (SEQ ID NO:14) 500 nM) in a 50 μl reaction with the Expand Long Template PCR system (Roche), using 3 μl of either 8 times (15 μM dPTP-60 μM 8-oxo dGTP in the PCR mix), 16 times or 22 times diluted base-analogue mix in expand long template PCR buffer 1 (Roche), containing MgCl₂ (2 mM), dNTPs (500 μM), expand long template PCR polymerase enzyme mix (Roche).

Samples were subjected a PCR amplification consisting of 2 minutes at 94° C., followed by 3 cycles of 94° C., 1 min; 50° C., 1 min; 68° C., 4 min followed by a final extension of 7 min at 68° C. Amplified products were purified using a QIAquick PCR purification kit (QIAGEN) in the presence of 0.25 ng/μl yeast RNA (Roche) and captured on M-280 streptavidin beads following the procedure of the Dynabeads kilobaseBINDER kit (Dynal Biotech). 1/5 of each resulting product was amplified in a second PCR reaction (2 min 94° C., followed by 10 cycles of 15 s at 94° C.; 30 s at 55° C.; 2 min at 68° C. and 15 cycles of 15 s at 94° C.; 30 s at 55° C.; 2 min+10 s/cycle at 68° C. with a final elongation step at 68° C. for 7 min) with oligonucleotides LMB2-10E (5′-GATGGCGCCCAACAGTCC-3′) (SEQ ID NO:7) and pIVB4 (5′-TTTGGCCGCCGCCCAGT-3′) (SEQ ID NO:8) and finally purified again using the QIAquick PCR purification kit (QIAGEN) and isopropanol-precipitated.

Iterative Rounds of In Vitro Selection Using Double Emulsions

The random mutagenesis libraries generated were expressed in emulsions and then selected by FACS after conversion to a w/o/w emulsion. The entire procedure is described in detail above (Example 2).

Thermophilic Strains

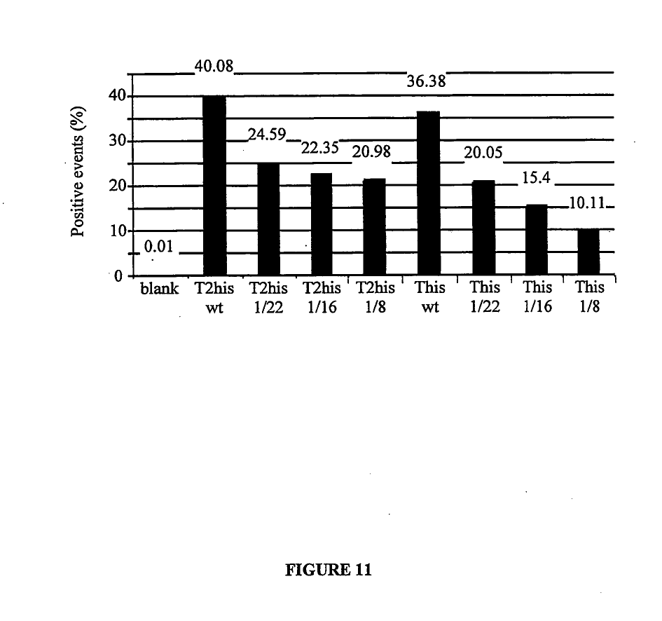

FACS analysis of double emulsified samples from both wild type genes and libraries of heat-stable Thermus thermophilus HB27 and Thermus sp T2 beta-galactosidases, following the protocol described in Example 2, are summarize in FIG. 11. Results confirmed that the higher the mutation rate is, the lower the number of positive events. 7-hydroxycoumarin-3-carboxylic acid was also entrapped within the primary emulsion. Only both 7-hydroxycoumarin-3-carboxylic acid and fluorescein emission define a “positive event”, corresponding to water-in-oil-in-water droplets in which FDG has been hydrolyzed.

The thermophilic strain Thermus sp strain T2 was submitted to a selection process involving 30 min incubation at 30° C. followed by a 20-minute incubation at 90° C. Sorted DNA was successfully recovered from 100,000 purified positive events (see Example 2).

Half of the recovered DNA from the sorted w/o/w compartments was amplified by a 33-cycle long template PCR, following manufacturer's instruction, with the suitable pIVEX2.2dEM oligonucleotides (see Table 6), namely LMB2-11E/PIVB8 after one round of library selection, LMB2-11/PIVB11 after a second round of library selection and the appropriate forward and backward primers, included in the firstly beta-galactosidase amplified genes of each strain, after a third round of selection (see Table 5). Amplified products were purified by QIAquick PCR purification (QIAGEN) and checked by electrophoresis on 1% agarose gel (TAE) before further selection rounds.

TABLE 6

Sequences and description of the primers used to amplify
recovered DNA from successive rounds of selection

| Name | Supplier | Sequence (5′→3′) | Description |
|---|---|---|---|
| LMB2-11E | Sigma | GCCCGATCTTCCCCATCGG | forward primer used after |
| | | (SEQ ID NO:9) | the first selection round of |
| | | | mutagenized libraries |
| LMB2-11 | Sigma | ATGCGTCCGGCGTAGAGG | forward primer used after |
| | | (SEQ ID NO:15) | the second selection |
| | | | round of mutagenized |
| | | | libraries |
| PIVB8 | Sigma | CACACCCGTCCTGTGGA | Backward primer for first |
| | | (SEQ ID NO:10) | selection round of |
| | | | mutagenized libraries |
| PIVB11 | Sigma | AGCAGCCAACTCAGCTTCC | Backward primer for |
| | | (SEQ ID NO:16) | second selection round of |
| | | | mutagenized libraries |

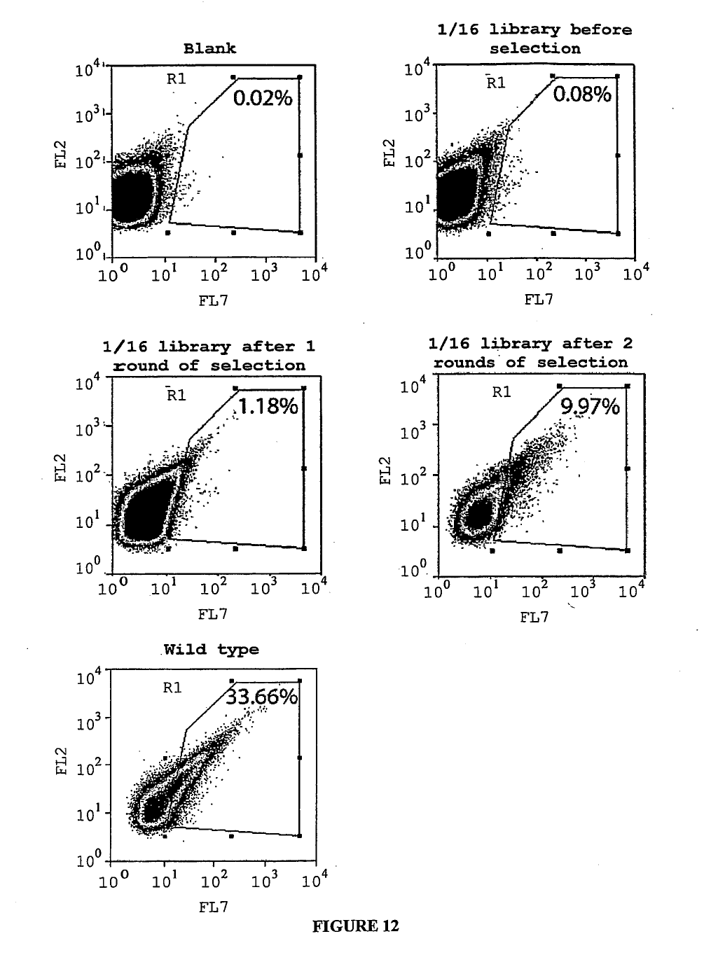

The amplified products were then emulsified again and incubated 30 minutes at 30° C. followed by 20 minutes at 90° C. (conditions identical to the first round procedure). Primary emulsions were then converted into double emulsions. The FIG. 12 illustrates the enrichment of 1/16 library (intermediate mutations rate of 1.25 mutations per 1000 bp) after two successive rounds of FACS selection on double emulsion. FACS analysis showed around 15-times enrichment of 1/16 library population in positive events after one round of selection. A second selection round from 100,000 previous purified positive events led to around 8-fold increase of the ratio of positive events (FIG. 12).

Temperatures were successfully increased up to 99° C. and, despite a significant increase in the non-enzymatic hydrolysis of the substrate, the discrimination between the blank and the libraries was still significant. These results demonstrate how active thermophilic mutants can be enriched from a library of gene.

Psychrophilic Strain

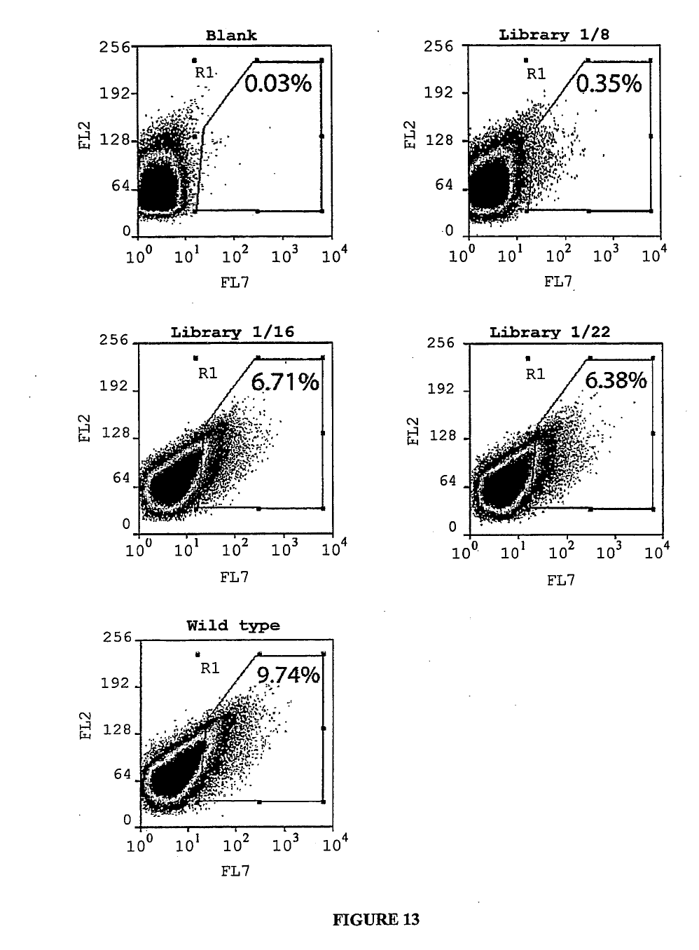

A procedure involving a 10-minute preliminary incubation at 30° C. followed by 12 hours at 4° C. were used for a FACS analysis of double emulsified random-mutagenized libraries from cold-adapted Arthrobacter psychrolactophilus B7 beta-galactosidase. The 1/8 library (high mutation rate) showed around 10 times more positive events than the background observed for negative control (without gene). 1/16 and 1/22 mutated libraries appeared relatively similar, both presenting around 33% less positive events than the wild-type under the same conditions (FIG. 13).

The procedure allowed to clearly discriminate compartments containing active enzymes. Consequently, using the same process as described for thermophilic strains, genes encoding cold-adapted beta-galactosidases can be selected.

### Example 6

### Compartmentalization and Detection of PON1 Variants in Single E. coli Cells

Serum paraoxonase (PON1) is a mammalian enzyme that catalyzes the hydrolysis and inactivation of a broad range of phosphotriesters, esters and lactones. This enzyme, that resides on HDL plasma particles (the “good cholesterol”), has a profound impact on the onset and progression of atherosclerosis. Lusis, A. J. Although PON1's mechanism of action is still under investigation, it was found to hydrolyze homocysteine thiolactone (HcyT) and thereby reduce the levels of this highly toxic compound that comprises a known risk factor for atherosclerosis. Jakubowski. But although PON1 is the primary, or only, plasma enzyme that hydrolyzes HcyT²⁰, HcyT, and other thiobutyrolactones (TBLs), are generally poor substrates of PON1 (k_{cat}/K_{M}≦100 M⁻¹s⁻¹) Directed evolution was therefore applied to increase the TBLase activity of PON1, and thereby provide new potential means of detoxification.

TBLs present a challenge for detection and sorting. Although their hydrolysis can be monitored by chromogenic and fluorogenic thiol-detecting reagents, there exists a high background due to the spontaneous (non-enzymatic) hydrolysis of TBLs, and the presence of other thiols in the media in which the enzyme variants are expressed and screened. In addition, the signal by PON1 is very low due to the poor catalytic efficiency of the wild-type enzyme. There are two ways to overcome a low signal-to-background ratio: Selecting under single-turnover conditions when the substrate and enzyme are tethered (as in ribozyme, or certain phage-display enzyme selections); or, by increasing the enzyme concentration. Griffiths et al. As the former is unlikely to yield efficient enzyme variants, to gain maximal sensitivity, compartmentalizing intact bacterial cells containing 10⁴-10⁵ enzyme molecules per cell was chosen, rather then cell-free translation that has been traditionally used with IVC and yields 10-10² enzyme molecules per droplet. See Griffiths et al. and Tawfik et al. Compartmentalizing single cells resulted in very high enzyme concentrations within the aqueous droplets (1-10 μM) and enabled detection and selection despite the low signal-to-background ratio.

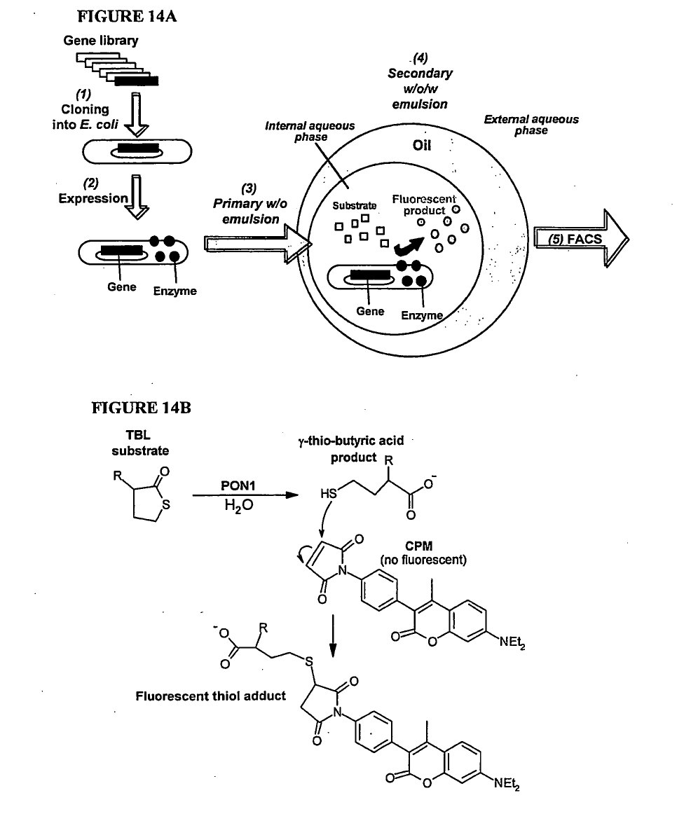

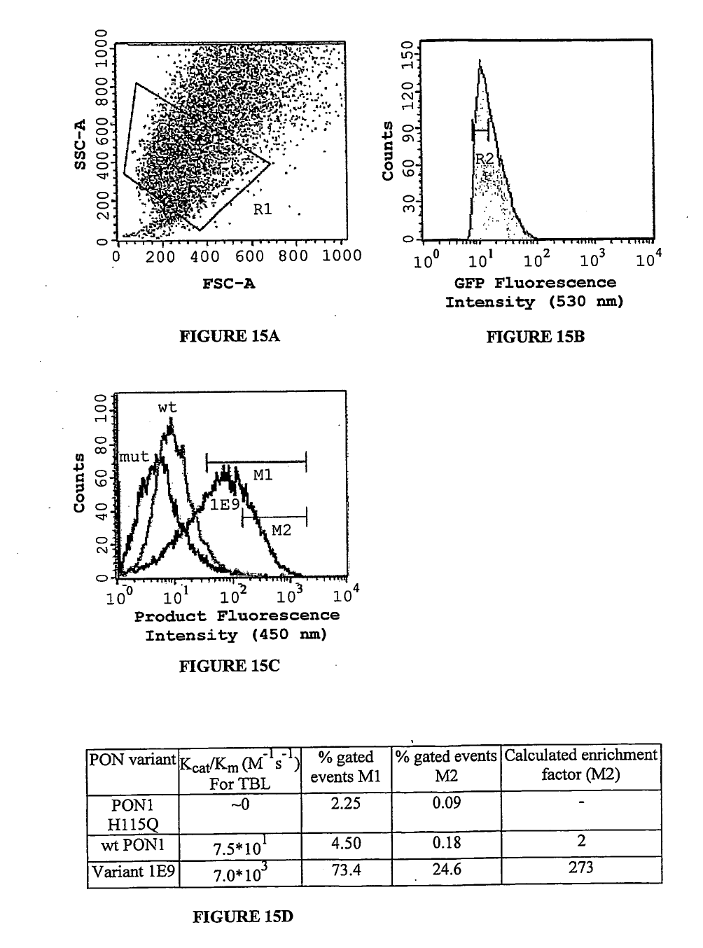

Specifically, E. coli cells expressing the PON1 variants in their cytoplasms were emulsified to generate the primary w/o emulsion. See FIG. 14A. Cell cultures were grown overnight, and ca. ˜5×10⁸ cells were rinsed, resuspended in buffer and emulsified in mineral oil containing the AbilEM90 surfactant. The number of aqueous droplets in this emulsion (>10¹⁰) was in large excess of the number of cells, rendering the vast majority of the droplets empty. In addition, the tendency of the E. coli cells to adhere and form small aggregates resulted in emulsion droplets containing multiple E. coli cells. These aggregates, although small, compromised the selection since negative variants were co-selected with positive ones. Therefore an internal marker to the cells was introduced by expressing green fluorescence protein (GFP) in addition to the selected enzyme. The w/o emulsion was re-emulsified to generate the w/o/w double emulsion in which the TBL substrate, the thiol-detecting dye and individual E. coli cells were co-compartmentalized in the aqueous inner droplets, surrounded by a layer of oil and a second, continuous phase of water that was amenable to FACS sort. The FACS triggering threshold was set on GFP emission (530 nm), and an appropriate gate was chosen corresponding to the level of emission of single cells. See FIG. 15B. In this way, the sort completely ignored droplets with no cells, and avoided the isolation of droplets containing more than one cell. This approach allowed >10 fold higher enrichment factors, and 20 times faster sorting rates, than those obtained by triggering on the standard forward scatter parameter (droplet size). Detection of the TBLase activity of the compartmentalized cells was via the UV fluorescence signal (450 nm) emitted when the CPM dye reacts with the free thiol groups generated by the hydrolysis of γ-TBL to give γ-thiobutyric acid (FIG. 14B). To test the sensitivity and dynamic range of detection, three PON1 variants with different TBLase activity were analyzed (FIG. 15D): a recombinant PON1 variant with wild-type like (wt) activity (k_{cat}/K_{M}=75 s⁻¹ M⁻¹); its H115Q mutant that has no detectable TBLase activity; and variant 1E9, isolated from the library selections described below, and exhibiting ˜100 fold higher TBLase activity than wt. Aharoni et al.; Harel et al.

Cells expressing these PON1 variants were separately emulsified and analyzed by FACS (FIG. 15). Significant differences between the fluorescence intensities of these samples were observed in accordance with the their enzymatic activities (see FIG. 15C). The high amounts of PON1 (assays of the enzymatic activity in lyzed cells indicated ˜10⁵ active PON1 molecules per cell) contained within the small volume of the emulsions droplets, yielded a local concentration of ˜10 μM, which appeared to allow the detection of low enzymatic rates, as wt PON1 activity was separated from the inactive PON1-H115Q mutant. The improved variant 1E9 showed a very clear separation, with the number of ‘positive’ events being 16-136 times higher than wt PON1, and 33-273 times higher than with the H115Q inactive mutant, depending on the stringency of the gate (FIG. 15D). Thus, the sensitivity of detection is high, and its dynamic range spans over at least two orders of magnitude.

### Example 7

### Model Sorts for PON1 Variants

To demonstrate and quantify the enrichment factor, a model selection was performed in which cells expressing the improved TBLase variant 1E9 (the evolution of which is described below), were mixed with cells carrying wt PON1, at ratios of 1:100, and 1:300, respectively. These cell mixtures were emulsified and analyzed by FACS as described above. ‘Positive’ events were sorted according to three different criteria: First, the GFP emission (as in Marker R2, FIG. 15B) was used for triggering the sort and restricting it to droplets containing single cells. Second, droplets were gated by the forward and side scattering parameters to obtain the middle-sized droplets (as in Gate R1, FIG. 15A) and maximal enrichment. Bernath et al. Third, droplets exhibiting high product-dye fluorescence intensity were selected (as in M2, FIG. 15C). The ‘positive’ droplets were collected directly into growth medium, and then plated on agar. Isolated colonies were picked into the individual wells of 96-well plates, grown in liquid media, and the crude cell lysates assayed for TBLase activity. Clones carrying 1E9 were easily distinguished from wt PON1 by virtue of exhibiting ˜100 fold higher TBLase activity, allowing the determination of the ratio of 1E9 to wt PON1 clones in the selected pool. Enrichments of 56-107 fold relative to the pre-sorted pools were observed; these correlated well with the FACS enrichment factors calculated from the number of ‘positive’ events in the 1E9 vs. wt samples as shown in table 7 below:

TABLE 7
Model sorts of PON1 variants.

| | Percentage of | |
|---|---|---|
| | positives | |
| Sample | (M1 gate) | Enrichment |
| wt PON1 | 0.08 | — |
| variant 1E9 | 9.7 | 121^{a} |
| 1:100 (1E9:wt) | 0.11 | 56^{b} |
| mixture | | |
| 1:300 (1E9:wt) | 0.12 | 107^{b} |
| mixture | | |

^{a}Noted is the calculated FACS enrichment factor, i.e., the percentage of events in M1 gate for variant 1E9, divided by, the percentage of events in M1 gate for wt PON1.
^{b}Noted is the actual enrichment observed the after FACS sorts - i.e., the frequency of 1E9 clones after the FACS sort (0.56 (27/48) and 0.35 (17/48), for the 1:100 and 1:300 spikes, respectively) divided by the frequency of the pre-sorted mixture (0.01 or 0.003 for 1:100 and 1:300 spikes, respectively).

### Example 8

### Additional Library Construction and Selection

PON1's crystal structure and the directed evolution of several PON1 variants, each selected for a different activity, have been described in Harel et al. This led to the classification of sixteen residues that are located within, and in the vicinity of PON1's active site, and appear to have led to the divergence of the PON family in nature, and the alteration of its substrate selectivity in directed evolution experiments.

Therefore new libraries were created in which these sixteen residues were randomized. However, a simultaneous diversification of all sixteen positions would result in an impossibly high library size, and an extremely high mutation rate rendering almost all library variants inactive. Therefore a protocol developed for the spiking in of randomizing oligos was applied, so that each library variant carried, on average, 3 mutated residues, and the entire repertoire of 16 residues can be explored in the complete library.

Briefly, the PON1 gene was randomly digested with DNaseI to generate 50-125 base pairs fragments. The fragments were reassembled, as in DNA shuffling in the presence of a mixture of short oligos. Stemmer, W. P. C. Each oligo encoded one randomized codon, and 3′ and 5′ flanking regions matching the wt PON1 gene. The 16 oligos were incorporated into the assembled gene at a frequency determined by the ratio of oligos vs. PON1 gene fragments in the assembly reaction. The assembly reaction that gave an average of 3 mutated positions per gene was ligated into an expression vector and electroporated to competent cells to yield ˜1.3×10⁶ individual transformants.

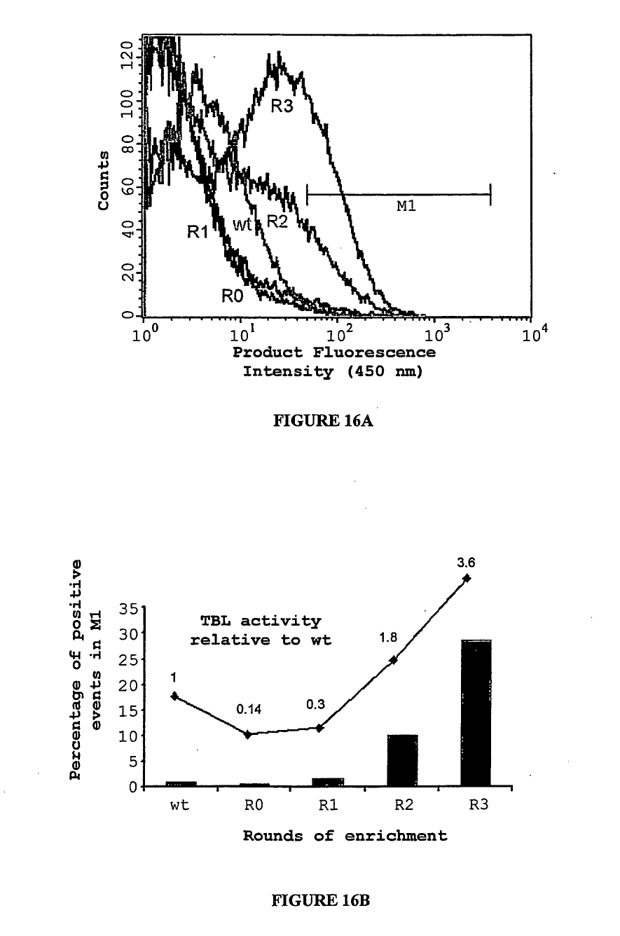

The library plasmid DNA was extracted, and retransformed to BL21 (DE3) cells carrying the GFP expression vector. Approximately 5×10⁸ cells, grown from 5×10⁶ individual transformants, were emulsified, and ˜5×10⁷ individual bacteria were analyzed by FACS. Positive events were sorted using the criteria of size and shape (FIG. 15A), GFP emission (FIG. 15B), and product-dye fluorescence intensity (FIG. 16A; M1 gate), and the isolated bacteria plated on agar. The resulting colonies were pooled, and the plasmid DNA extracted and transformed for a second round of enrichment. Three rounds of sorting were performed, and in each round an increase in the number of positive events and the TBLase activity of the selected pool was observed (FIG. 16B).

The plasmid DNA extracted from the third round of sorting was subsequently transformed to Origami B (DE3) cells, and 360 colonies were picked, and individually grown in 96-well plates. The cells were lyzed, and the cleared lysates assayed for the hydrolysis of five different PON1 substrates: γTBL and HcyT (thiobutyrolactones), DEPCyC and paraoxon (phosphotriesters), 7AcC (an acetyl ester). The wt PON1 served as reference in these assays. About a third of the clones exhibited a significantly higher TBLase with both γTBL and HcyT. These parallel improvements are expected since HcyT is a derivative of γTBL with an α-amino substituent (FIG. 14B). It also appeared that, despite three rounds of enrichment, the selected variants exhibited considerable phenotypic diversity. By analyzing the rates with six different substrates, we could identify at least eight different distinct phenotypes amongst the TBLase improved variants that turned out to be unique in their sequence. These exhibited, in addition to the improved TBLase activity, significant changes in rates (both increases and decreases relative to wt PON1) with other PON1 substrates.

### Example 9

### Analysis of the Newly Evolved TBLase PON1 Variants

Three variants exhibiting the highest TBLase activity (1E9, 2B3 and 3F3) were over-expressed in E. coli, purified, and analyzed in detail. The improvements in TBLase catalytic efficiency (k_{cat}/K_{M}) were found to be in the range of 20-100 fold, for both γTBL and HcyT. To identify the mutations leading to the increase in PON1's TBLase activity, several clones from each of the eight representative phenotypes were sequenced. One mutation—Thr332Ser—appeared in all selected clones. This mutation is in a residue located ˜6 Å from the catalytic calcium ion that lies at the very bottom of PON1's deep active site, and appears to be the most crucial for increasing the TBLase activity. Harel et al. Mutations in Ile291 (also in the active site wall, and ˜10 Å away form the calcium) to either Ala or Phe, appear in five out of the eight variants. Previously observed were different mutations in both Thr332 and Ile291 in variants isolated by screening of PON1 libraries generated by error-prone PCR using conventional colorimetric screens on agar, and in 96-well plates. The two different mutations were observed in two separate clones (Thr332Ala, and Ile291Leu), and were only then combined by DNA shuffling to give a variant (1HT) with TBLase activity (k_{cat}/K_{M}=7×10³M⁻¹s⁻¹) similar to 1E9 and 2B3. Other, minor sequence changes resulted in large variation in PON1's phenotype. For example, variants 1B2 and 2D5, that in addition to the above described mutations (Thr332Ser, Ile291Phe), carry a mutation of Leu240 to either Thr or Met, respectively. This resulted in a very different phenotype: 1B2 exhibits similar rates with γTBL and HcyT, whereas 2D5 improved only in γTBL. Finally, the mutation of Lys192 into Gly is of interest, as natural polymorphism is observed in this residue that is related to susceptibility to organophosphates (OPs) and increased risk for atherosclerosis. Draganov et al.

### Example 10

### Detection of Surface-Displayed PON1

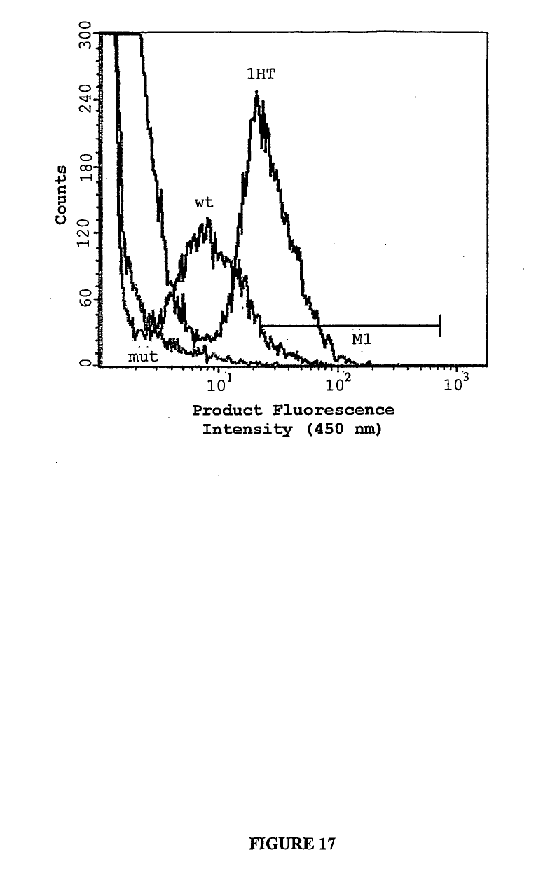

To examine the generality of this methodology, and open the road to more challenging selections, the detection and sorting of surface-displayed enzymes was performed. Various PON1 variants were displayed on the surface of E. coli by fusion to the outer membrane protein A (OmpA). Georgiou, G. The recombinant wt PON1 was displayed, alongside the previously-identified variant 1HT that exhibits 93-fold higher TBLase activity, and a heavily mutated PON1 library that exhibits almost no TBLase activity. The enzyme-displaying bacteria were compartmentalized and analyzed by FACS as described above. Excellent separation between the three variants was observed (FIG. 17). As is the case with cytoplasmic expression, the fluorescence signal of the surface-displayed variants was stable after several hours of storage of the emulsion on ice, and no mixing of product between the droplets was observed.

These results show that the detection of PON1's enzymatic activity is also possible when the activity takes place outside the cell, and that the diffusion of the product is restricted by compartmentalization in the droplets of the water-in-oil emulsion. This conclusion was further supported by the compartmentalization and ample detection of purified PON1 enzyme variants in buffer.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

### REFERENCES

Aharoni, A. et al. Proc Natl Acad Sci USA 101, 482-487 (2004).
Amstutz, P., Forrer, P., Zahnd, C. and Pluckthun, A., Curr. Opin. Biotechnol. 12 (2001) 400-405.
Anderson, C. W., Straus, J. W. and Dudock, B. S. (1983) Methods Enzymol, 101, 63544.
Anderson, J. E. (1993) Curr. Op. Struct Biol., 3, 24-30.
Ash, M. and Ash, I. (1993) Handbook of industrial surfactants. Gower, Aldershot.
Baccanari, D. P., Averett, D., Briggs, C. and Burchall, J. (1977) Biochemistry, 16, 3566-72.
Barany, F. (1991) PCR Methods Applic., 1, 5-16.
Bass, S., Greene, R. and Wells, J. A. (1990) Proteins, 8, 309-14.
Becher, P. (1957) Emulsions: theory and practice. Reinhold, N.Y.
Benevides C. C. P., Vian A., Mateo C., Fernandez-Lafuente R., Garcia J. L., Guisan J. M., and Carrascosa A. V. (2003). Appl. Environ. Microbiol. 69(4), 1967-1972.
Benita, S., Ed. (1996). Microencapsulation: methods and industrial applications. Drugs and pharmaceutical sciences. Edited by Swarbrick, J. New York: Marcel Dekker.
Benner, S. A. (1994) Trends Biotechnol, 12, 158-63.
Berman, J., Eisenberg, S. and Tye, B. K. (1987) Methods Enzymol, 155, 528-37.
Bernath, K. et al. In vitro compartmentalization by double emulsions: sorting and gene enrichment by fluorescence activated cell sorting. Anal Biochem 325, 151-157 (2004).
Betlach, L., Hershfield, V., Chow, L., Brown, W., Goodman, H. M. & Boyer, H. W. (1976). Federation Proceedings 35, 2037-2043.
Blattner, F. R. and Dahlberg, J. E. (1972) Nature New Biol, 237, 227-32.
Boder, E. T., Midelfort, K. S. and Wittrup, K. D., Proc. Natl. Acad. Sci. US 97 (2000) 10701-5.
Borchardt, A., Liberles, S. D., Biggar, S. R., Crabtree, G. R. and Schreiber, S. L. Chem. Biol. 4 (1997) 961-968.
Bougueleret, L., Schwarzstein, M., Tsugita, A. & Zabeau, M. (1984). Nucleic Acids Res 12(8), 3659-76.
Bru, R. & Walde, P. (1991). Eur J Biochem 199(1), 95-103.
Bru, R. & Walde, P. (1993). Biochem Mol Biol Int 31(4), 685-92.
Cahill, P., Foster, K. and Mahan, D. E. (1991) Clin Chem, 37, 1482-5.
Castiglia P. T. (1994). Lactose intolerance. J. Pediatr. Health Care 8(1), 36-38.
Chakrabarti, A. C., Breaker, R. R., Joyce, G. F. & Deamer, D. W. (1994). J Mol Evol 39(6), 555-9.
Chamberlin, M. and Ring, J. (1973) J Biol Chem, 248, 2235-2244.
Chang, T. M. (1987). Methods Enzymol 136(67), 67-82.
Chang, T. M. S. (1992). In Droplets and nanoparticles in medicine and pharmacy (Donbrow, M., ed.), pp. 323-339. CRC Press, Boca Raton, Fla.
Chapman, K. B. and Szostak, J. W. (1994) Curr. op. Struct. Biol., 4, 618-622.
Chetverin, A. B. and Spirin, A. S. (1995) Prog Nucleic Acid Res Mol Biol, 51, 225-70.
Clackson, T. and Wells, J. A. (1994) Trends Biotechnol, 12, 173-84.
Creagh, A. L., Prausnitz, J. M. & Blanch, H. W. (1993). Enzyme Microb Technol 15(5), 383-92.
Cull, M. G., Miller, J. F. and Schatz, P. J. (1992) Proc Natl Acad Sci USA, 89, 1865-9.
Daugherty, P. S., Chen, G., Olsen, M. J., Iverson, B. L. and Georgiou, G. Protein Eng. 11 (1998) 825-832.
Daugherty, P. S., Iverson, B. L. and Georgiou, G., J. Immunol. Methods 243 (2000) 211-27.
Deminiere, B., Colin, A., Calderon, F. L. and Bibette, J. (1998) in Modern aspects of emulsion science (Binks, B. P., Ed.), pp. 261-291, The Royal Society of Chemistry, Cambridge, UK.
Dickinson, E. (1994) In Wedlock, D. J. (ed.), Emulsions and droplet size control. Butterworth-Heinemann, Oxford, Vol. pp. 191-257.
Dion M., Fourage L., Hallet J-N, Colas B. (1999). Glycoconj. J. 16, 27-37.
Draganov, D. I. & La Du, B. N. Naunyn-Schmiedebergs Arch Pharmacol 369, 78-88 (2004).
Ellington, A. D. and Szostak, J. W. (1990) Nature, 346, 81822.
Ellman, J., Mendel, D., Anthony, C. S., Noren, C. J. and Schultz, P. G. (1991) Methods Enzymol, 202, 301-36.
Fahy, E., Kwoh, D. Y. and Gingeras, T. R. (1991) PCR Methods Appl, 1, 25-33.
Fields, S. & Song, O. (1989) Nature 340, 245-6.
Finch, C. A. (1993). Spec. Publ.-R. Soc. Chem. 138, 35.
Fisch, I., Kontermann, R. E., Finnern, R., Hartley, O., Soler, G. A., Griffiths, A. D. and Winter, G. (1996) Proc Natl Acad Sci USA, 93, 7761-6.
Freese, E. (1959) J. Mol. Biol., 1, 87.
Friedberg, E. C., Walker, G. C. and Siede, W. (1995) DNA repair and mutagenesis. ASM Press, Washington D.C.
Garcia-Garibay M., Gomez-Ruiz L. (1996). Rev. Invest. Clin. 48, 51-61.
Garti, N. and Bisperink, C., Curr. Opin. Coll. Interf. Sci. 3 (1998) 657-667.
Georgiou, G. in Advances in Protein Chemistry, Vol 55, Vol. 55 293-315 (2001).
Gold, L., Polisky, B., Uhlenbeck, O. and Yarus, M. (1995) Annu Rev Biochem, 64, 763-97.
Green, R. and Szostak, J. W. (1992) Science, 258, 1910-5.
Gregoriadis, G. (1976) Methods Enzymol, 44, 21 8-27.
Griffiths, A. D., Williams, S. C., Hartley, O., Tomlinson, I. M. , Waterhouse, P., Crosby, W. L., Kontermann, R. E. , Jones, P. T., Low, N. M., Allison, T. J. and et a.l. (1994) EMBO J, 13, 3245-60.
Griffiths, A. D. & Tawfik, D. S. EMBO J 22, 24-35 (2003).
Griffiths, A. D. & Tawfik, D. S. Curr Opin Biotechnol 11, 338-353 (2000).
Haber, J., Maslakiewicz,. P., Rodakiewicz, N. J. & Walde, P. (1993). Eur J Biochem 217(2), 567-73.
Hall B. G, Malik H. S. (1998). Mol Biol Evol. 15(8):1055-61.
Hall B. G. (1999). FEMS Microbiol Lett. 174(1):1-8.
Hall B. G. (2003). Genetica. 118(2-3):143-56.
Harel, M. et al. Nature Struct Mol Biol 11, 412-419 (2004).
Harpur, A. G., Wouters, F. S., and Bastiaens, P. I>, Nat. Biotechnol. 19 (2001) 167-9.
Hermanson, G. T. (1996) Bioconjugate techniques. Academic Press, San Diego.
Hochuli, E., Dobeli, H. and Schacher, A. (1987) J Chromatogr, 411, 177-84.
Hoogenboom, H. R. et al., (1991) Nucl. Acids Res., 91, 4133-4137.
Hoogenboom, H. R. (1997). Trends Biotechnol. 15, 62-70.
Ibrahim, S. F. and van den Engh, G., Curr. Opin. Biotechnol. 14 (2003) 5-12.
Jakubowski, H. J Biol Chem 275, 3957-3962 (2000).
Janda, K. D., Lo, L.-C., Lo, C.-H. L., Sim, M., -M., Wang, R, Wong, C.-H. and Lerner, R. A. (1997) Science, 275, 945-948.
Johannisson, A. (1991) In Price, C. P. and Newman, D. J. (ed.), Heterogeneous enzyme immunoassays. Stockton Press, New York, Vol. pp. 295-325.
Johannsson, A. and Bates, D. L. (1988) In Kemeny, D. M. and Challacombe, S. I. (ed.) Amplification by second enzymes. John Wiley, Chichester, Vol. pp. 85-106.
Joyce, G. F. (1994) Curr. Opinion Structural Biol., 4, 331-336.
Kadir, F. H. and Moore, G. R. (1990) Febs Lett, 276, 814.
Kallen, R. G. & Jencks, W. P. (1966). J. Biol. Chem. 241, 5851-5863.
Katanaev, V. L., Kurnasov, O. V. and Spirin, A. S. (1995) Febs Lett, 359, 89-92.
Keij, J. F., Groenewegen, A. C. & Visser, J. W. M. (1994). Methods in cell biology 42, 371-358.
Klug, A. (1995) Ann NY Acad Sci, 758, 143-60.
Klug, A. and Schwabe, J. W. (1995) Faseb T, 9, 597-604.
Kolb, V. A., Makeyev, E. V., Kommer, A. and Spirin, A. S. (1995) Biochem Cell Biol. 73, 1217-20.
Kowalczykowski, S. C., Dixon, D. A., Eggleston, A. K., Lauder, S. D. and Rehrauer, W. M. (1994) Microbiol Rev, 58, 401-65.
Krumdiek, C. L. & Baugh, C. M. (1980) Methods Enzymol. pp. 524-529.
Kumar, A., Kumar, A. & Katiyar, S. S. (1989). Biochim Biophys Acta 996(1-2), 1-6.
Landegren, U., Kaiser, R., Sanders, J. and Hood, L. (1988) Science, 241, 1077-80.
Lesley, S. A., Brow, M. A. & Burgess, R. R. (1991). J Biol Chem 266(4), 2632-8.
Lesley, S. A. (1995) Methods Mol Biol, 37, 265-78.
Lesley, S. A., Brow, M. A. and Burgess, R. R. (1991) J Biol Chem, 266, 2632-8.
Leung, D. W., Chen, E. and Goeddel, D. V. (1989) Technique, 1, 11-15.
Liao, H., McKenzie, T. and Hageman, R. (1986) Proc Natl Acad Sci USA, 83, 576-80.
Lim, F. & Sun, A. M. (1980). Science 210(4472), 908-10.
Lim, F., Ed. (1984). Biomedical applications of microencapsulation. Boca Raton, Fla.: CRC Press.
Lissant, K. J., ed. Emulsions and emulsion technology. Surfactant Science New York: Marcel Dekker, 1984.
List, B. and Barbas, C. F. 3rd, R. A. Lerner, Proc. Natl. Acad. Sci. USA 95 (1998) 15351-5.
Little, M., Breitling, F., Dubel, S., Fuchs, P. and Braunagel, M., J. Biotechnol. 41 (1995) 187-195.
Low, N. M., Holliger, P. H. and Winter, G. (1996) J Mol Biol, 260, 359-68.
Lowman, H. B., Bass, S. H., Simpson, N. and Wells, J. A. (1991) Biochemistry, 30, 10832-8.
Luisi, P. L. & B., S.-H. (1987). Activity and conformation of enzymes in reverse micellar solutions. Methods Enzymol 136(188), 188-216.
Lusis, A. J. Atherosclerosis. Nature 407, 233-241 (2000).
Ma, C., Kudlicki, W., Odom, O. W., Kramer, G. and Hardesty, B. (1993) Biochemistry, 32, 7939-45.
Magdassi, S., Frenkel, M., Carti, N. and Cazan, R. (1984) 97, 377-379.
Mahajan, N. P., Linder, K., Berry, G., Gordon, G. W. Heim, R. and Herman, B. Nat. Biotechnol. 16 (1998) 547-52
Manley, J. L., Fire, A., Samuels, M. and Sharp, P. A. (1983) Methods Enzymol, 101, 568-82.
Mao, Q. & Walde, P. (1991). Biochem Biophys Res Commun 178(3), 1105-12.
Mao, Q., Walde, P. & Luisi, P. L. (1992). Eur J Biochem 208(1), 165-70.
Mattheakis, L. C., Bhatt, R. R. and Dower, W. J. (1994) Proc Natl Acad Sci USA, 91, 9022-6.
McCafferty, J., Griffiths, A. D., Winter, G. and Chiswell, D. J. (1990) Nature, 348, 552-4.
Melton, D. A., Krieg, P. A., Rebagliati, M. R., Maniatis, T., Zinn, K. and Green, M. R. (1984) Nucleic Acids Res, 12, 703556.
Mendel, D., Cornish, V. W. and Schultz, P. G. (1995) Annu Rev Biophys Biomol Struct, 24, 435-62.
Menger, F. M. & Yamada, K. (1979). J. Am. Chem. Soc. 101, 6731-6734.
Miele, E. A., Mills, D. R. and Kramer, F. R. (1983) J Mol Biol, 171, 281-95.
Mize, P. D., Hoke, R. A., Linn, C. P., Reardon, J. E. and Schulte, T. H. (1989) Anal Biochem, 179, 229-35.
Montigiani, S., Neri, G., Neri, P. and Neri, D. (1996) J Mol Biol, 258, 6-13.
Moore, M. J. (1995) Nature, 374, 766-7. New, R. R. C., Ed. (1990). Liposomes: a practical approach. The practical approach series. Edited by Rickwood, D. & Hames, B. D. Oxford: Oxford University Press.
Nissim, A., Hoogenboom, H. R. I Tomlinson, I. M., Flynn, G., Midgley, C., Lane, D. and Winter, G. (1994) Embo J, 13, 692-8.
Oberholzer, T., Albrizio, M. & Luisi, P. L. (1995a). Polymerase chain reaction in liposomes. Chemistry and Biology 2, 677-682.
Oberholzer, T., Wick, R., Luisi, P. L. & Biebricher, C. K. (1995b). Enzymatic RNA replication in self-reproducing vesicles: an approach to a minimal cell. Biochem Biophys Res Commun 207(1), 250-7.
Olsen, M. J., Stephens, D., Griffiths, D., Daugherty, P., Georgiou, G. Iverson, B. L., Nat. Biotechnol. 18 (2000) 1071-4.
Parmley, S. F. and Smith, G. P. (1988) Gene, 73, 305-18.
Parvari, R., Pecht, I. & Soreq, H. Anal Biochem 133, 450-456 (1983).
Pelham, H. R. and Jackson, R. J. (1976) Eur J Biochem, 67, 247-56.
Perelson, A. S. and Oster, G. F. (1979) J Theor Biol, 81, 64570.
Perez, G. M., Sanchez, F. A. & Garcia, C. F. (1992). Biochem J.
Pirrung, M. C. and Huang, C. Y. (1996) Bioconjug Chem, 7, 31721.
Posner, B. A., Li, L., Bethell, R., Tsuji, T. and Benkovic, S. J. (1996) Biochemistry, 35, 1653-63.
Roberts, B. E., Gorecki, M., Mulligan, R. C., Danna, K. J., Rozenblatt, S. and Rich, A. (1975) Proc Natl Acad Sci USA, 72, 1922-6.
Roberts, J. W. (1969) Nature, 224, 1168-74.
Roberts, R. W. and Szostak, J. (1997). Proc Natl Acad Sci USA 94, 12297-12302.
Rosenberg, M., Weissman, S. and deCrombrugghe, B. (1975) J Biol Chem, 250, 4755-64.
Saiki, R. K., Gelfand, D. H., Stoffel, S., Scharf, S. J., Higuchi, R, Horn, G. T., Mullis, K. B. and Erlich, H. A. (1988) Science, 239, 487-91.
Sambrook, J., Fritsch, E. F. and Maniatis, T. (1989) Molecular cloning: a laboratory manual. Cold Spring Harbor Laboratory Press, New York.
Savage, M. D., Mattson, G., Desai, S., Nielander, G. W., Morgensen, S. and Conklin, E. J. (1994) Avidin-biotin chemistry: a handbook. Pierce Chemical Company, Rockford.
Schick, M. J. (1966) Nonionic surfactants. Marcel Dekker, New York.
Sherman, P. (1968) Emulsion science. Academic Press, London.
Smith, G. P. (1985) Science, 228, 1315-7.
Smith, G. P. and Petrenko, V. A. Chem. Rev. 97 (1997) 391410.
Soumillion, P., Jaspers, L., Bouchet, M., Marchand, B. J., Winter, G. and Fastrez, J. (1994) J Mol Biol, 237, 415-22.
Stemmer, W. P. (1994a) Nature, 370, 389-91.
Stemmer, W. P. (1994b) Proc Natl Acad Sci USA, 91, 10747-51.
Stofko, H. R., Carr, D. W. and Scott, J. D. (1992) Febs Lett, 302, 274-8.
Sun, A. M., Vasek, I. & Tai, I. (1992). Microencapsulation of living cells and tissues. In Microencapsuiation and nanoparticles in medicine and pharmacy (Donbrow, M., ed.), pp. 315-322. CRC Press, Boca Raton, Fla.
Sundberg, S. A., Barrett, R. W., Pirrung, M., Lu, A. L., Kiangsoontra, B. and Holmes, C. P. (1995) J. Am. Chem. Soc., 117, 12050-12057.
Tawfik, D. S., Green, B. S., Chap, R., Sela, M. & Eshhar, Z. (1993). Proc Natl Acad Sci USA 90(2), 373-7.
Tawfik, and Griffiths, Nat. Biotechnol. 16 (1998) 652-6
Tokatlidis, K., Friguet, B., Deville, B. D., Baleux, F., Fedorov, A. N., Navon, A., Djavadi, O. L. and Goldberg, M. E. (1995) Philos Trans R Soc Lond B Biol Sci, 348, 89-95.
Trimbur D. E., Gutshall K.R., Prema P., Brenchley J. E. (1994. Appl. Environ. Microbiol. 60(12), 4544-4552.
Tripet, B., Yu, L., Bautista, D. L., Wong, W. Y., Irvin, R. T. and Hodges, R. S. (1996) Protein Engng., 9, 1029-1042.
Tuerk, C. and Gold, L. (1990) Science, 249, 505-10. van Hal, D. A., Bouwstra, J. A. & Junginger, H. E. (1996). In Microencapsulation: methods and industrial applications (Benita, S., ed.), pp. 329-347. Marcel Dekker, New York.
Walde, P., Goto, A., Monnard, P.-A., Wessicken, M. & Luisi, P. L. (1994). s. J. Am. Chem. Soc. 116, 7541-7547.
Walde, P., Han, D. & Luisi, P. L. (1993). Biochemistry 32(15), 4029-34.
Walde, P., Peng, Q., Fadnavis, N. W., Battistel, E. & Luisi, P. L. (1988). Eur J Biochem 173(2), 401-9.
Walker, G. T., Fraiser, M. S., Schram, J. L., Little, M. C., Nadeau, J. G. and Malinowski, D. P. (1992) Nucleic Acids Res, 20, 1691-6.
Weil, P. A., Luse, D. S., Segall, J. and Roeder, R. G. (1979) Cell, 18, 469-84.
Whateley, T. L. (1996). In Microencapsulation: methods and industrial applications (Benita, S., ed.), pp. 349-375. Marcel Dekker, New York.
Wick, R. & Luisi, P. L. (1996). Chem Biol 3(4), 277-85.
Widersten, M. and Mannervik,. B. (1995) J Mol Biol, 250, 115-22.
Williams, J. W., Morrison, J. F. and Duggleby, R. G. (1979) Biochemistry, 18, 2567-73.
Winter, G., Griffiths, A. D., Hawkins, R. E. and Hoogenboom, H. R. (1994) Annu Rev Immunol, 12, 433-55.
Wittrup, K. D. Curr. Opin. Biotechnol. 12 (2001) 395-9.
Wyatt, J. R. Chastain, M. and Puglisi, J. D. (1991) Biotechniques, 11, 764-9.
Yamagishi, J., Kawashima, H., Matsuo, N., Ohue, M., Yamayoshi, M., Fukui, T., Kotani, H., Furuta, R., Nakano, K. and Yamada, M. (1990) Protein Eng, 3, 713-9.
Yelamos, J., Klix, N., Goyenechea, B., Lozano, F., Chui, Y. L., Gonzalez, F. A., Pannell, R., Neuberger, M. S. and Milstein, C. (1995) Nature, 376, 225-9.
Zaccolo, M., Williams, D. M., Brown, D. M. and Gherardi, E. (1996) 3 Mol Biol, 255, 589-603.
Zakrzewski, S. F. (1980). Methods Enzymol. pp. 539
Zaug, A. J. and Cech, T. R. (1986) Biochemistry, 25, 4478-82.
Zaug, A. J. and Cech, T. R. (1986) Science, 231, 470-5.
Zaug, A. J., Been, M. D. and Cech, T. R. (1986) Nature, 324, 429-33.
Zubay, G. (1973) Annu Rev Genet, 7, 267-87.
Zubay, G. (1980) Methods Enzymol, 65, 856-77.

We claim:

1. A library comprising a plurality of distinct molecules encapsulated within a water-in-oil-in-water emulsion, the emulsion comprising a continuous external aqueous phase and a discontinuous dispersion of water-in-oil droplets, wherein the internal aqueous phase of a plurality of the droplets each comprises a specific molecule of said plurality of distinct molecules of the library.

2. The library of claim 1, wherein the specific molecule is selected from the group consisting of: a genetic element, a protein, a carbohydrate and a small organic molecule.

3. The library of claim 2, wherein each said droplet further comprises at least one additional molecule capable of interacting with the specific molecule to generate a detectable signal.

4. The library of claim 3, wherein said droplet further comprises at least one molecule capable of modifying one or more optical properties of the droplets, the at least one molecule is selected from the group consisting of a fluorescent marker and a fluorogenic substrate.

5. The library of claim 3, wherein the specific molecule is an enzyme and the at least one additional molecule is a substrate of the enzyme.

6. The library of claim 1, wherein the specific molecule is an expressible genetic element and each droplet further comprises a reaction system for expressing said genetic element.

7. The library of claim 6, wherein the genetic element and its gene product are attached to each other by plasmid-display, ribosome-display, CIS display or mRNA-peptide fusion.

8. The library of claim 1, wherein said specific molecule is contained within an entity selected from the group consisting of: a cell, a bacteriophage and a virus.

9. The library of claim 6, wherein the specific molecule is contained within a cell and the gene product of said specific molecule is obtained in a location selected from the group consisting of: intracellular, extracellular, cellular surface, cellular cytoplasm and cellular periplasm.

10. The library of claim 8, said specific molecule is contained within a cell, wherein the plurality of cells each comprise a distinct expressible genetic element the genetic product thereof induces growth arrest, apoptosis or lysis.

11. A method for isolating or identifying one or more molecules having a desired function, comprising the steps of:
a) providing the library of claim 1, said library comprises molecules within a water-in-oil-in-water emulsion, the emulsion comprising an external aqueous phase and a discontinuous dispersion of a plurality of water-in-oil droplets, wherein the molecules are compartmentalized in the plurality droplets; and
b) screening the plurality of droplets for a molecule having a desired function.

12. The method of claim 11, wherein the screening step comprises identifying a change in the optical properties of a droplet of the plurality of droplets.

13. The method of claim 11, wherein the molecule is a genetic element encoding at least one gene product having a desired activity.

14. The method of claim 11, wherein each droplet of the plurality of droplets comprise at least one genetic element and in vitro transcription-translation reaction system.

15. The method of claim 14, wherein following step (a) the method comprises the step of expressing the genetic element to produce its gene product within the droplets.

16. The method of claim 15, wherein the gene product remains linked to its genetic element.

17. The method of claim 15, wherein the activity of the gene product results in the alteration of the expression of a second genetic element within the droplet and the activity of the gene product of the second genetic element enables the isolation of the first genetic element.

18. The method of claim 11, wherein the droplet comprises at least one molecule selected from the group consisting of a fluorescent marker and a fluorogenic substrate.

19. The method of claim 11, wherein screening of the droplets comprises a technique selected from the group consisting of flow cytometry, fluorescence microscopy, optical tweezers and micro-pipettes.

20. The method of claim 11, wherein said molecules are within cells such that the cells being compartmentalized in said plurality droplets.

21. The method of claim 11, wherein step (a) is a multistep process comprising the steps of:
(i) compartmentalizing molecules or cells into primary water-in-oil droplets; and
(ii) re-emulsifying the primary water-in-oil droplets of (i) with an external aqueous phase to obtain re-emulsified water-in-oil-in-water droplets.

22. The method of claim 11, further comprising isolating a sub-population of droplets comprising molecules encoding desired gene products.

23. The method of claim 22, wherein said molecules are pooled and subjected to mutagenesis.

24. The method of claim 23, further comprising re-compartmentalizing said molecules for further iterative rounds of screening.

25. The method of claim 22, wherein the desired gene products induce, directly or indirectly, a change in the optical properties of the droplets containing same, the change permitting the droplet to be sorted.

26. The method of claim 11, wherein step (a) comprises:
(a) compartmentalizing molecules into primary water-in-oil droplets, wherein the molecule are genetic elements;
(b) expressing the genetic elements to produce their respective gene products within the primary water-in-oil droplets; and
(c) re-emulsifying the primary water-in-oil droplets of (b) with an external aqueous phase to obtain a plurality of re-emulsified water-in-oil-in-water droplets.


SEQUENCE LISTING (33 sequences)

SEQ ID NO: 1 - DNA, 17 bp, Artificial
  primer
gtaaaacgacggccagt

SEQ ID NO: 2 - DNA, 17 bp, Artificial
  primer
ttttttgctgaaaggag

SEQ ID NO: 3 - DNA, 19 bp, Artificial
  primer
taatacgactcactatagg

SEQ ID NO: 4 - DNA, 22 bp, Artificial
  primer
cccgtttagaggccccaagggg

SEQ ID NO: 5 - DNA, 48 bp, Artificial
  primer
cagactgcaccatggccatgattacggattcactggccgtcgttttac

SEQ ID NO: 6 - DNA, 51 bp, Artificial
  primer
acgatgtcaggatccttattatttttgacaccagaccaactggtaatggta

SEQ ID NO: 7 - DNA, 18 bp, Artificial
  primer
gatggcgcccaacagtcc

SEQ ID NO: 8 - DNA, 17 bp, Artificial
  primer
tttggccgccgcccagt

SEQ ID NO: 9 - DNA, 19 bp, Artificial
  primer
gcccgatcttccccatcgg

SEQ ID NO: 10 - DNA, 17 bp, Artificial
  primer
cacacccgtcctgtgga

SEQ ID NO: 11 - DNA, 41 bp, Artificial
  primer
cagactgcaccgcgggatgaatcgctgggaaaacattcagc

SEQ ID NO: 12 - DNA, 39 bp, Artificial
  primer
gcgaggagctcttatttgttatggaaataaccatcttcg

SEQ ID NO: 13 - DNA, 21 bp, Artificial
  primer
gcatttatcagggttattgtc

SEQ ID NO: 14 - DNA, 17 bp, Artificial
  primer; triple biotinylated
gcgttgatgcaatttct

SEQ ID NO: 15 - DNA, 18 bp, artificial
  primer
atgcgtccggcgtagagg

SEQ ID NO: 16 - DNA, 19 bp, artificial
  primer
agcagccaactcagcttcc

SEQ ID NO: 17 - DNA, 20 bp, artificial
  primer
taatacgactcactataggg

SEQ ID NO: 18 - DNA, 19 bp, artificial
  primer
gctagttattgctcagcgg

SEQ ID NO: 19 - DNA, 53 bp, artificial
  primer
tactatactcacctgcactacatggcatcttcctcctacatcaccgatcaagg

SEQ ID NO: 20 - DNA, 71 bp, artificial
  primer
tactatactcacctgcactacatggcacatcaccatcaccatcactcttcctcctacatcaccgatcaagg

SEQ ID NO: 21 - DNA, 34 bp, artificial
  primer
atagttttagcggccgcctaagcggcacggatgc

SEQ ID NO: 22 - DNA, 48 bp, artificial
  primer
tactatactgaagacatcatggcaaccgagaacgccgaaaaattcctt

SEQ ID NO: 23 - DNA, 66 bp, artificial
  primer
tactatactgaagacatcatggcacatcaccatcaccatcacaccgagaacgccgaaaaattcctt

SEQ ID NO: 24 - DNA, 45 bp, artificial
  primer
atagtttagcggccgcattcttatttaggtctgggcccgcgcgat

SEQ ID NO: 25 - DNA, 38 bp, artificial
  primer
catgccatggctatgttgggcgtttgttactacccgga

SEQ ID NO: 26 - DNA, 56 bp, artificial
  primer
catgccatggctcatcaccatcaccatcacatgttgggcgtttgttactacccgga

SEQ ID NO: 27 - DNA, 30 bp, artificial
  primer
catgccatgggctatggcctcccagtccaa

SEQ ID NO: 28 - DNA, 31 bp, artificial
  primer
catgccatggggcagaggtggtttcctactt

SEQ ID NO: 29 - DNA, 35 bp, artificial
  primer
cgcggatcctcatgtctcctcccacacggcaaggt

SEQ ID NO: 30 - DNA, 29 bp, artificial
  primer
ggaggccatagcccacggggcagaggtgg

SEQ ID NO: 31 - DNA, 29 bp, artificial
  primer
ccacctctgccccgtgggctatggcctcc

SEQ ID NO: 32 - DNA, 20 bp, artificial
  primer
ctgggacttgaggttatctg

SEQ ID NO: 33 - DNA, 20 bp, artificial
  primer
gccactattgatccacggat